(19) United States
(12) Patent Application Publication
(10) Pub. No.: US 2013/0111503 A1
(43) Pub. Date: May 2, 2013

(54) COLLATION DEVICE, COLLATION PROGRAM AND COLLATION METHOD

(71) Applicants: Shinichiro Tago, Shinagawa (JP); Tatsuya Asai, Kawasaki (JP); Hiroya Inakoshi, Tama (JP); Nobuhiro Yugami, Minato (JP); Hiroaki Morikawa, Kawasaki (JP); Takashi Katoh, Yokohama (JP)

(72) Inventors: Shinichiro Tago, Shinagawa (JP); Tatsuya Asai, Kawasaki (JP); Hiroya Inakoshi, Tama (JP); Nobuhiro Yugami, Minato (JP); Hiroaki Morikawa, Kawasaki (JP); Takashi Katoh, Yokohama (JP)

(73) Assignee: FUJITSU LIMITED, Kawasaki-shi (JP)

(21) Appl. No.: 13/586,940

(22) Filed: Aug. 16, 2012

(30) Foreign Application Priority Data
Oct. 31, 2011 (JP) 2011-239699

(51) Int. Cl. G06F 13/00

(52) U.S. Cl. 719/318

(57) ABSTRACT

A collation device generates an NFA by generating an automaton corresponding to an event pattern, replicating an automaton part corresponding to the same series part in which events are connected in the same series in the generated automaton for a plurality of series, substituting each replicated automaton part with a transition that is received in an event of each series, and combining each substituted automaton part through an ε transition. In addition, the collation device collates whether or not the event pattern is included in an event stream by comparing the event stream and the NFA and receiving an event included in the event stream in an NFA part corresponding to a series in which the event occurs out of the replicated NFA parts and operating the NFA part.

### CROSS-REFERENCE TO RELATED APPLICATION

This application is based upon and claims the benefit of priority of the prior Japanese Patent Application No. 2011-239699, filed on Oct. 31, 2011, the entire contents of which are incorporated herein by reference.

### FIELD

The embodiment discussed herein is directed to a collation device, and the like.

### BACKGROUND

Event stream processing has attracted attention in accordance with the development and wide use of network technologies and sensor technologies, which is performed for the purpose of processing a series of events occurring in large quantities from moment to moment in real time. Hereinafter, a series of events is represented as an event stream. In the field of processing an event stream, an event pattern collating technique for detecting patterns of the arrival order of events and the interval of the arrival of events is regarded to be significant, and thus various techniques are proposed.

In the collation of event patterns, for example, three properties represented below are requested. A first property will now be described. In the collation of event patterns, it is requested to perform the collation with a noise event which is mixed in the event stream and to be ignored. Here, the noise event corresponds to an event other than events that are the targets of the collation.

A second property will now be described. In the collation of event patterns, it is requested to perform the collation of event patterns such that a specific event arrives within a predetermined time after an event. For example, the collation of two events, which are not related with each other, having a large difference in time can be avoided.

A third property will now be described. In the collation of event patterns, it is requested to perform the collation of event patterns based on event data acquired from a plurality of data sources. For example, it can be found that two arbitrary cars are stopped at the same location.

Next, an example of a related technology for collating event patterns will be described. FIG. 27 is a diagram that illustrates a related technology. As illustrated in FIG. 27, an event stream 10 that includes event data acquired from a plurality of data sources represents rows of events, each representing a difference in the speed of a car for every five seconds. In FIG. 27, each data source is assumed to be identified by an ID (identification). For the convenience of description, a horizontal row is set as a series of events for each ID, and a vertical column represents events for each ID that occurs at the same time. A series of events within the event stream 10 of which IDs are “1” includes events a, n, x, a, b, x, y, c, n, a, n, c, n, . . . . In addition, a series of events within the event stream 10 of which IDs are “2” includes events b, c, n, n, n, n, n, n, n, z, x, n, n, . . . . Furthermore, a series of events within the event stream 10 of which IDs are “3” includes events a, z, b, n, z, n, c, n, a, n, z, n, n, . . . . FIG. 28 is a diagram in which events and descriptions of the events are associated with each other. As illustrated in FIG. 28, event z represents sudden deceleration of −30 km/h or less, event y represents −30 to −15 km/h, and event x represents −15 to −5 km/h. In addition, event n represents −5 to 5 km/h, event a represents 5 to 15 km/h, event b represents 15 to 30 km/h, and event c represents sudden acceleration of 30 km/h or more.

Here, an event pattern P will be considered in which, within five seconds after sudden deceleration is made in an ID, sudden deceleration is made in another ID. In the sudden deceleration, it is assumed that events n and z continuously occur. In the related technology, the event pattern P and the event stream 10 illustrated in FIG. 27 are compared with each other. In that case, events n and z of sudden deceleration are collated at position 10a in an ID of 3, and events n and z of sudden deceleration are collated at position 10b in an ID of 2. However, it is 20 seconds until event c is received at position 10b after the reception of events n and z at position 10a, and accordingly, the event pattern P is not detected. In addition, events n and z of sudden deceleration are collated at position 10b in an ID of 2, and events n and z of sudden deceleration are collated at position 10c in an ID of 3. In this case, it is 5 seconds until events n and z are received at position 10c after the reception of events n and z at position 10b, and accordingly, the event pattern P is detected.

However, in the related technology, in a case where the event pattern and the event stream are compared with each other, an NFA (nondeterministic finite automaton) corresponding to the event pattern is generated and used. Hereinafter, the nondeterministic finite automaton is abbreviated to an NFA. FIGS. 29 to 32 are diagrams that illustrate related NFAs generated from various patterns that are included in the event patterns. FIG. 29 is a diagram that illustrates an NFA corresponding to a single event. In FIG. 29, an NFA that corresponds to a single event “P=a” is illustrated. In addition, FIG. 30 is a diagram that illustrates an NFA corresponding to a serial pattern. In FIG. 30, an NFA corresponding to a non-continuous serial pattern P=(P1, P2) is illustrated. This NFA recognizes a collation of P=(P1, P2) even in a case where P2 is collated after an arbitrary event row is acquired to appear after the collation of P1.

FIG. 31 is a diagram that illustrates an NFA that corresponds to a selection pattern. In addition, in FIG. 31, ε represents an ε transition. In FIG. 31, an NFA that corresponds to a selection pattern P=(P1|P2) is illustrated. In this NFA, the collation of P=(P1|P2) is completed in a case where any one of patterns P1 or P2 is included in the event stream. For example, in a case where a transition to a node 3a is activated, an ε transition from the node 3a to nodes 3b and 3d is activated. For example, in a case where the process arrives at the pattern P1 of the event stream, a transition from the node 3a to a node 3c is activated. Then, in that state, when an ε transition from a node 3c to a node 3f is activated, the collation is completed. FIG. 32 is a diagram that illustrates an NFA corresponding to a repetitive pattern. In FIG. 32, an NFA that corresponds to a repetitive pattern P=(P1)* is illustrated.
Non Patent Literature 1: A. Demers, et al. “Cayuga: A General Purpose Event Monitoring System”, Proc. CIDR'07
Non Patent Literature 2: J. Agrawal, et al. “Efficient Pattern Matching over Event Streams”, Proc. SIGMOD'08.

### SUMMARY

According to an aspect of the embodiments, a collation device includes a processor, a memory. The processor executes generating an automaton by generating an automaton corresponding to an event pattern that is an event pattern including events of a plurality of series and is an event pattern accompanying an occurring order of the events and an interval condition of the events and replicating an automaton part corresponding to a same-series part in which events included in the generated automaton are connected to each other in the same series for a plurality of series, substituting each replicated automaton part with a transition that is received in an event of each series, and combining the substituted automaton parts through an ε transition; and collating whether or not the event pattern is included in an event stream by sequentially comparing the event stream that includes the occurring order of a plurality of events of a plurality of series with the automaton, receiving an event included in the event stream in an automaton part corresponding to the series in which the event has occurred out of replicated automaton parts, and operating the automaton part.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram that illustrates the configuration of a collation system according to an embodiment;

FIG. 2 is a functional block diagram that illustrates the configuration of a collation device according to an embodiment;

FIG. 3 is a diagram that illustrates an example of the data structure of an event stream;

FIG. 4 is a diagram that illustrates a method of building an NFA using an NFA generating unit;

FIG. 5 is a diagram that illustrates a method of building an NFA using an NFA generating unit;

FIG. 6 is a diagram that illustrates a method of building an NFA using an NFA generating unit;

FIG. 7 is a diagram that illustrates a modified example of the diagram that illustrates a method of building an NFA using an NFA generating unit;

FIG. 8 is a diagram that illustrates a method of building an NFA using an NFA generating unit;

FIG. 9 is a diagram that illustrates a method of building an NFA using an NFA generating unit;

FIG. 10 is a diagram that illustrates an example of the data structure of a transition type determining table;

FIG. 11 is a flowchart that illustrates the sequence of a main NFA building process performed by the NFA generating unit;

FIG. 12 is a flowchart that illustrates the sequence of a provisional NFA converting process;

FIG. 13A is a flowchart (1) that illustrates the sequence of a subroutine process;

FIG. 13B is a flowchart (2) that illustrates the sequence of the subroutine process;

FIG. 13C is a flowchart (3) that illustrates the sequence of the subroutine process;

FIG. 13D is a flowchart (4) that illustrates the sequence of the subroutine process;

FIG. 14 is a flowchart that illustrates the sequence of a same-series NFA searching process;

FIG. 15 is a flowchart that illustrates the sequence of a same-series NFA converting process;

FIG. 16A is a diagram that illustrates the process of generating a provisional NFA;

FIG. 16B is a diagram that illustrates the process of generating the provisional NFA;

FIG. 16C is a diagram that illustrates the process of generating the provisional NFA;

FIG. 16D is a diagram that illustrates the process of generating the provisional NFA;

FIG. 17A is a diagram that illustrates the same-series NFA searching process;

FIG. 17B is a diagram that illustrates the same-series NFA searching process;

FIG. 17C is a diagram that illustrates the same-series NFA searching process;

FIG. 17D is a diagram that illustrates the same-series NFA searching process;

FIG. 17E is a diagram that illustrates the same-series NFA searching process;

FIG. 17F is a diagram that illustrates the same-series NFA searching process;

FIG. 18A is a diagram that illustrates the same-series NFA converting process;

FIG. 18B is a diagram that illustrates the same-series NFA converting process;

FIG. 18C is a diagram that illustrates the same-series NFA converting process;

FIG. 18D is a diagram that illustrates the same-series NFA converting process;

FIG. 18E is a diagram that illustrates the same-series NFA converting process;

FIG. 18F is a diagram that illustrates the same-series NFA converting process;

FIG. 18G is a diagram that illustrates the same-series NFA converting process;

FIG. 19A is a diagram that illustrates a provisional NFA generating process for another pattern;

FIG. 19B is a diagram that illustrates a provisional NFA generating process for another pattern;

FIG. 19C is a diagram that illustrates a provisional NFA generating process for another pattern;

FIG. 19D is a diagram that illustrates a provisional NFA generating process for another pattern;

FIG. 19E is a diagram that illustrates a provisional NFA generating process for another pattern;

FIG. 19F is a diagram that illustrates a provisional NFA generating process for another pattern;

FIG. 19G is a diagram that illustrates a provisional NFA generating process for another pattern;

FIG. 19H is a diagram that illustrates a provisional NFA generating process for another pattern;

FIG. 19I is a diagram that illustrates a provisional NFA generating process for another pattern;

FIG. 20A is a diagram that illustrates the same-series NFA searching process for another pattern;

FIG. 20B is a diagram that illustrates the same-series NFA searching process for another pattern;

FIG. 20C is a diagram that illustrates the same-series NFA searching process for another pattern;

FIG. 20D is a diagram that illustrates the same-series NFA searching process for another pattern;

FIG. 20E is a diagram that illustrates the same-series NFA searching process for another pattern;

FIG. 20F is a diagram that illustrates the same-series NFA searching process for another pattern;

FIG. 20G is a diagram that illustrates the same-series NFA searching process for another pattern;

FIG. 21A is a diagram that illustrates the same-series NFA converting process for another pattern;

FIG. 21B is a diagram that illustrates the same-series NFA converting process for another pattern;

FIG. 21C is a diagram that illustrates the same-series NFA converting process for another pattern;

FIG. 21D is a diagram that illustrates the same-series NFA converting process for another pattern;

FIG. 21E is a diagram that illustrates the same-series NFA converting process for another pattern;

FIG. 21F is a diagram that illustrates the same-series NFA converting process for another pattern;

FIG. 24G is a diagram that illustrates the same-series NFA converting process for another pattern;

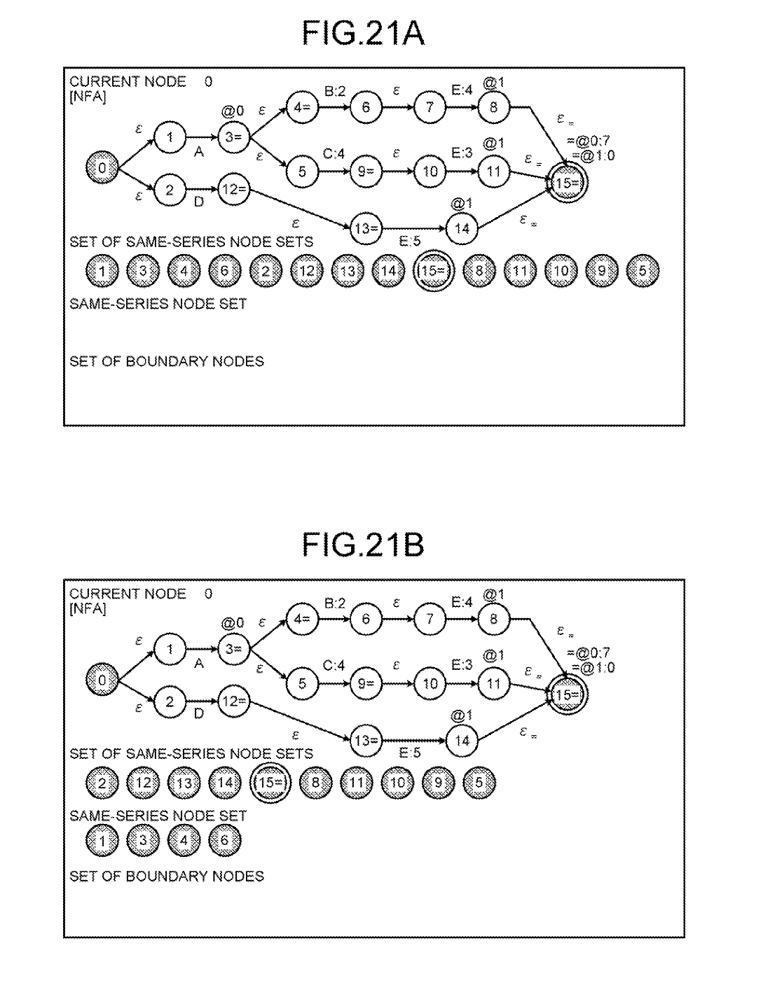

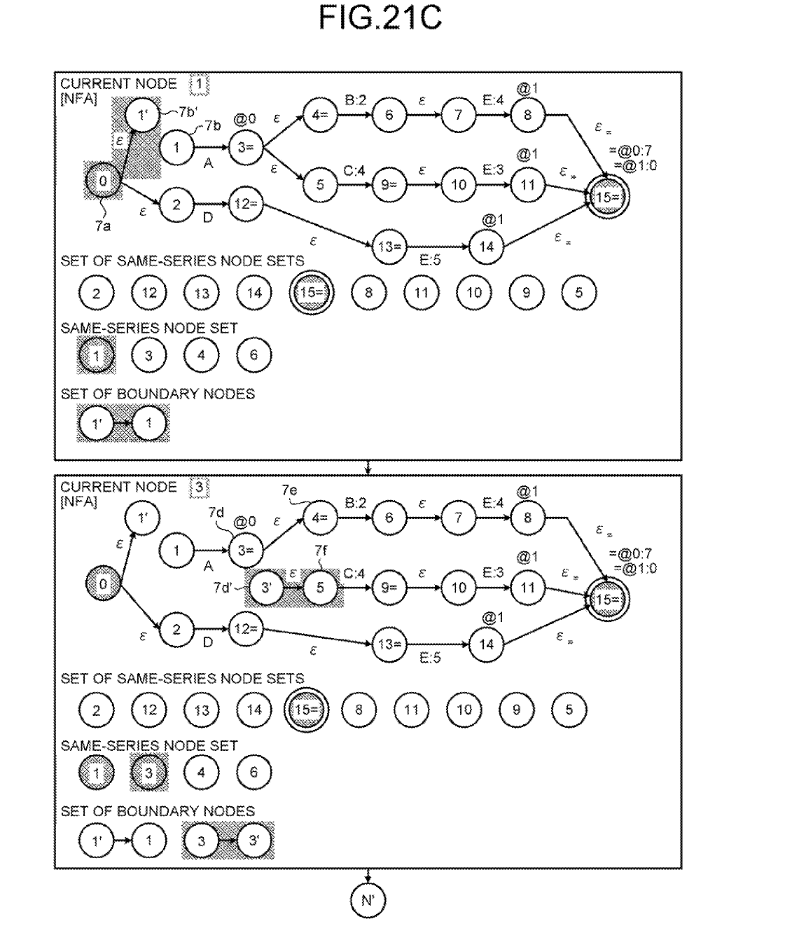

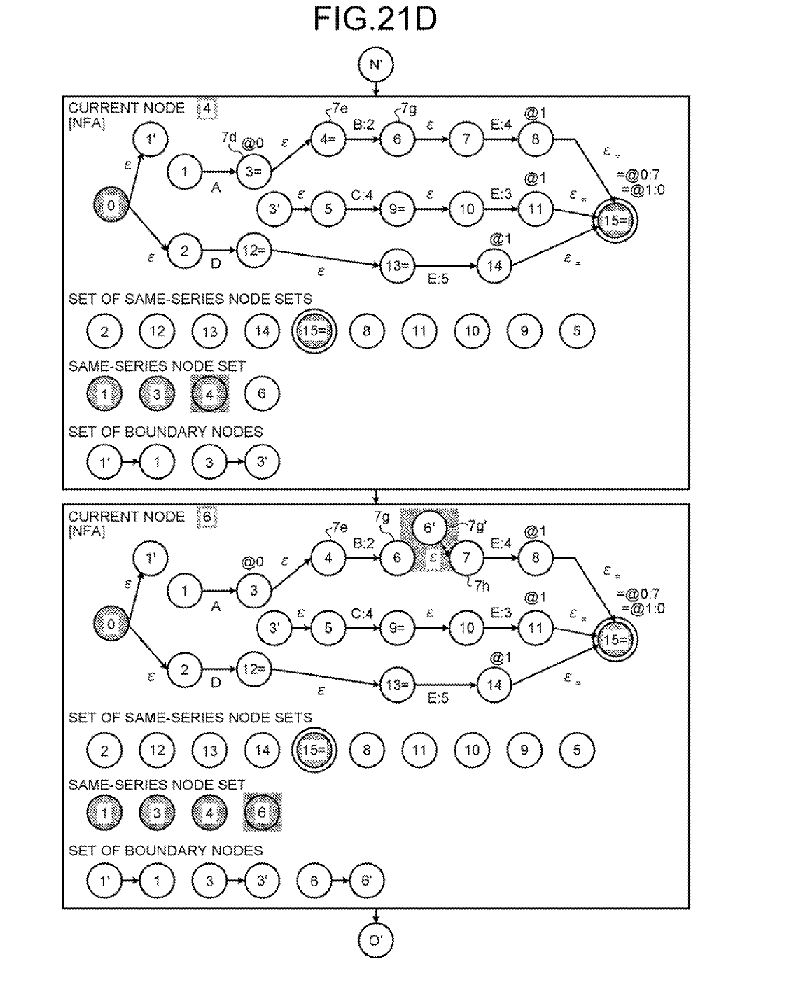

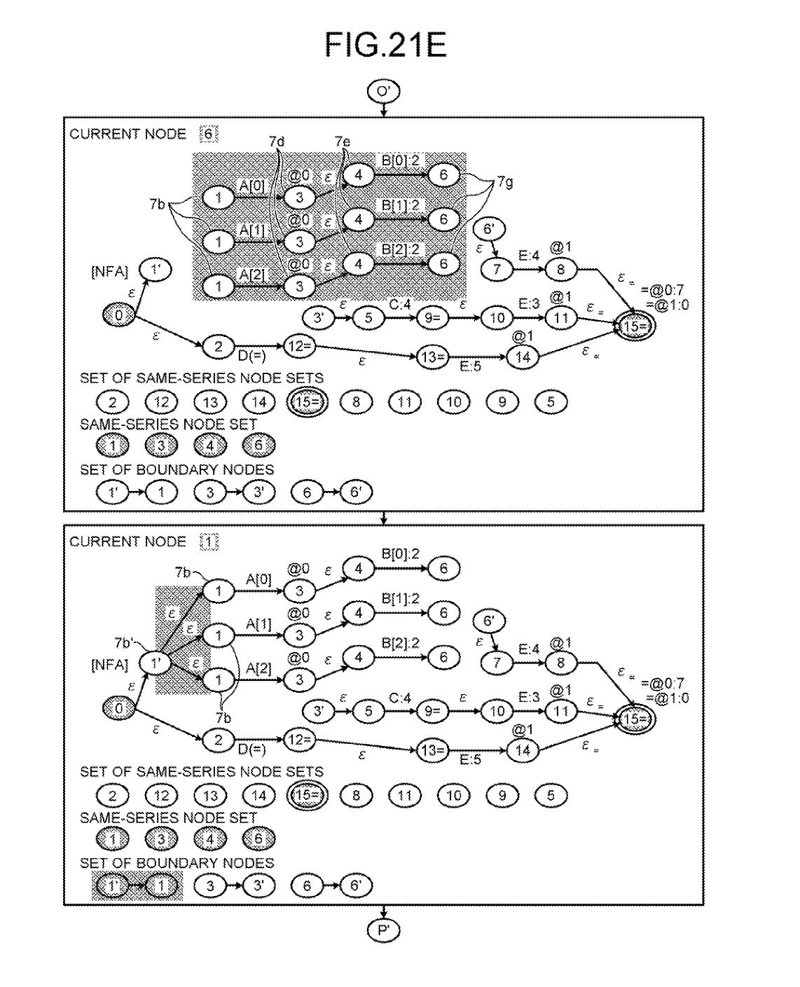

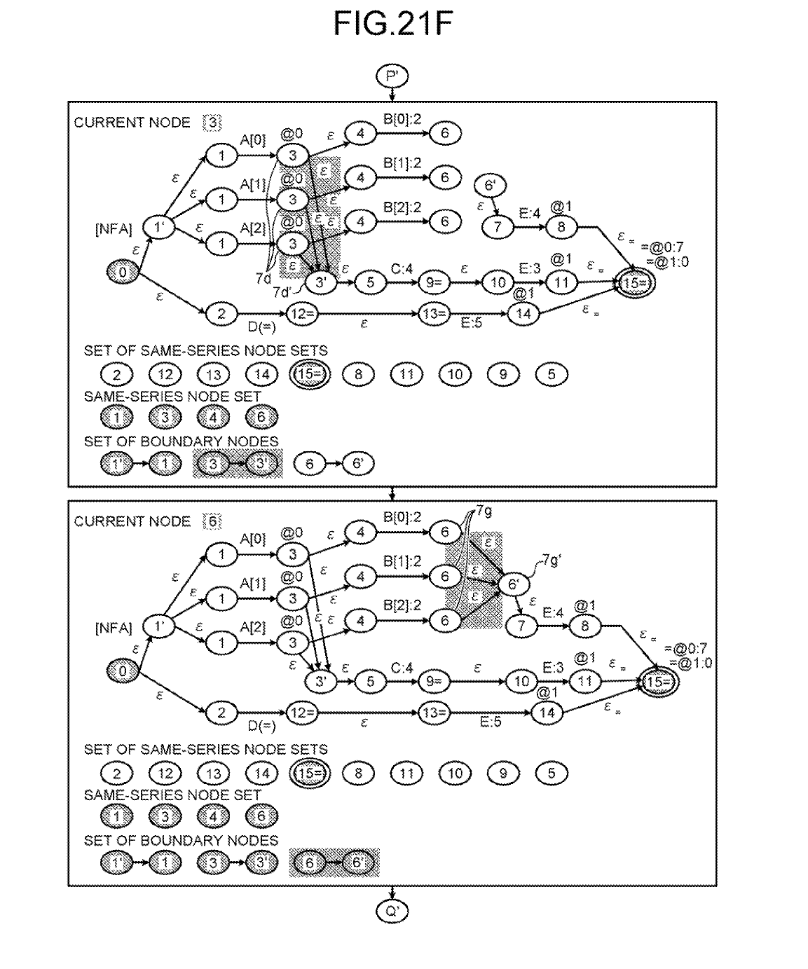

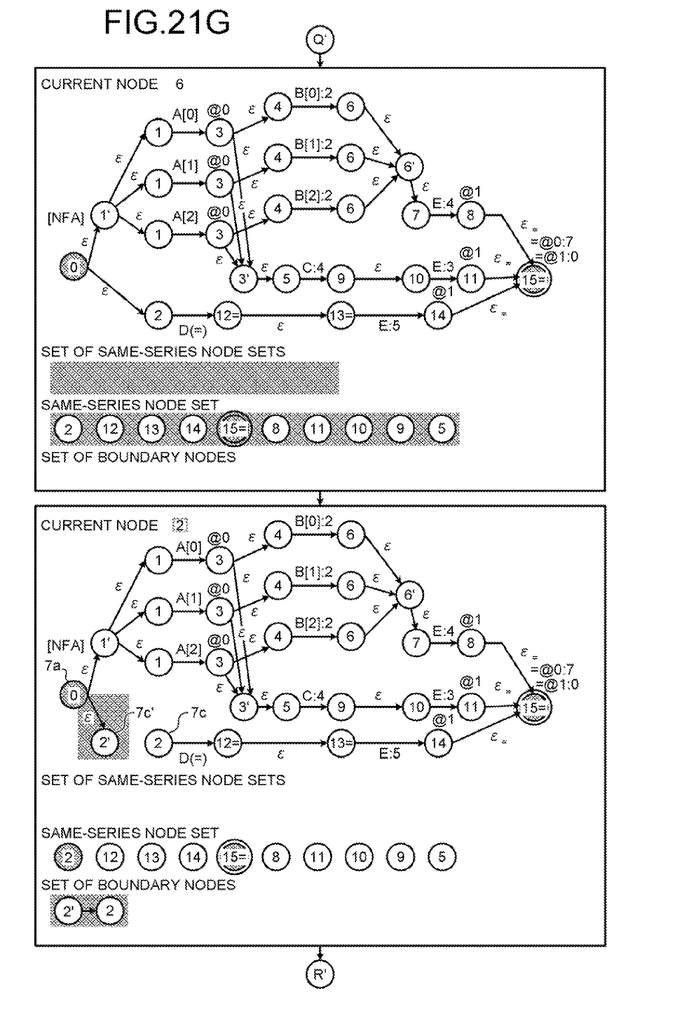

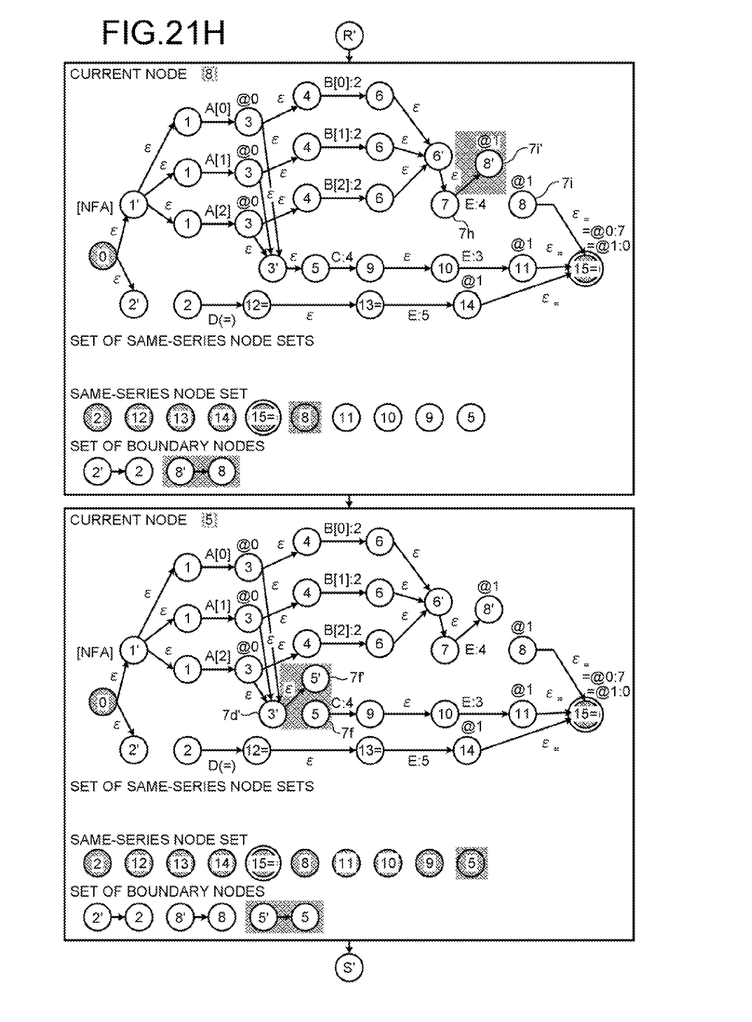

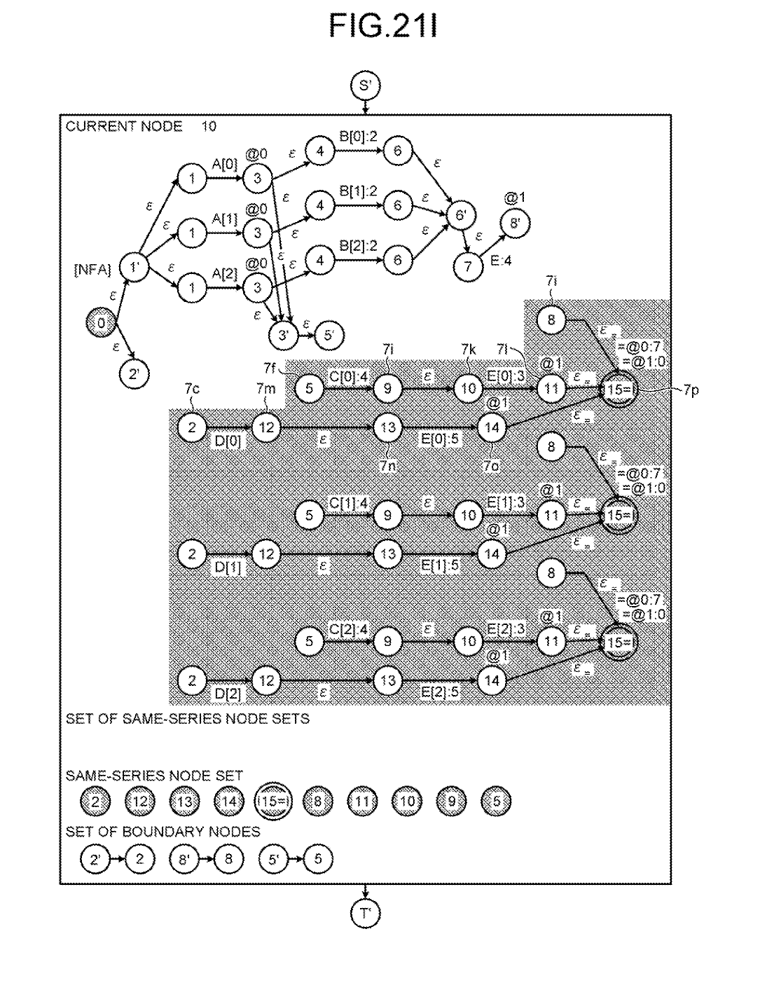

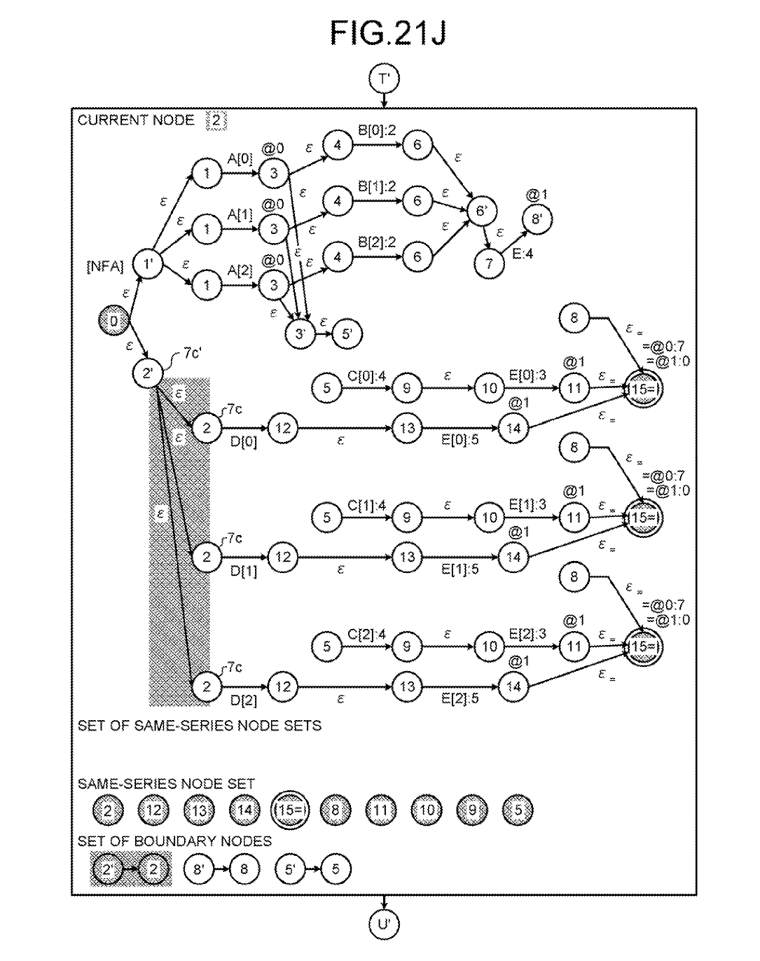

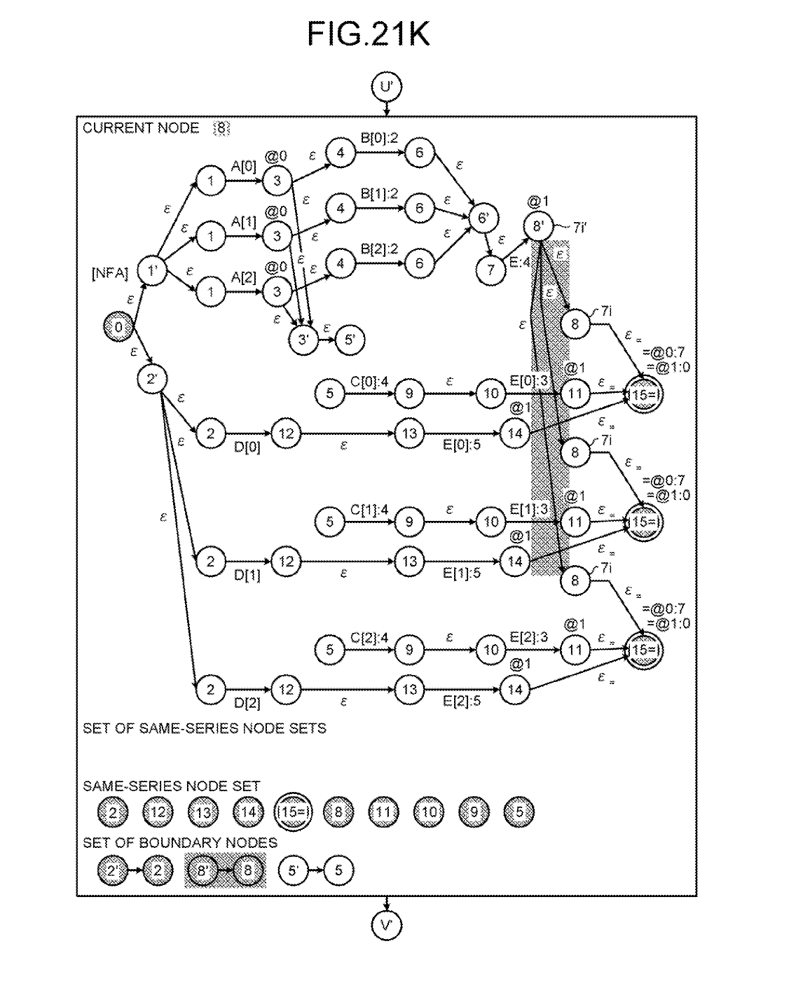

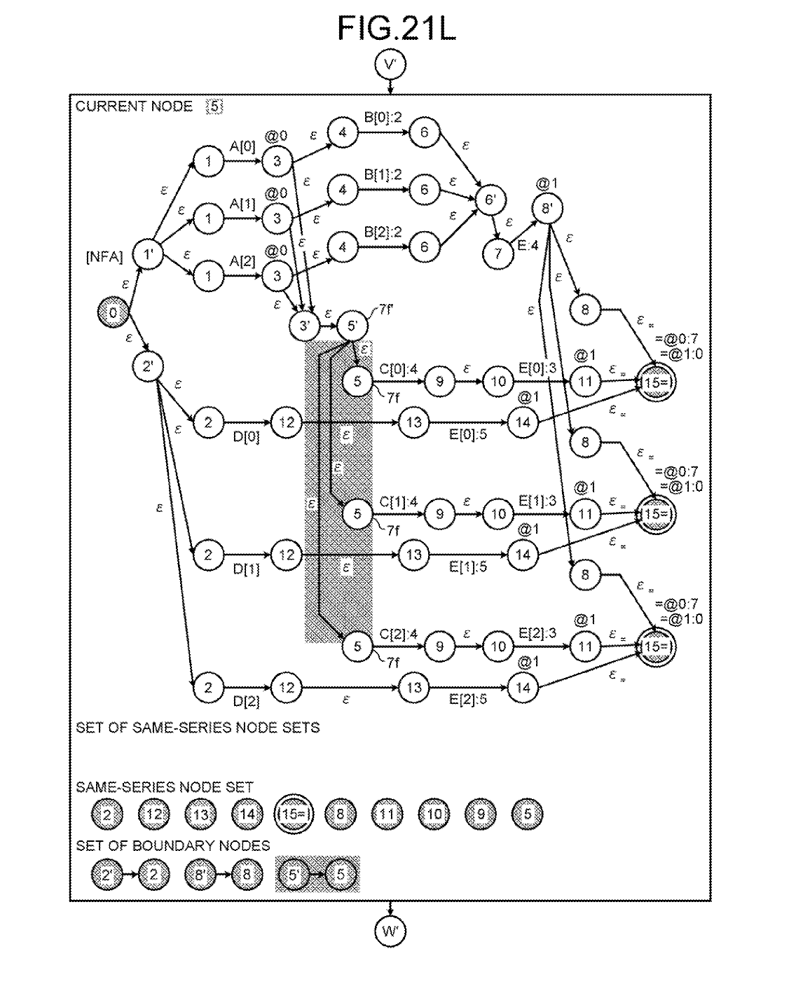

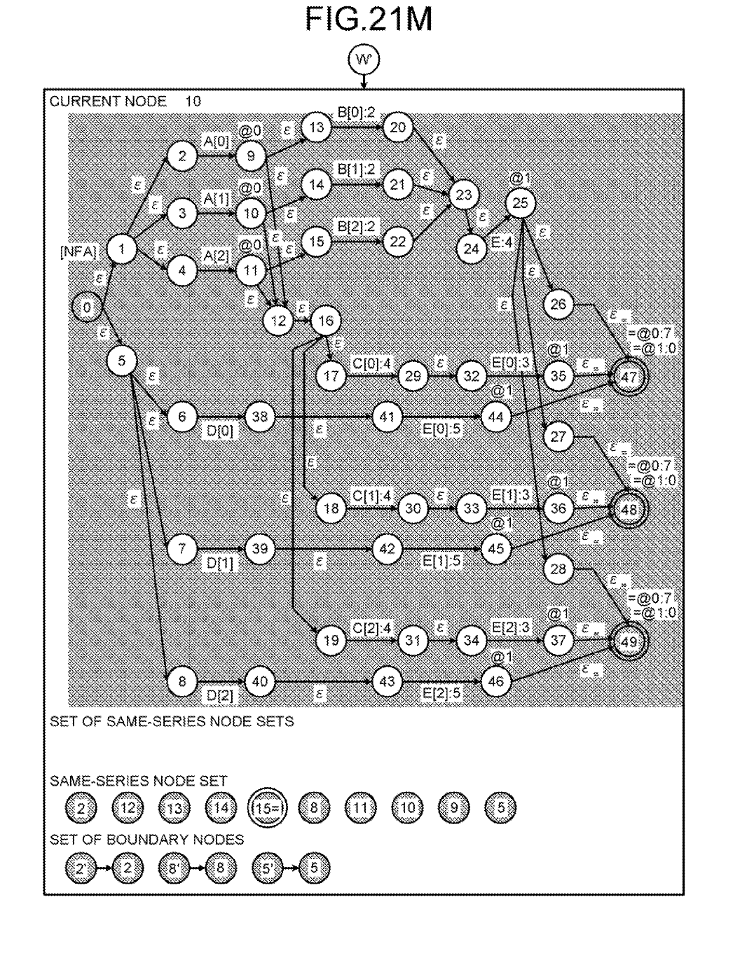

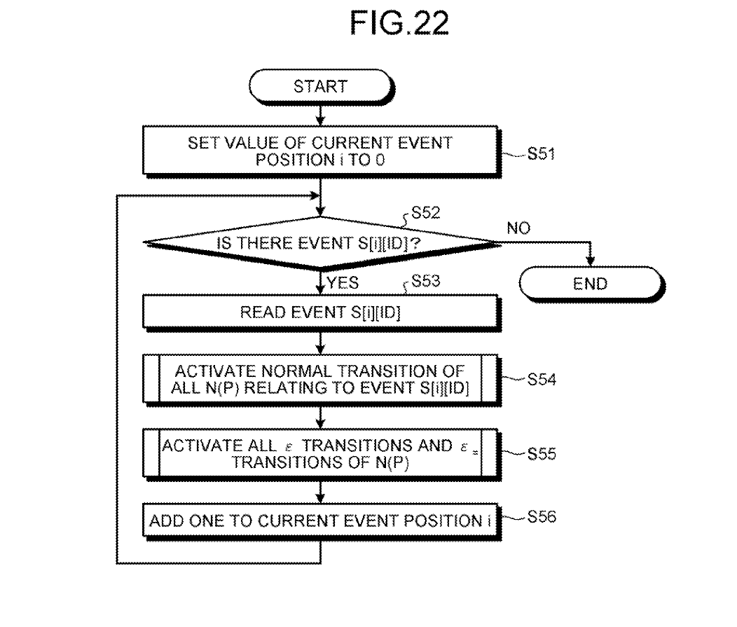

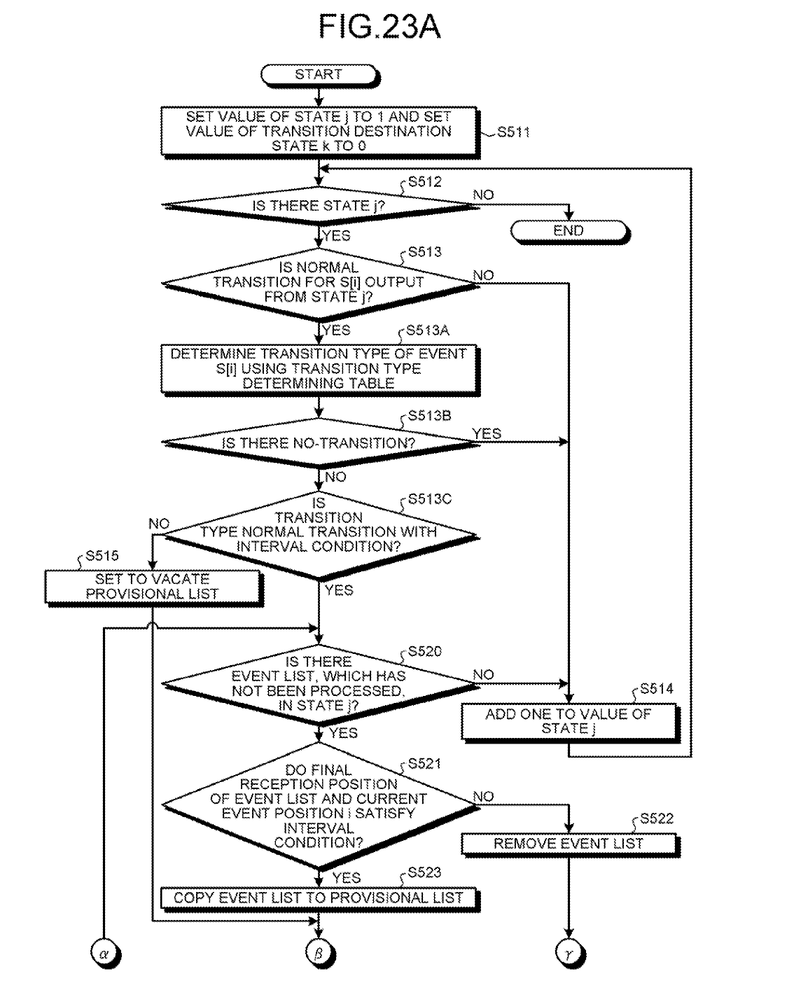

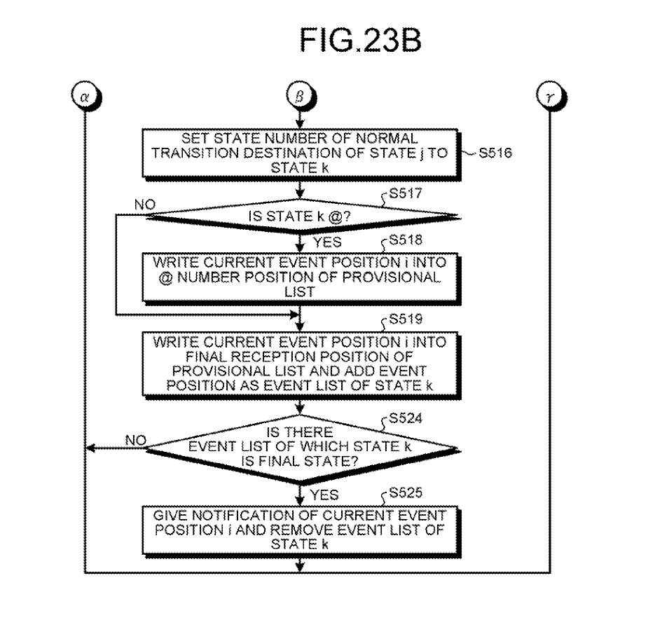

FIG. 21H is a diagram that illustrates the same-series NFA converting process for another pattern;

FIG. 21I is a diagram that illustrates the same-series NFA converting process for another pattern;

FIG. 21J is a diagram that illustrates the same-series NFA converting process for another pattern;

FIG. 21K is a diagram that illustrates the same-series NFA converting process for another pattern;

FIG. 21L is a diagram that illustrates the same-series NFA converting process for another pattern;

FIG. 21M is a diagram that illustrates the same-series NFA converting process for another pattern;

FIG. 22 is a flowchart that illustrates the sequence of a main process of a pattern collation that is performed by a collation unit;

FIGS. 23A and 23B are flowcharts that illustrate the processing sequence of a process for activating a normal transition;

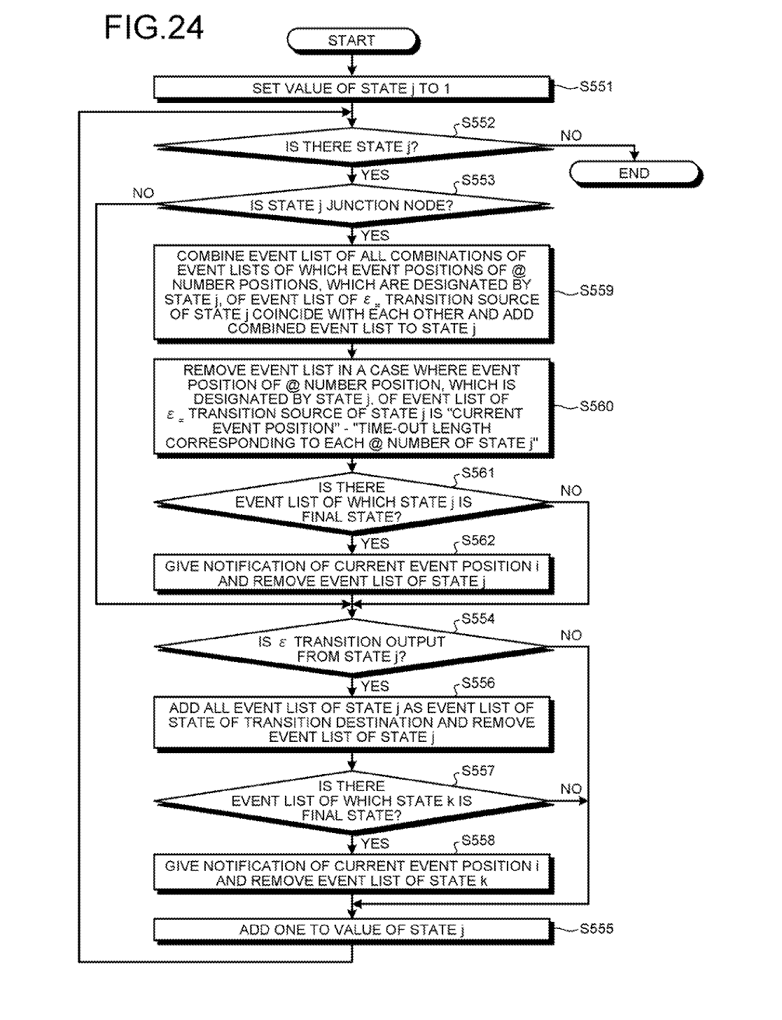

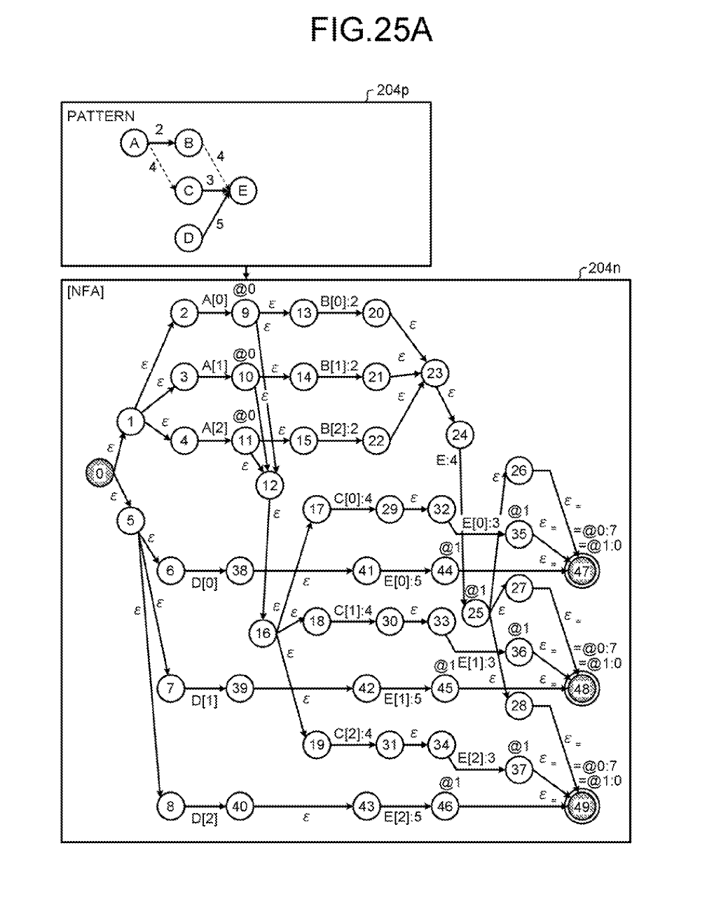

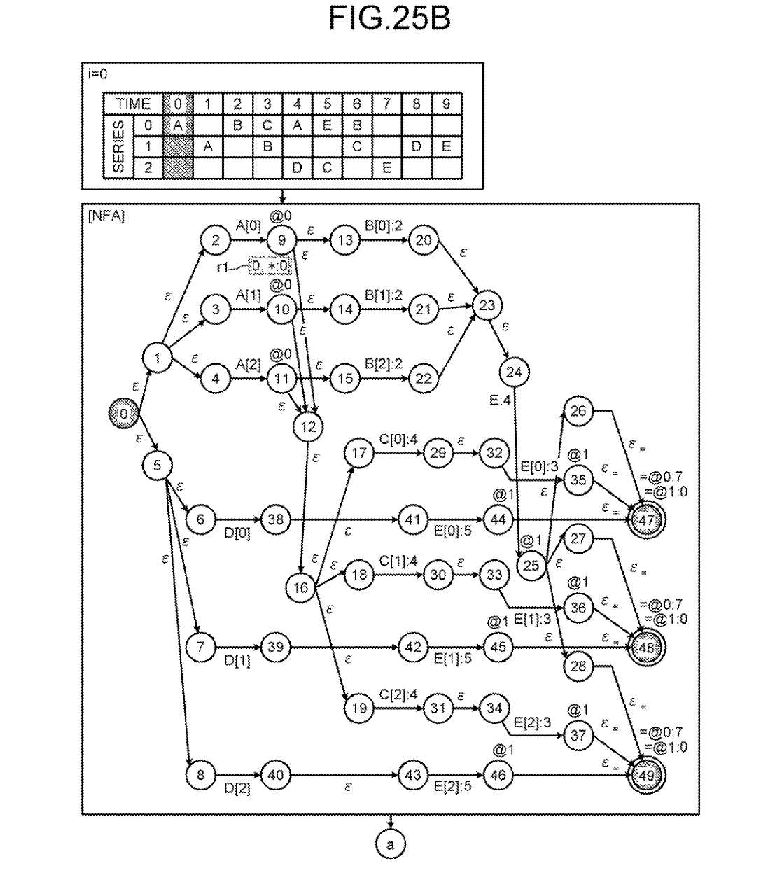

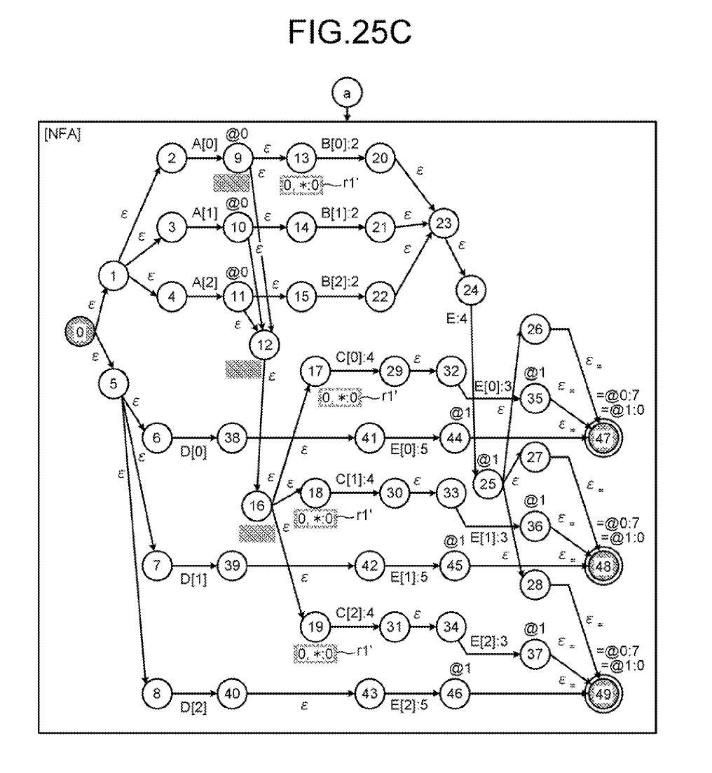

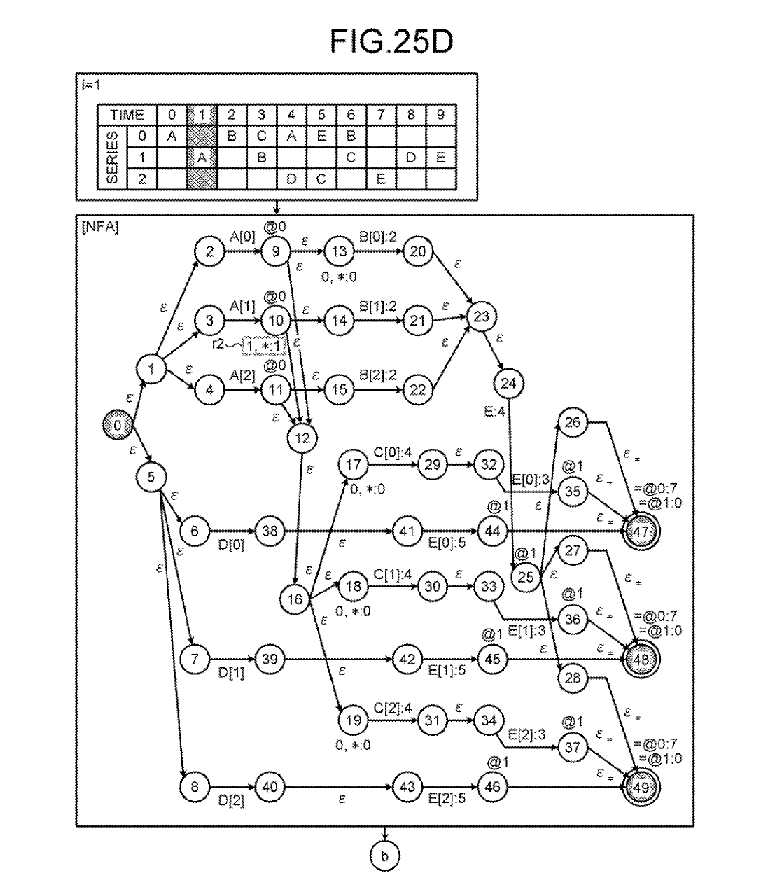

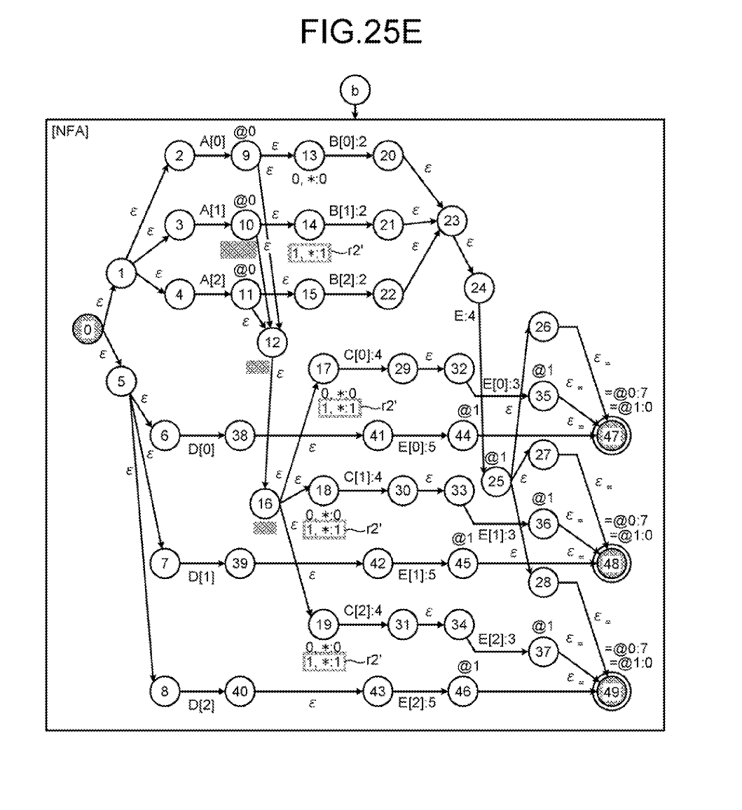

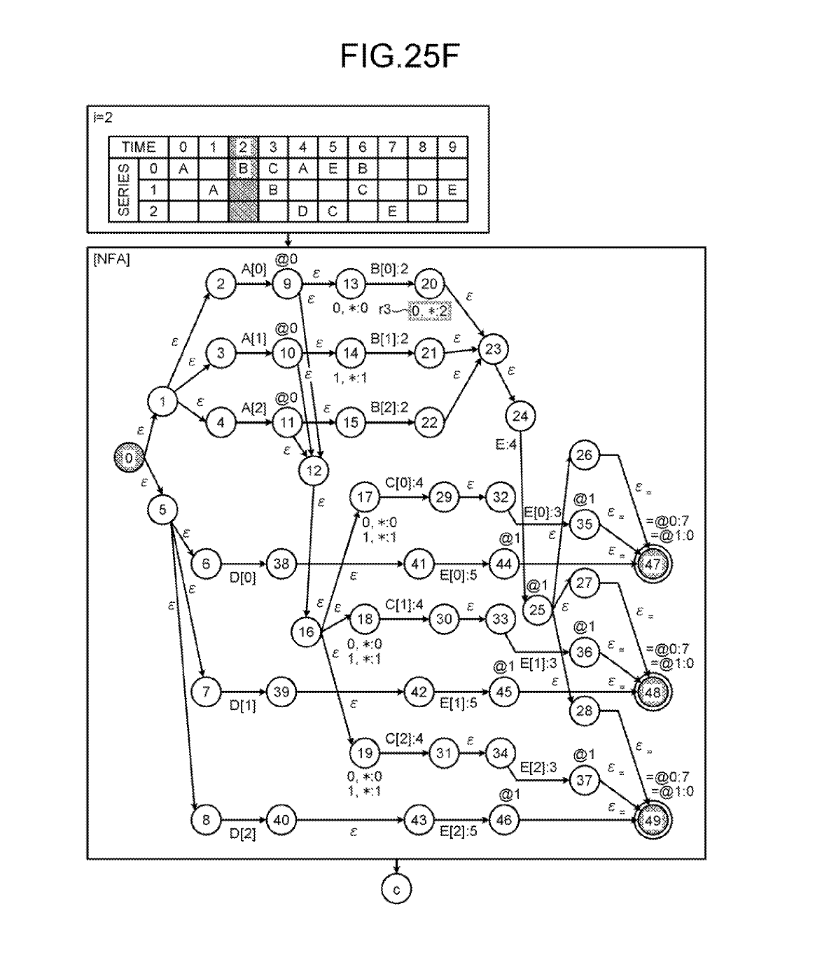

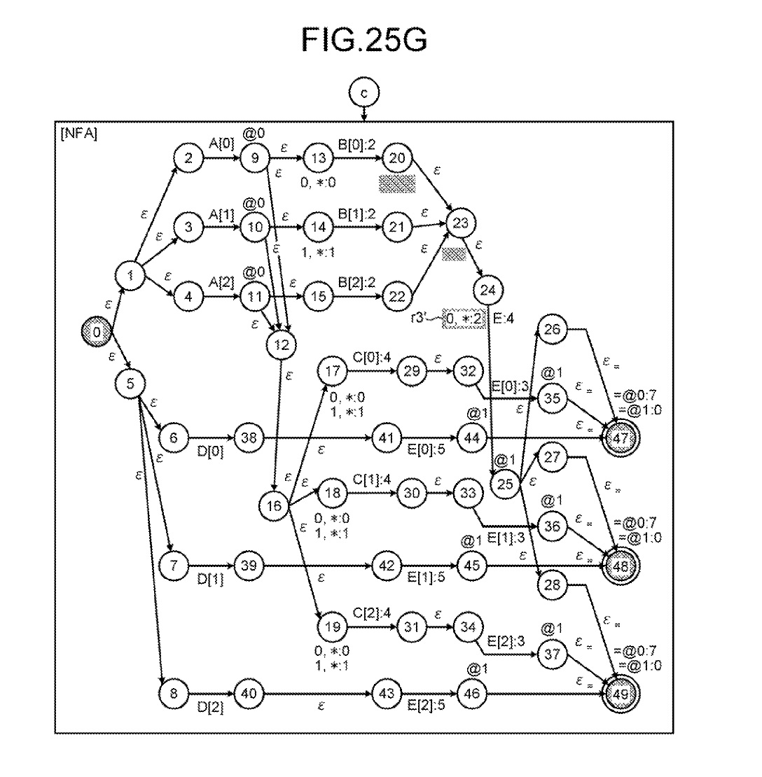

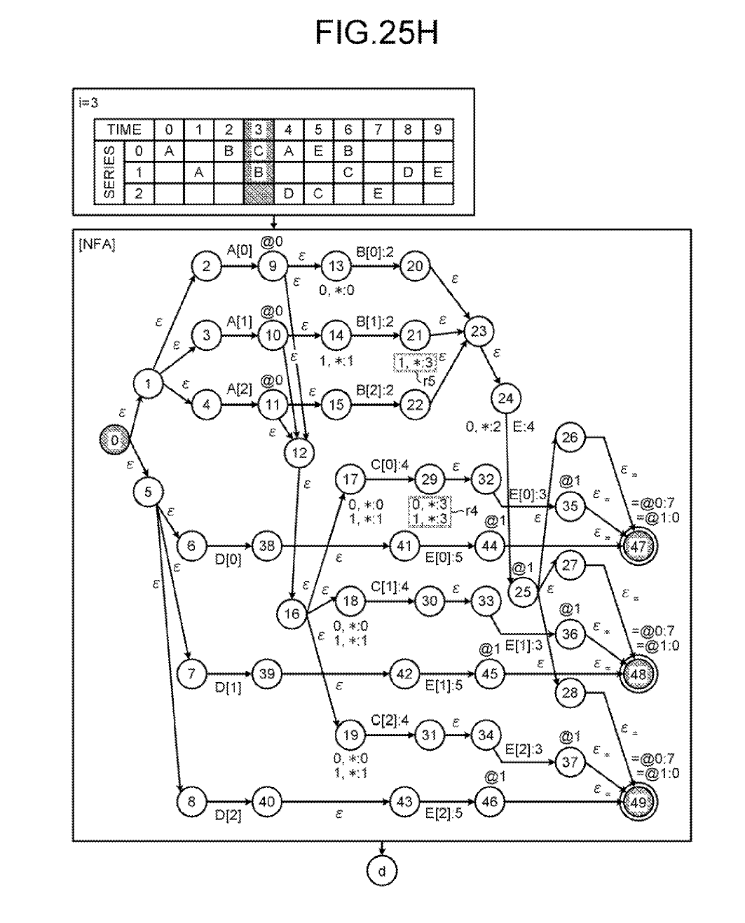

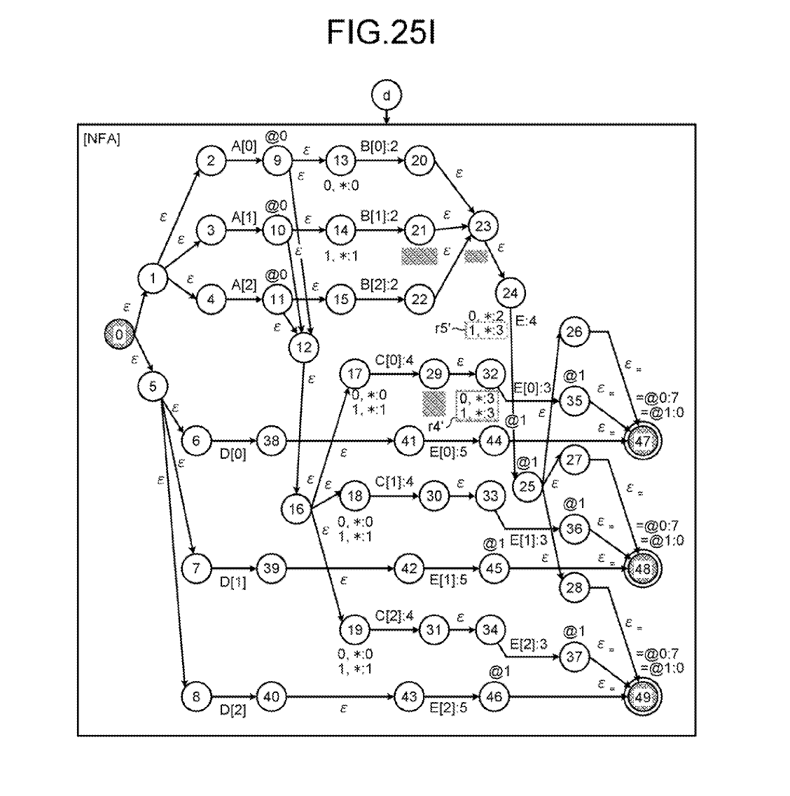

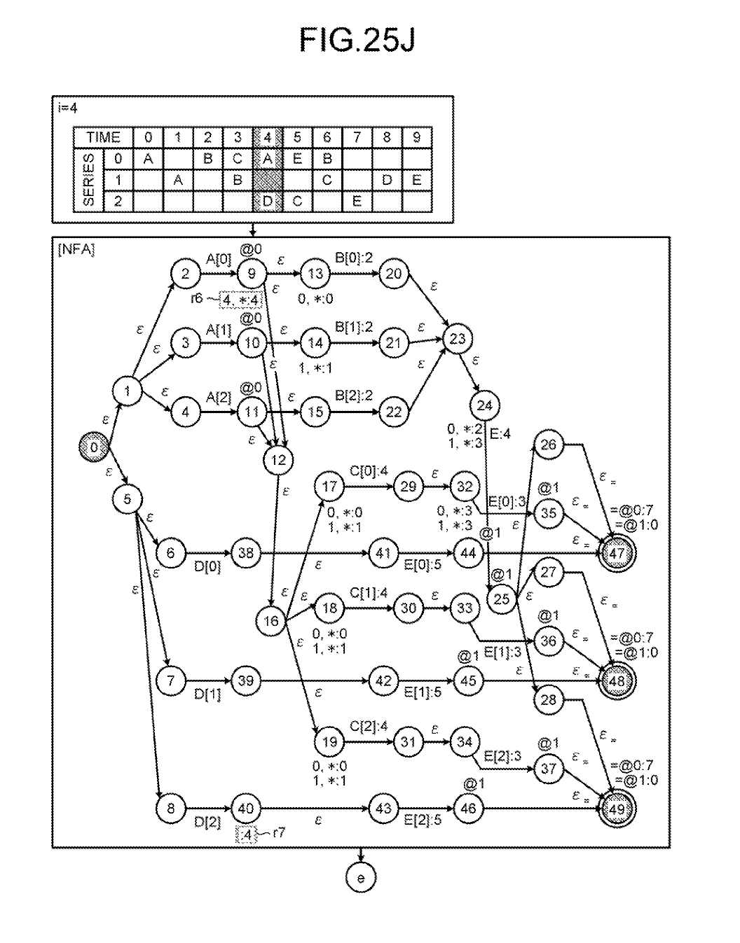

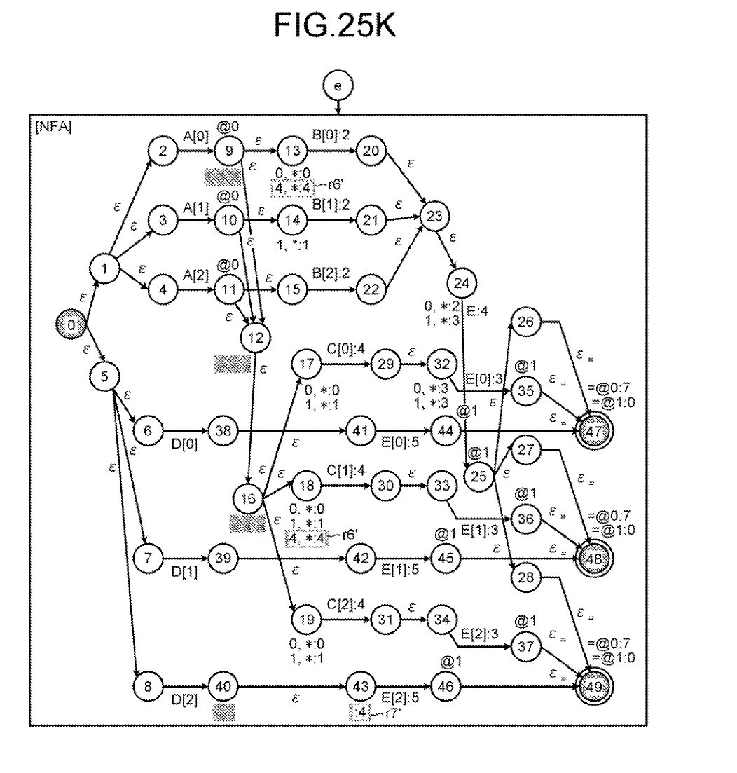

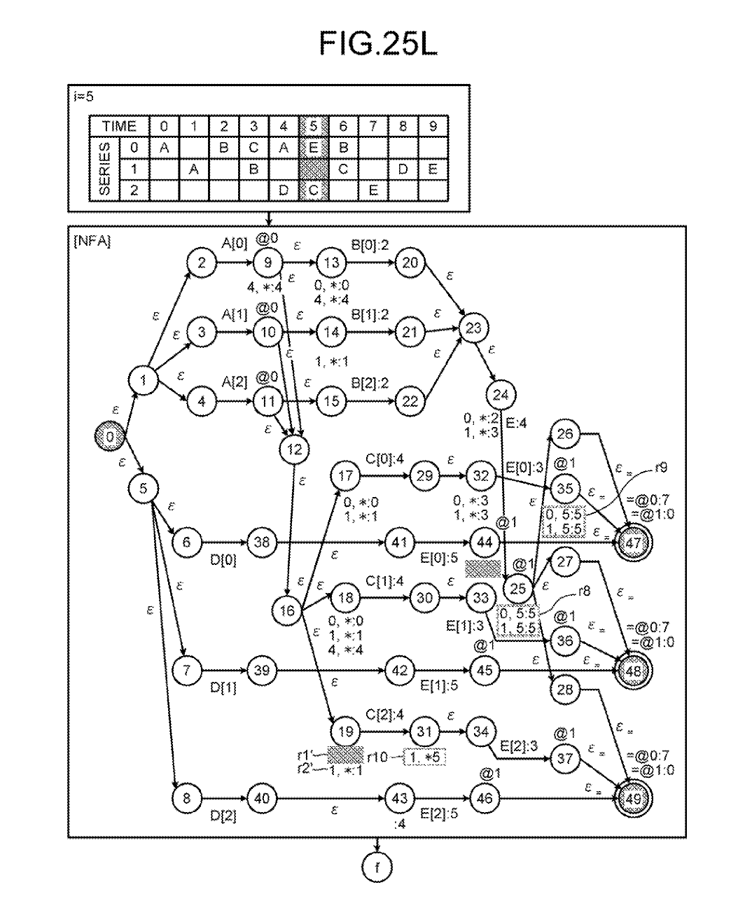

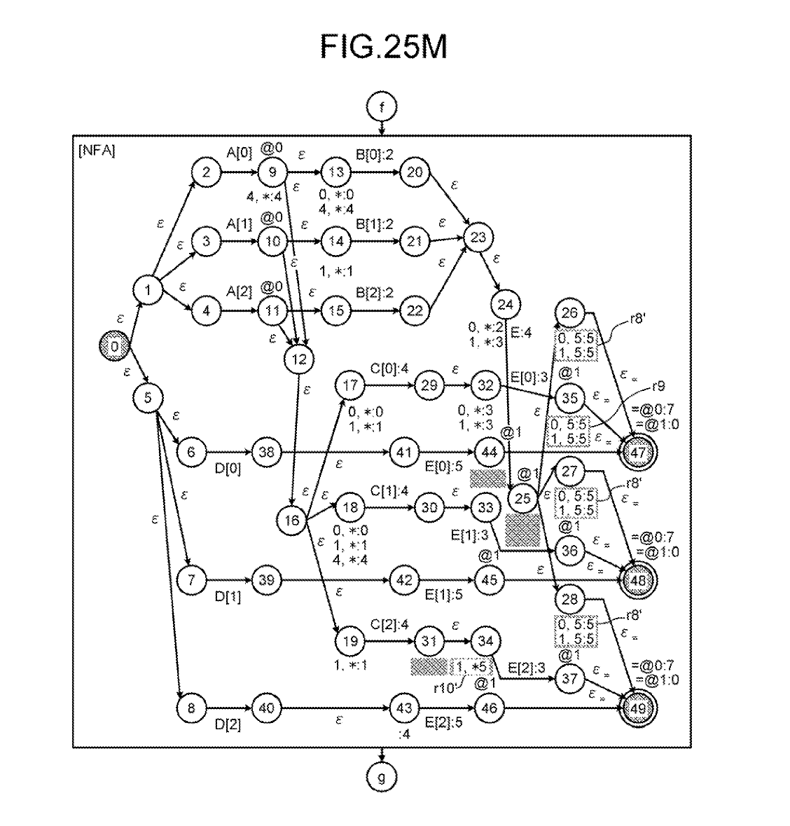

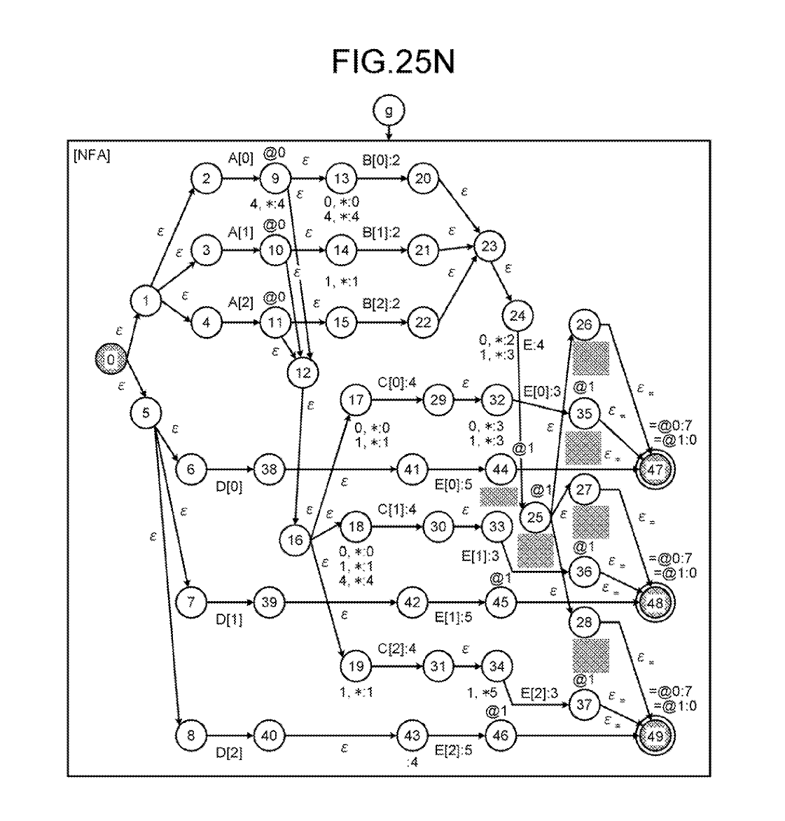

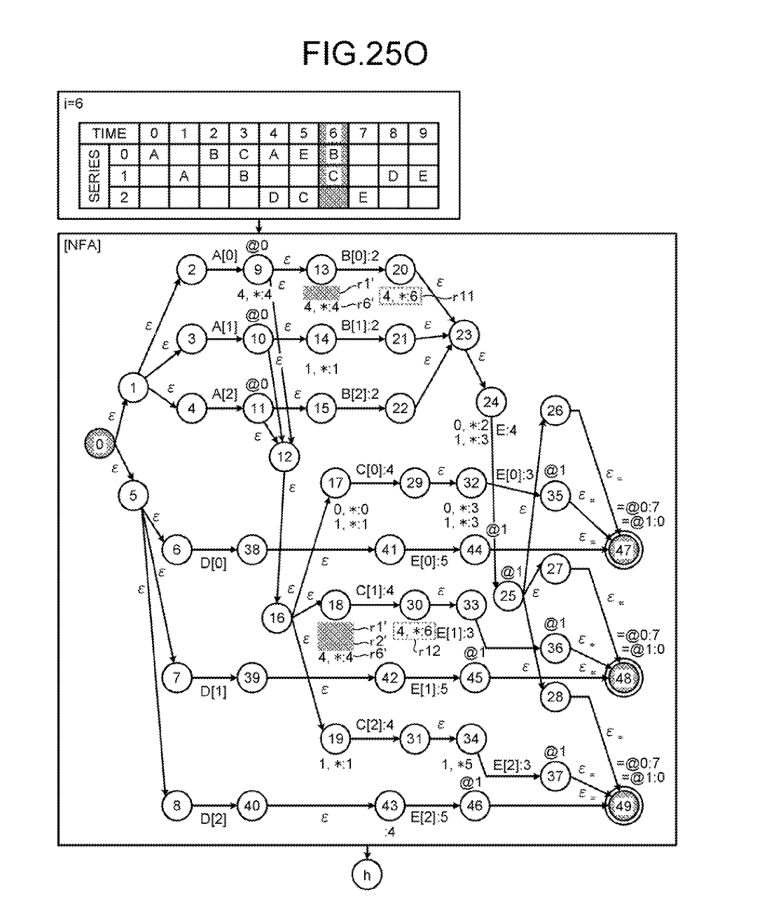

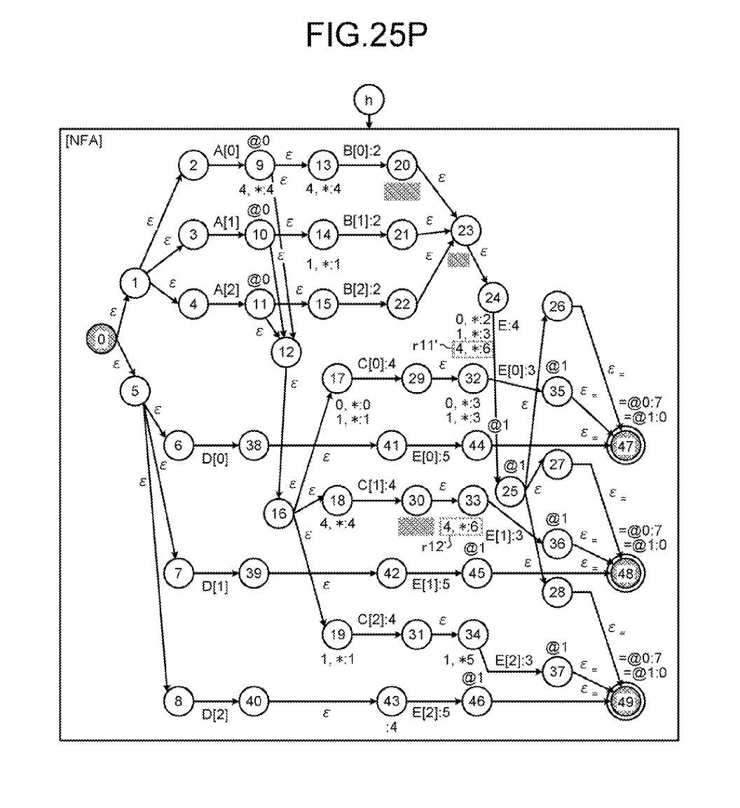

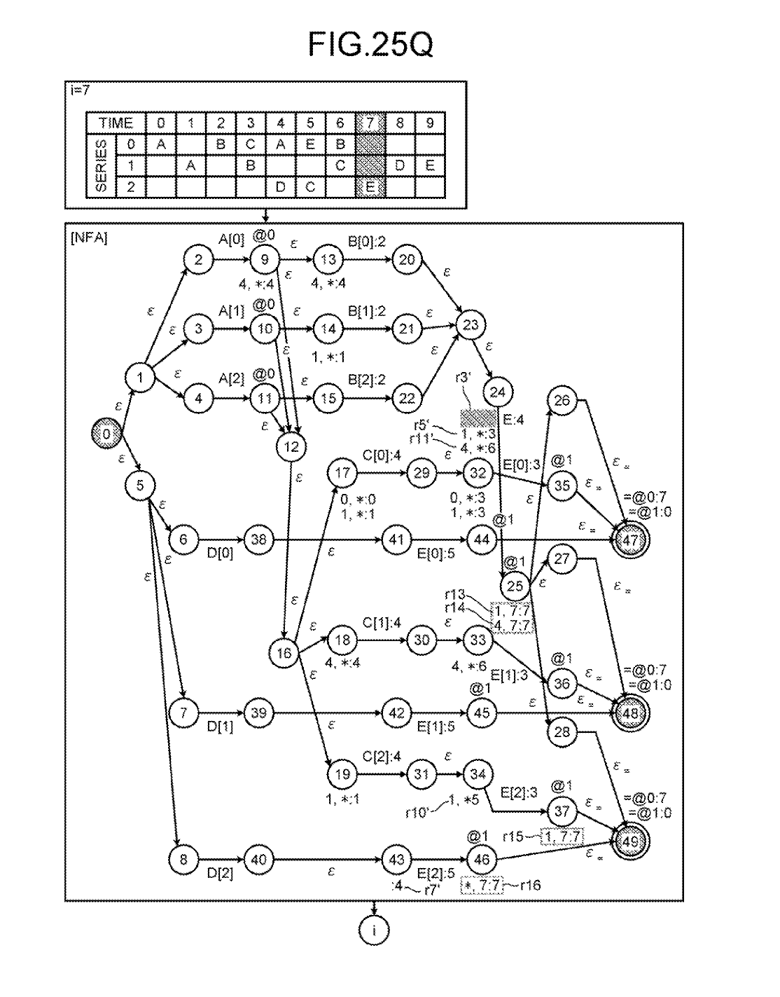

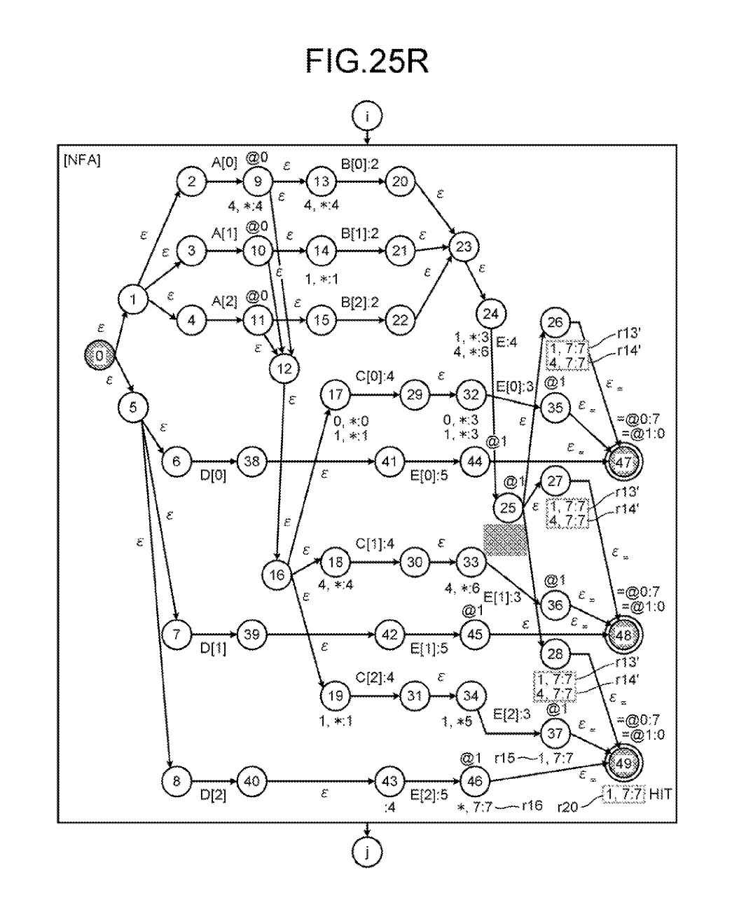

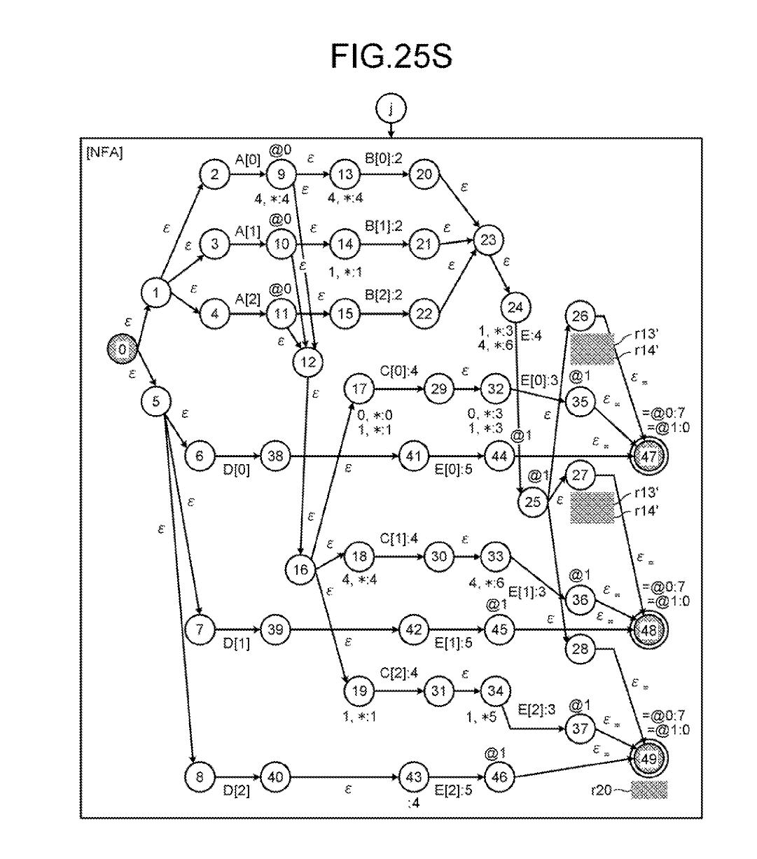

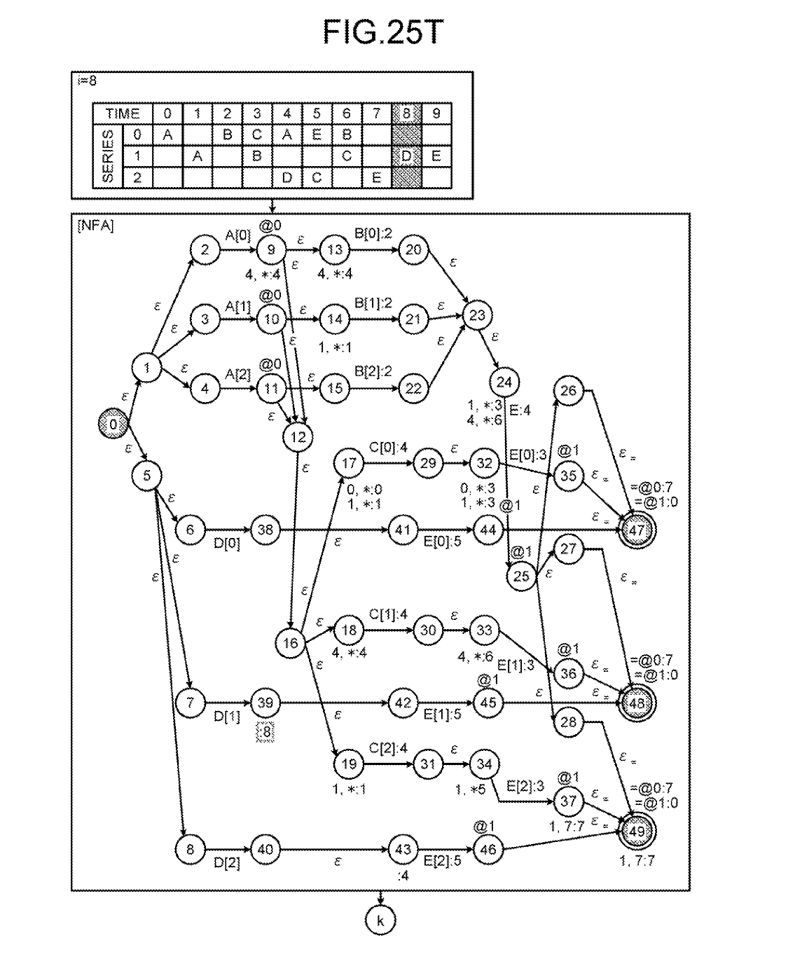

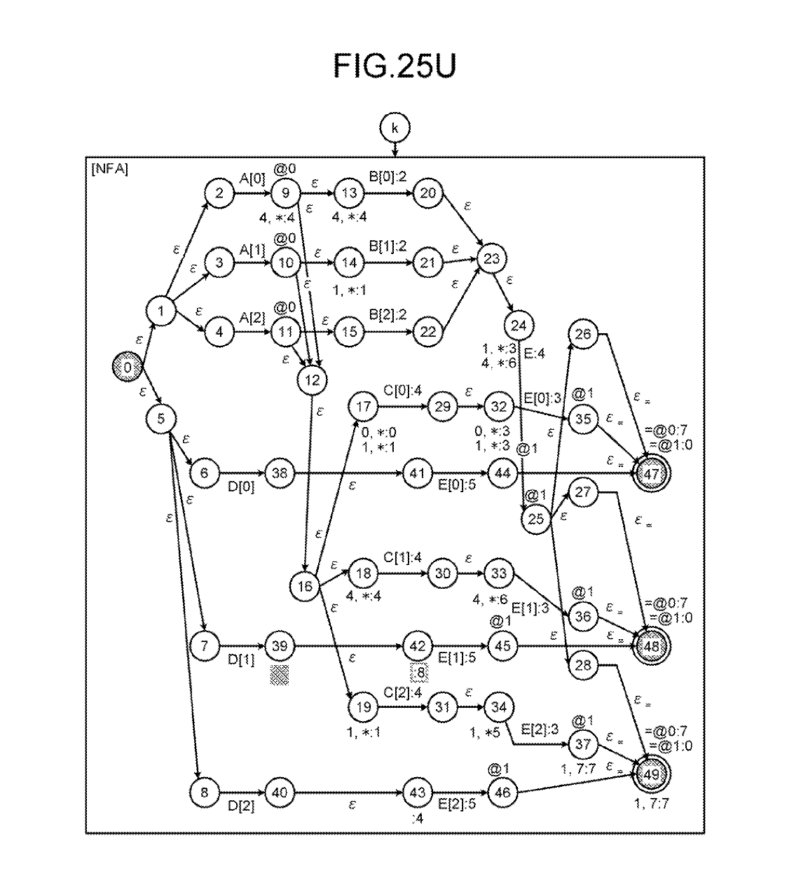

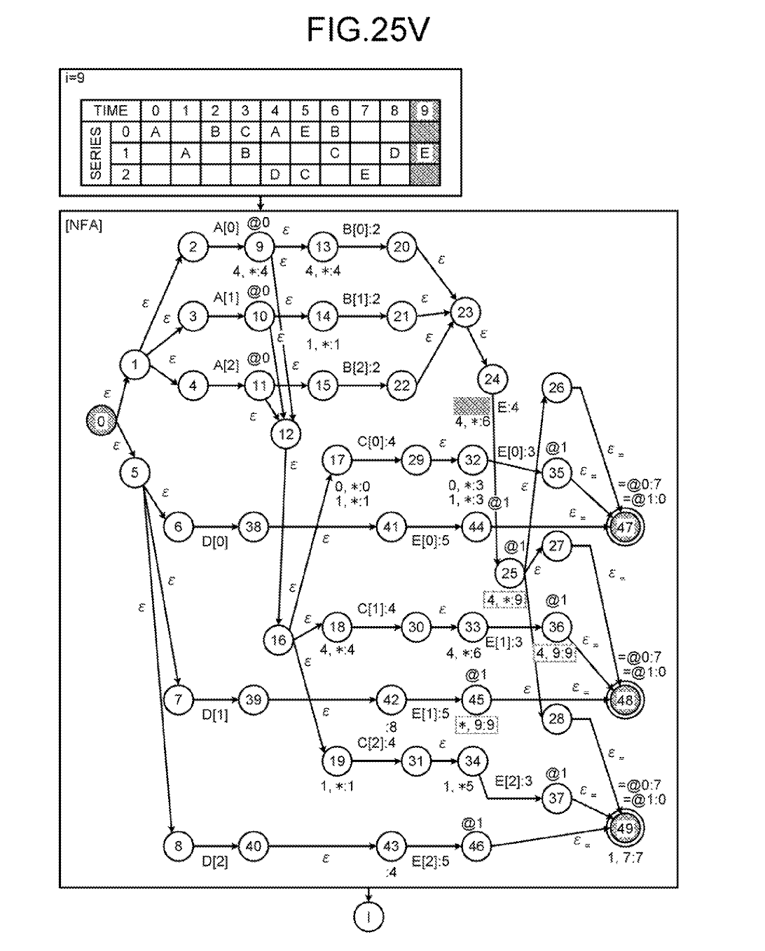

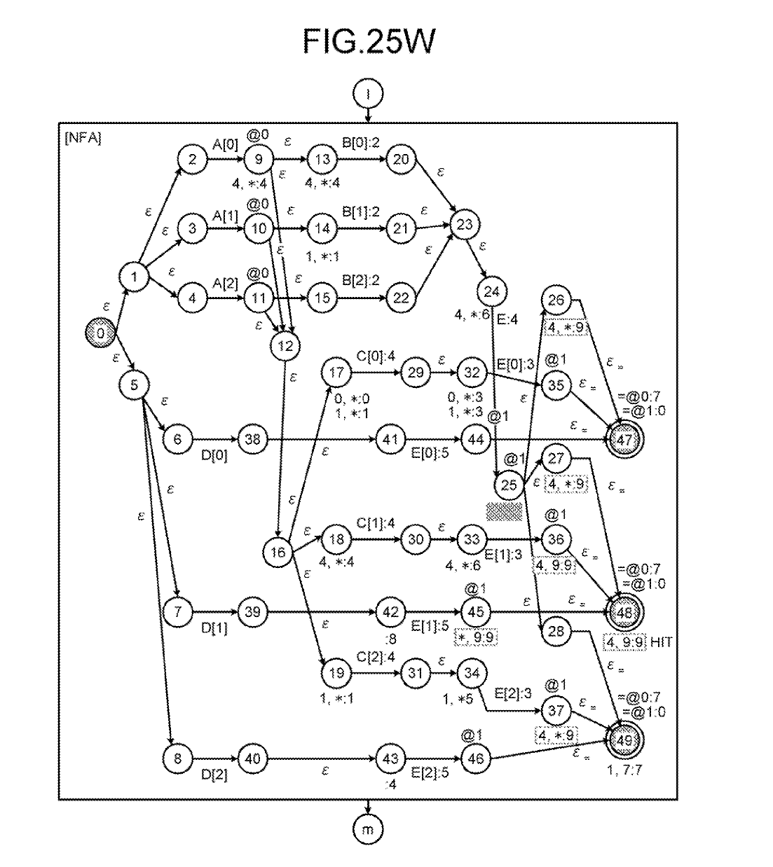

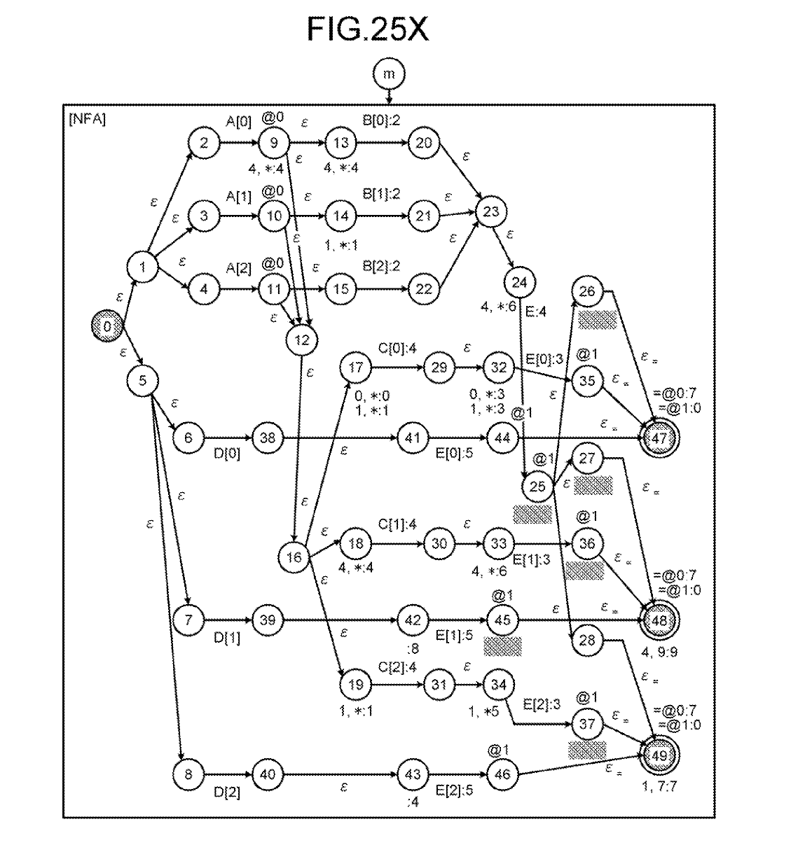

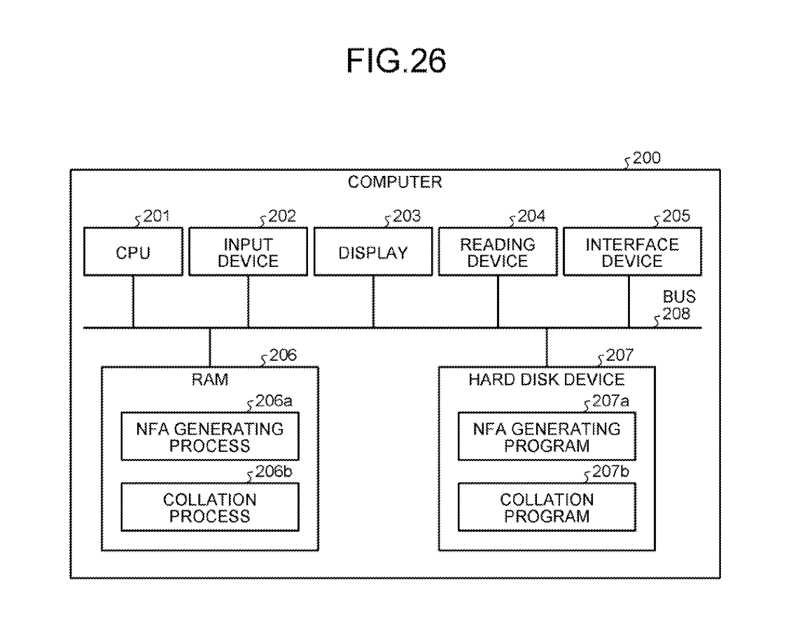

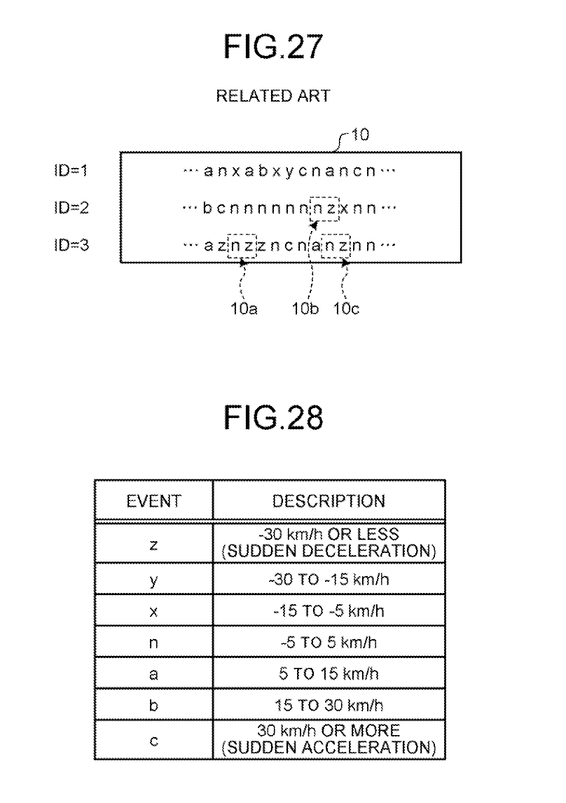

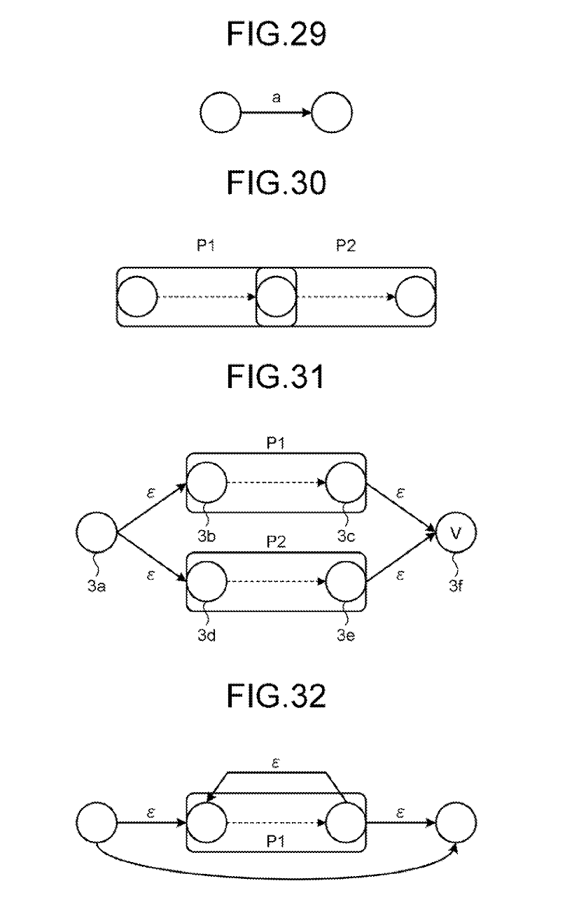

FIG. 24 is a flowchart that illustrates the sequence of a process for activating all the ε transitions and ε=transitions;

FIG. 25A is a diagram that illustrates the process of the collation unit;

FIG. 25B is a diagram that illustrates the process of the collation unit;

FIG. 25C is a diagram that illustrates the process of the collation unit;

FIG. 25D is a diagram that illustrates the process of the collation unit;

FIG. 25E is a diagram that illustrates the process of the collation unit;

FIG. 25F is a diagram that illustrates the process of the collation unit;

FIG. 25G is a diagram that illustrates the process of the collation unit;

FIG. 25H is a diagram that illustrates the process of the collation unit;

FIG. 25I is a diagram that illustrates the process of the collation unit;

FIG. 25J is a diagram that illustrates the process of the collation unit;

FIG. 25K is a diagram that illustrates the process of the collation unit;

FIG. 25L is a diagram that illustrates the process of the collation unit;

FIG. 25M is a diagram that illustrates the process of the collation unit;

FIG. 25N is a diagram that illustrates the process of the collation unit;

FIG. 25O is a diagram that illustrates the process of the collation unit;

FIG. 25P is a diagram that illustrates the process of the collation unit;

FIG. 25Q is a diagram that illustrates the process of the collation unit;

FIG. 25R is a diagram that illustrates the process of the collation unit;

FIG. 25S is a diagram that illustrates the process of the collation unit;

FIG. 25T is a diagram that illustrates the process of the collation unit;

FIG. 25U is a diagram that illustrates the process of the collation unit;

FIG. 25V is a diagram that illustrates the process of the collation unit;

FIG. 25W is a diagram that illustrates the process of the collation unit;

FIG. 25X is a diagram that illustrates the process of the collation unit;

FIG. 26 is a diagram that illustrates an example of a computer that executes a collation program;

FIG. 27 is a diagram that illustrates a related technology;

FIG. 28 is a diagram in which events and descriptions of the events are associated with each other;

FIG. 29 is a diagram that illustrates an NFA corresponding to a single event;

FIG. 30 is a diagram that illustrates an NFA corresponding to a serial pattern;

FIG. 31 is a diagram that illustrates an NFA corresponding to a selection pattern; and

FIG. 32 is a diagram that illustrates an NFA corresponding to a repetitive pattern.

### DESCRIPTION OF EMBODIMENTS

In the above-described related technology, in a case where a condition using two events included in the same series is set, there is a problem in that a process of determining the identity of the series between the two events for event data of a plurality of series is delayed.

For example, in a case where an event pattern using two events included in the same series is set, a large amount of events in the past is searched for the event pattern of the events included in the same series for an event stream including events included in a plurality of series. As a result, a process of determining the identity of the series between two events is delayed.

Also in the related NFA, since the relation of the series between two events is not be set, the event is searched for an event pattern included in the same series for an event stream. As a result, the process of determining the identity of series between two events is delayed.

Preferred embodiments of the present invention will be explained with reference to accompanying drawings. However, the present invention is not limited by the embodiment.

### Embodiment

Configuration of Collation System According to Embodiment

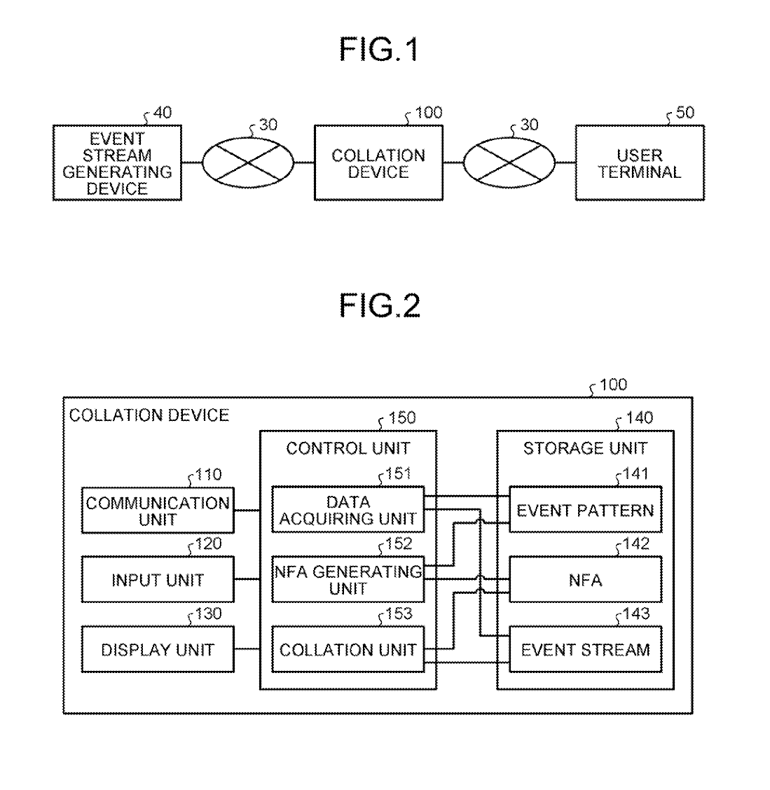

An example of the configuration of a collation system according to an embodiment will be described. FIG. 1 is a diagram that illustrates the configuration of the collation system according to this embodiment. As illustrated in FIG. 1, this collation system includes an event stream generating device 40, a user terminal 50, and a collation device 100. The collation device 100 is connected to the event stream generating device 40 and the user terminal 50 through a network 30.

The event stream generating device 40 is a device that generates an event stream including a series of a plurality of events of a plurality of systems. The event stream generating device 40 transmits information of the event stream to the collation device 100.

The user terminal 50 is a device that transmits an event pattern to the collation device 100 and receives a collation result from the collation device 100.

The collation device 100 is a device that collates whether or not an event pattern is included in the event stream. The collation device 100 transmits a collation result to the user terminal 50.

Configuration of Collation Device According to Embodiment

The configuration of the collation device 100 that is illustrated in FIG. 1 will now be described. FIG. 2 is a functional block diagram that illustrates the configuration of the collation device according to an embodiment. As illustrated in FIG. 2, the collation device 100 includes a communication unit 110, an input unit 120, a display unit 130, a storage unit 140, and a control unit 150.

The communication unit 110 is a processing unit that performs data communication with the event stream generating device 40 and the user terminal 50 through the network 30. The control unit 150 to be described later receives information of an event stream or an event pattern through the communication unit 110. The communication unit 110 corresponds to a communication device, a communication card, or the like that performs data communication using a predetermined communication protocol.

The input unit 120 is an input device that is used by a user for inputting various kinds of information to the collation device 100. For example, the input unit 120 corresponds to a keyboard, a mouse, or a touch panel. The display unit 130 is a display device that displays various kinds of information. For example, the display unit 130 corresponds to a display or a touch panel.

The storage unit 140 stores an event pattern 141, an NFA (nondeterministic finite automaton) 142, and an event stream 143. The storage unit 140, for example, corresponds to a semiconductor memory element such as RAM (random access memory), ROM (read only memory), or flash memory or a storage device such as a hard disk or an optical disc.

The event pattern 141 is an event pattern that is used for collating the event stream 143. In this embodiment, the event pattern is assumed to include an event pattern with an interval condition in which two events of a same system are connected to each other through a transition with an interval condition.

As an example, the event pattern 141 is set as a pattern of events with an interval condition of “P={b:(2:a)}”. Here, “a” and “b” represented in this event pattern correspond to events a and b occurring in the same system. In addition, {b:(2:a}} represents that event b that is in the same system as that of event a is received within a difference between events a and b of two.

In addition, as another example, the event pattern 141 is a pattern “P={c:(5:b)}” of events of a same system with an interval condition and a pattern “P2=a” of events with an interval condition in which events of arbitrary systems are connected to each other through a transition with an interval condition. Here, “b” and “c” represented in this event pattern correspond to events b and c that occur in the same system. In addition, “a” represented in this event pattern corresponds to event a occurring in an arbitrary system that is allowed in any system. Furthermore, {c:(5:b)} represents that event c of the same system as that of event b is received within a difference between events b and c of five.

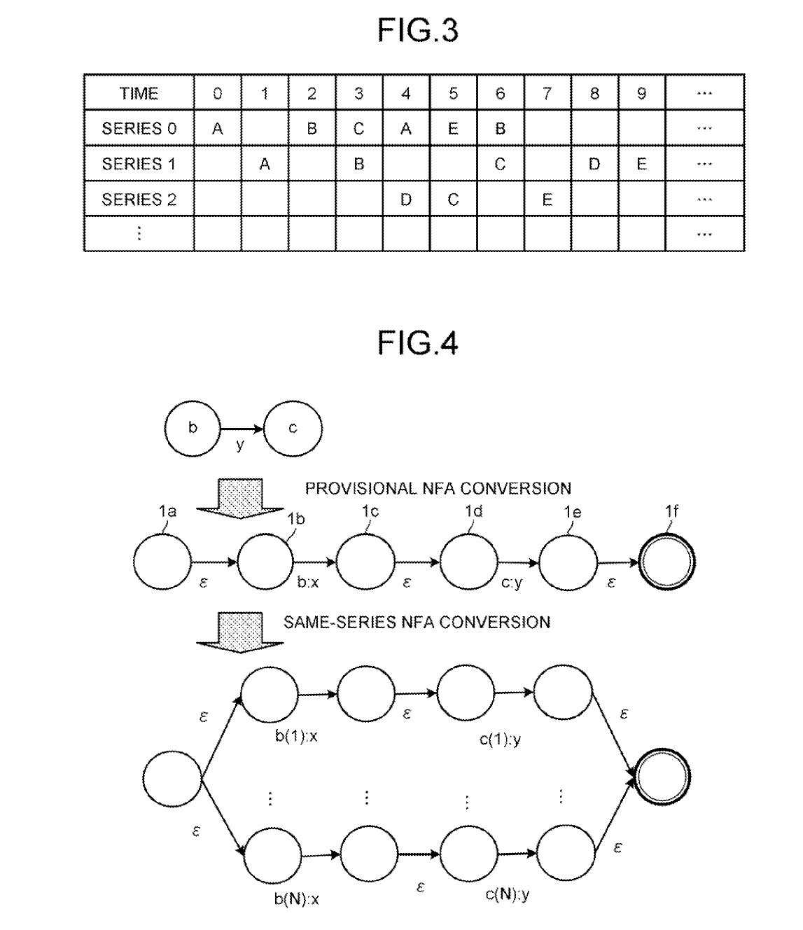

The NFA 142 is a nondeterministic finite automaton that is generated based on the event pattern 141. The event stream 143 is data that includes a series of a plurality of events in a plurality of systems. FIG. 3 is a diagram that illustrates an example of the data structure of an event stream. As illustrated in FIG. 3, the event stream 143 stores an event stream that represents a series of a plurality of events for each system in association with time at which each event occurs with each other. For example, series 0 represents a series of a plurality of events of system 0, stores A at time 0, stores B at time 2, stores C at time 3, stores A at time 4, stores E at time 5, and stores B at time 6. In addition, series 1 represents a series of a plurality of events of system 1, stores A at time 1, stores B at time 3, and stores C at time 6. Here, “A”, “B”, “C”, and “E” correspond to events.

The control unit 150 includes a data acquiring unit 151, an NFA generating unit 152, and a collation unit 153. For example, the control unit 150 corresponds to an integrated device such as an ASIC (application specific integrated circuit) or an FPGA (field programmable gate array). In addition, the control unit 150, for example, corresponds to an electronic circuit such as a CPU or an MPU (micro processing unit).

The data acquiring unit 151 is a processing unit that acquires an event stream from the event stream generating device 40 and acquires an event pattern from the user terminal 50. The data acquiring unit 151 stores an event pattern and an event stream as the event pattern 141 and the event stream 143 in the storage unit 140.

The NFA generating unit 152 is a processing unit that generates the NFA 142 based on the event pattern 141. In addition, although the NFA generating unit 152 generates an NFA by using a Thompson NFA technique, the technique is not limited thereto, but an NFA may be generated by using any related technique. In addition, the NFA generating unit 152 stores the generated NFA 142 in the storage unit 140.

Here, a method of building an NFA using the NFA generating unit 152 will be described. FIGS. 4 to 9 are diagrams that illustrate the method of building an NFA using the NFA generating unit.

FIG. 4 illustrates an NFA for an event pattern with an interval condition for two events of the same series. In FIG. 4, it is assumed that “a” and “b” represent events, and “y” represents an interval condition of the event interval.

As illustrated in an upper stage of FIG. 4, the event pattern 141 is a pattern in which event b occurs in an arbitrary series, and thereafter, event c occurs in the same series as that of “b” within “y”.

As illustrated in a middle stage of FIG. 4, the NFA generating unit 152 converts the event pattern 141 into a provisional NFA. Such a provisional NFA will be referred to as a “provisional NFA”. Here, the NFA generating unit 152 respectively connects node 1a and node 1b, node 1b and node 1c, node 1c and node 1d, node 1d and node 1e, and node 1e and node 1f. Then, the NFA generating unit 152 sets a transition from node 1a to node 1b, a transition from node 1c to node 1d, and a transition from node 1e to node 1f as “ε transitions”. For example, in a case where event b transitions to node 1a, a transition from node 1a to node 1b is activated. Then, the NFA generating unit 152 sets the transition from node 1d to node 1e as a transition “c:y” with a condition of an event interval. In other words, when node 1d receives event c, in a case where the node 1d satisfies an interval condition y with the received event b, a transition from node 1d to node 1e is activated. As above, a normal transition that is made from a node to another node based on checking an interval condition will be referred to as a “normal transition with an interval condition”. In addition, in the example illustrated in FIG. 4, the transition from node 1b to node 1c is set as a normal transition “b:x” with an interval condition for event b. In other words, when event b is received by node 1b, in a case where an interval condition x with an event that has already been received by node 1b is satisfied, the transition from node 1b to node 1c is activated.

As illustrated in a lower stage of FIG. 4, the NFA generating unit 152 replicates an NFA part of the provisional NFA, which has the relation of a same series, for a plurality of series, substitutes each NFA part that has been replicated with a transition that is received in an event of each series, and combines each substituted NFA part through an ε transition. Here, the NFA generating unit 152 replicates an NFA part, which has the relation of a same series, of node 1b to node 1e of the provisional NFA for N series as a plurality of series and substitutes the transition of each replicated NFA part with a transition that is received in an event of each series. In addition, the NFA generating unit 152 combines the replicated NFA parts through ε transitions. Here, the NFA generating unit 152 substitutes the normal transition of series 1 with an interval condition by “b(1):x” and “c(1):y” and substitutes the normal transition of series N with an interval condition with “b(N):x” and “c(N):y”. Accordingly, for example, “c(1):y” is received only by event c of series 1, and “c(N):y” is received only by event c of series N.

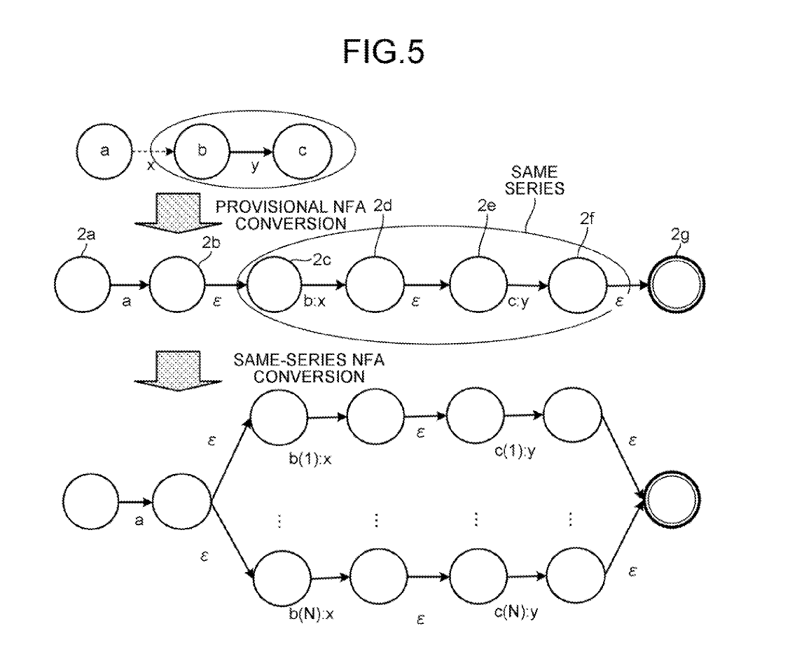

FIG. 5 illustrates an NFA for an event pattern with an interval condition for two events of a same series and an event pattern acquired by collating events of arbitrary series. In FIG. 5, “a”, “b”, and “c” represent events, and “x” and “y” represent an interval condition of the event interval.

As illustrated in an upper stage of FIG. 5, the event pattern 141 is a pattern in which event b occurs in an arbitrary series within x after the occurrence of event a in an arbitrary series, and thereafter, event c occurs in the same series as that of event b within y. In the event pattern 141, a transitional relation in a same series is denoted by a solid line, and a transitional relation in an arbitrary series is denoted by a broken line.

As illustrated in a middle stage of FIG. 5, the NFA generating unit 152 converts the event pattern 141 into a provisional NFA. Here, the NFA generating unit 152 respectively connects node 2a and node 2b, node 2b and node 2c, node 2c and node 2d, node 2d and node 2e, node 2e and node 2f, and node 2f and node 2g. In addition, the NFA generating unit 152 sets a transition from node 2a to node 2b to “a”. In other words, when node 2a receives event a, the transition from node 2a to node 2b is unconditionally activated. As above, a normal transition for an unconditional transition from a node to another node will be referred to as a “normal transition without an interval condition”. In addition, the NFA generating unit 152 sets a transition from node 2b to node 2c, a transition from node 2d to node 2e, and a transition from node 2f to node 2g as “ε transitions”. Furthermore, the NFA generating unit 152 sets a transition from node 2c to node 2d as a transition “b:x” with a condition of an event interval. In addition, the NFA generating unit 152 sets a transition from node 2e to node 2f as a transition “c:y” with a condition of an event interval. Then, the NFA generating unit 152 sets an NFA part having the relation of a same series in the provisional NFA as same-series relation information. Here, node 2c to node 2f correspond to an NFA part having the same-series relation, and the NFA generating unit 152 sets this NFA part as the same-series relation information.

As illustrated in a lower stage of FIG. 5, the NFA generating unit 152 searches for an NFA part having the same-series relation from the provisional NFA and separates the retrieved NFA part having the same-series relation. Then, the NFA generating unit 152 replicates the separated NFA part having the same-series relation for a plurality of series and substitutes each replicated NFA part with a transition that is received in an event of each series. Then, the NFA generating unit 152 combines joining portions between each substituted NFA part and the original provisional NFA before separation through ε transitions. Here, the NFA generating unit 152 replicates the NFA part, which has the same series relation, of node 2c to node 2f for N series as a plurality of series and substitutes a transition of the replicated NFA part with a transition that is received in an event of each series. In addition, the NFA generating unit 152 combines each replicated NFA part and node 2b that is a joining portion of the original provisional NFA before separation through an ε transition. Accordingly, for example, in “c(1):y”, only event c of series 1 is received, and, in “c(N):y”, only event c of series N is received. In addition, for example, in “a”, events a of all the series are received.

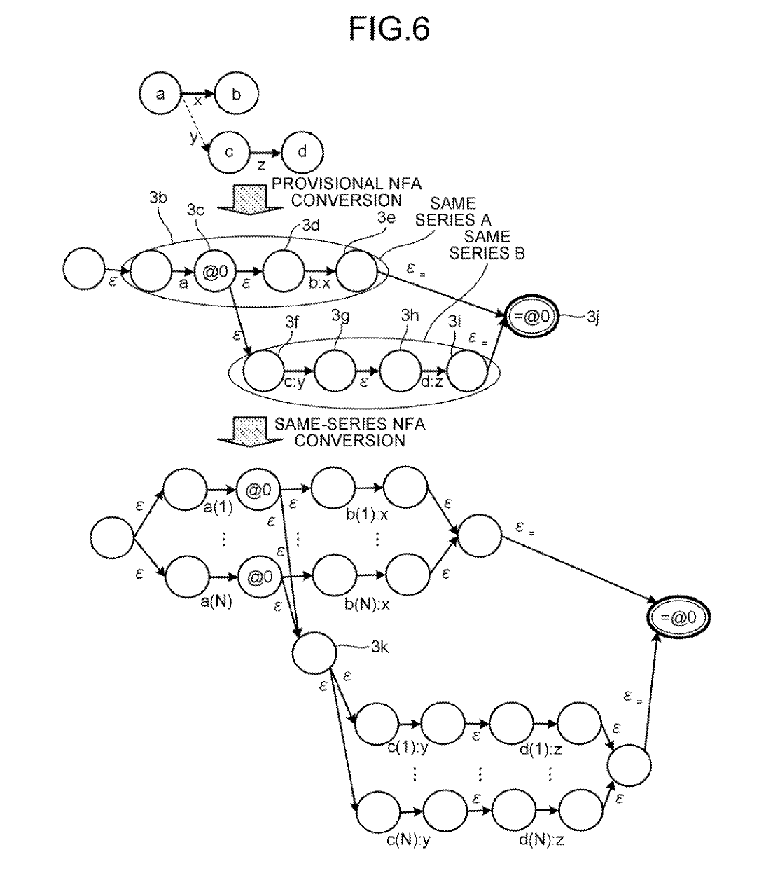

FIG. 6 illustrates an NFA in a case where a joining portion of the NFA part having the same series relation and a part having the relation of an arbitrary series is present in the middle of the NFA part having the same series relation in the provisional NFA. In FIG. 6, “a”, “b”, “c”, and “d” represent events, and “x” and “y” represent the interval condition of the event interval.

As illustrated in an upper stage of FIG. 6, in the event pattern 141, event a occurs in an arbitrary series, and thereafter, event b occurs in the same series as that of event a within x. Then, the event pattern 141 is a pattern in which event c occurs in an arbitrary series within y after the occurrence of event a in an arbitrary series, and thereafter, event d in the same series as that of event c occurs within z.

As illustrated in a middle stage of FIG. 6, the NFA generating unit 152 converts the event pattern 141 into a provisional NFA. Here, the NFA generating unit 152 converts an event pattern with an interval condition for events a and b included in the event pattern 141 into a provisional NFA of the same series A that is represented by nodes 3b to 3e. In addition, the NFA generating unit 152 converts an event pattern with an interval condition for events c and d included in the event pattern 141 into a provisional NFA of the same series B that is represented by nodes 3f to 3i. Then, the NFA generating unit 152 maintains the reception time of event a that is a starting point of branching in association with node 3c that represents the transition destination of the event a. In other words, node 3c is a joining portion of the same series A and the same series B. Here, a node that maintains the reception time of an event will be referred to as a “reception time maintaining node” (corresponding to a starting point node). In the example illustrated in FIG. 6, the reception time maintaining node is denoted by “@”. The NFA generating unit 152 assigns an @ number (here, “0”), which is a unique identifier, to the reception time maintaining node in correspondence with event a that is a starting point of branching. Then, the NFA generating unit 152 connects node 3c to node 3f, which is a branching destination, through an ε transition. In addition, the NFA generating unit 152 connects node 3e and node 3i to node 3j through ε=transitions. Here, a node that is connected from a plurality of nodes through ε=transitions, in other words, a node that represents a combining point that combines a plurality of nodes will be referred to as a “junction node”. In the example illustrated in FIG. 6, junction node 3j is denoted by “=@0”. In other words, the NFA generating unit 152 determines whether or not the reception time of event a transitioned from a plurality of nodes 3e and 3i in the junction node 3j is the same.

As illustrated in a lower stage of FIG. 6, the NFA generating unit 152 searches for an NFA part having the same series relation from the provisional NFA and separates the retrieved NFA part having the same series relation. Then, the NFA generating unit 152 replicates the separated NFA part having the same series relation for a plurality of series and generates a connection node as a joining portion of each replicated NFA part and an NFA part having an arbitrary series relation. Then, the NFA generating unit 152 joins the generated connection node and the joining portion of each replicated NFA part through an ε transition and joins the generated connection node and the NFA part having the arbitrary series relation through an ε transition. Here, the NFA generating unit 152 replicates an NFA part of the same series A from node 3b to node 3e for an N series as a plurality of series. In addition, the NFA generating unit 152 replicates an NFA part of the same series B from node 3f to node 3i for N series as a plurality of series. Then, the NFA generating unit 152 substitutes the transition of the replicated NFA part with a transition that receives an event of each series. In addition, the NFA generating unit 152 generates a connection node 3k as a joining portion and joins the generated connection node 3k and the joining portions of the replicated NFA parts through ε transitions.

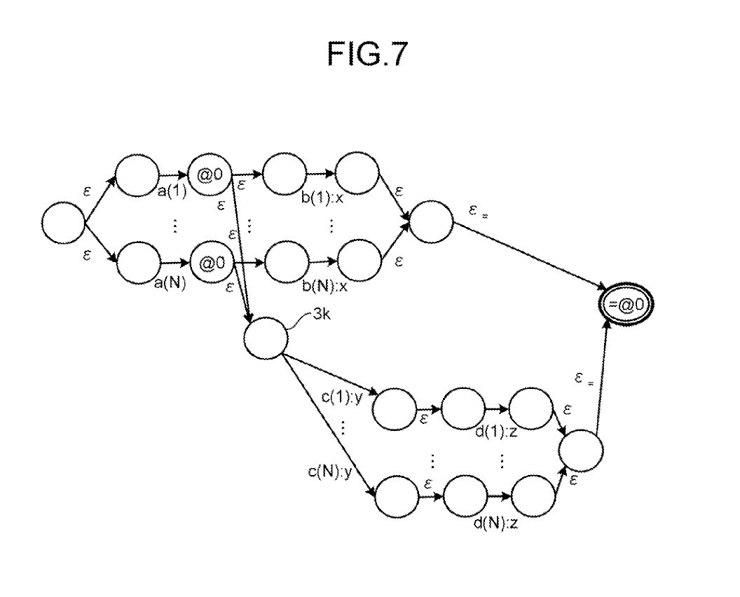

In addition, the NFA that is based on the same-series NFA conversion illustrated in the lower stage of FIG. 6 may be an NFA that is illustrated in FIG. 7. FIG. 7 is a modified example of the NFA in a case where a joining portion of the NFA part having the same series relation and a part having the relation of an arbitrary series is present in the middle of the NFA part having the same series relation in the provisional NFA. In other words, the NFA generating unit 152 joins the generated connection node 3k and the joining portions of all the NFA parts of the same series A, which have been replicated, through ε transitions. Then, the NFA generating unit 152, instead of joining the generated connection node and the joining portion of the replicated NFA part of the same series B through an ε transition, directly connects the generated connection node and the joining portion of the replicated NFA part of the same series B through a transition with an interval condition. Accordingly, the ε transition from the connection node can be omitted, whereby the number of transitions from the connection node can be decreased from N to one.

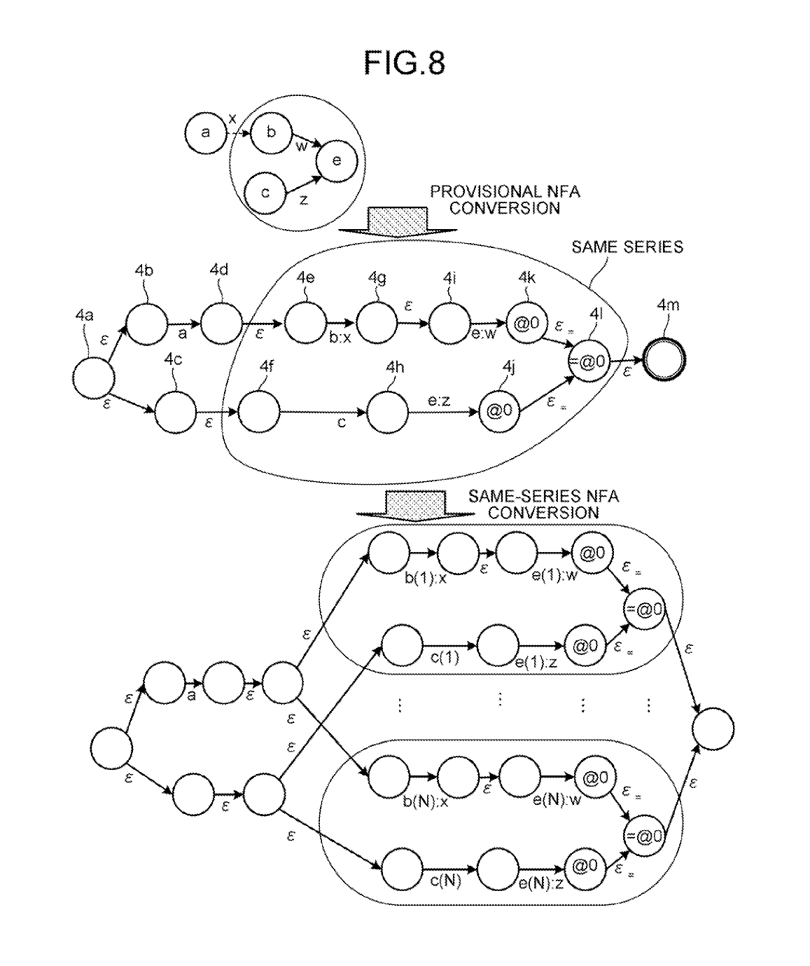

FIG. 8 illustrates an NFA for an event pattern that has two connection portions in the lead. In FIG. 8, “a”, “b”, “c”, and “e” represent events, and “x”, “w”, and “z” represent interval conditions of event intervals.

As illustrated in an upper stage of FIG. 8, the event pattern 141 is a pattern in which event b occurs in an arbitrary series within x after the occurrence of event a in an arbitrary series. In addition, the event pattern 141 is a pattern in which, thereafter, event e occurs in the same series as that of event b within w, event c occurs in the same series as that of event b, and thereafter, event e that is the same as the previous event e occurs in the same series as that of event b within z. In other words, event e is a junction portion.

As illustrated in a middle stage of FIG. 8, the NFA generating unit 152 converts the event pattern 141 into a provisional NFA. Here, the NFA generating unit 152 converts a pattern of events b, c, and e included in the event pattern 141 into a provisional NFA of the same series that is represented by nodes 4e to 4l. Then, the NFA generating unit 152 sets nodes 4k and 4j as reception time maintaining nodes and maintains the reception time of event e in association with the reception time maintaining nodes 4k and 4j that represent the transition destinations of the event e. Then, the NFA generating unit 152 connects the nodes 4k and 4j to the junction node 4l through ε=transitions.

As illustrated in a lower stage of FIG. 8, the NFA generating unit 152 searches for an NFA part having the same-series relation from the provisional NFA and separates the retrieved NFA part having the same-series relation. Then, the NFA generating unit 152 replicates the separated NFA part having the same-series relation for a plurality of series and substitutes each replicated NFA part with a transition that is received in an event of each series. Then, the NFA generating unit 152 combines the NFA parts which have been substituted for through ε transitions. Here, the NFA generating unit 152 replicates the NFA part, which has the same series relation, of node 4e to node 4l of the provisional NFA for N series as a plurality of series and substitutes a transition of the replicated NFA part with a transition that is received in an event of each series. In addition, the NFA generating unit 152 combines the replicated NFA parts through ε transitions.

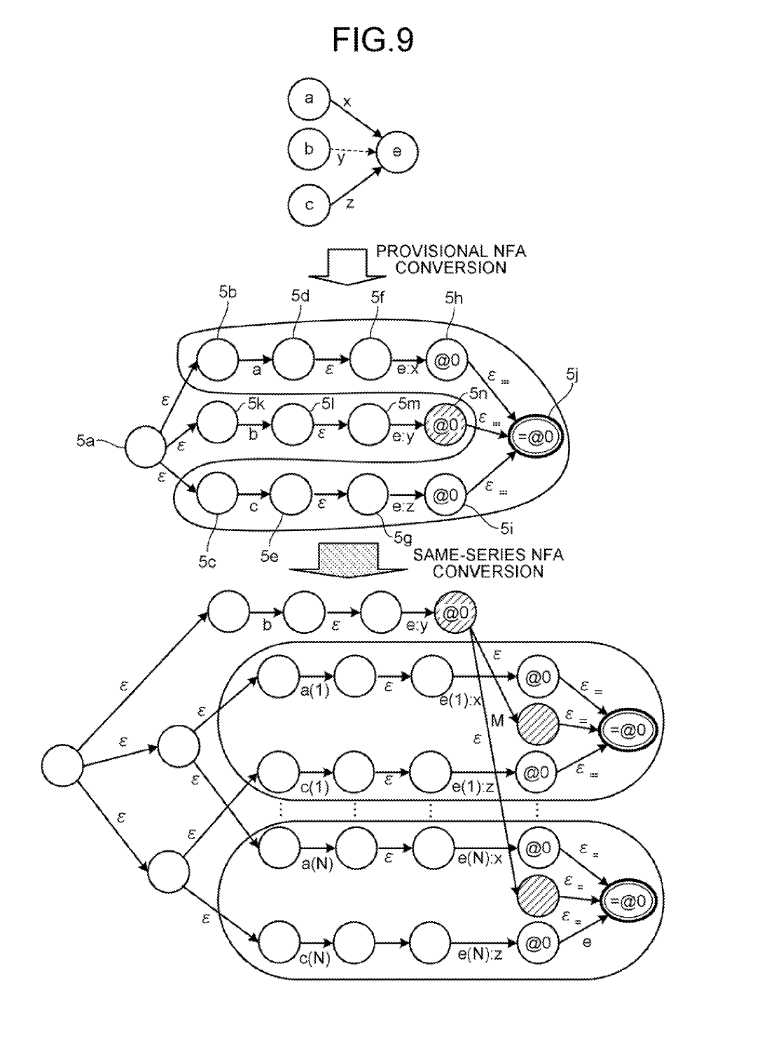

FIG. 9 illustrates an NFA for an event pattern in which a pattern of events in a same series and a pattern of events in arbitrary series are joined to a same event. In FIG. 9, “a”, “b”, “c”, and “e” represent events, and “x”, “y”, and “z” represents interval conditions of event intervals.

As illustrated in an upper stage of FIG. 9, the event pattern 141 is a pattern in which events a and c occur in a same series, and event e occurs in this series within x after the occurrence of event a and within z after the occurrence of event c. In addition, the event pattern 141 is a pattern in which, after event b occurs in an arbitrary event, the previous event e occurs within y.

As illustrated in a middle stage of FIG. 9, the NFA generating unit 152 converts the event pattern 141 into a provisional NFA. Here, the NFA generating unit 152 converts a pattern of events a, c, and e included in the event pattern 141 into a provisional NFA of the same series that is represented by nodes 5b to 5j. Then, the NFA generating unit 152 sets nodes 5h and 5i as reception time maintaining nodes and maintains the reception time of event e in association with the reception time maintaining nodes 5h and 5i that represent the transition destinations of the event e. In addition, the NFA generating unit 152 converts a pattern of events b and e included in the event pattern 141 into a provisional NFA that is represented by nodes 5a, 5k, 5l, 5m, and 5n. Then, the NFA generating unit 152 sets node 5n as a reception time maintaining node and maintains the reception time of event e in association with the reception time maintaining node that represents a transition destination of the event e. Here, the NFA generating unit 152 handles a joining portion that is adjacent to the same series relation to have the same series relation. Here, the NFA generating unit 152 generates node 5n that is a joining portion adjacent to the same series relation so as to have the same series relation as the series in which events a, c, and e occur.

As illustrated in a lower stage of FIG. 9, the NFA generating unit 152 searches for an NFA part having the same-series relation from the provisional NFA and separates the retrieved NFA part having the same-series relation. Then, the NFA generating unit 152 replicates the separated NFA part having the same-series relation for a plurality of series and substitutes each replicated NFA part with a transition that is received in an event of each series. Then, the NFA generating unit 152 combines the NFA parts which have been substituted for through ε transitions. Here, the NFA generating unit 152 replicates the NFA part, which has the same series relation, of node 5b to node 5j of the provisional NFA for N series as a plurality of series and substitutes a transition of the replicated NFA part with a transition that is received in an event of each series. In addition, the NFA generating unit 152, for node 5n that is handled to have the same series relation, replicates a node connected to node 5n through an ε transition for N series as a plurality of series. Then, the NFA generating unit 152 combines the replicated NFA parts through ε transitions.

Referring back to FIG. 2, the collation unit 153 is a processing unit that collates an event stream 143 by using the NFA 142. For example, for an NFA part having the same-series relation within the NFA 142, which has been replicated for a plurality of series, the collation unit 153 receives events that are included in the event stream 143 in the NFA part corresponding to a series in which each event occur and operates the received NFA part. In addition, for an NFA part having the relation of an arbitrary series within the NFA 142, the collation unit 153 receives events that are included in the event stream 143 regardless of the series in which the events occur and operates the received NFA part. Then, the collation unit 153 notifies the user terminal 50 of the collation result.

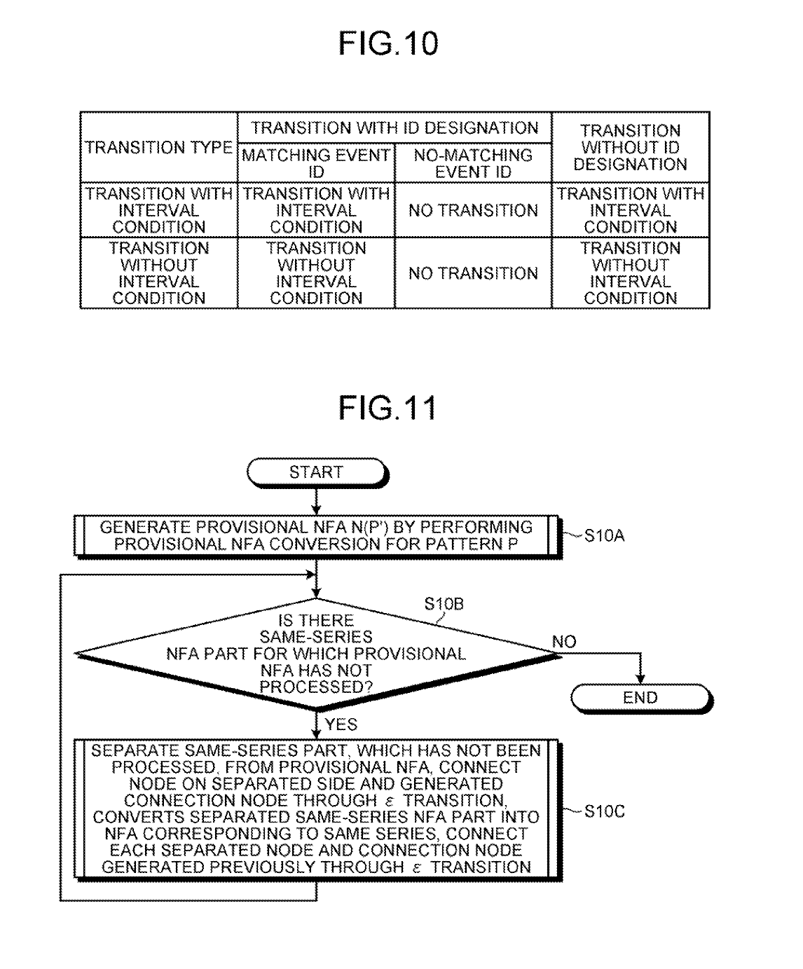

FIG. 10 illustrates the data structure of a transition type determining table that is used by the collation unit 153 for determining a transition type corresponding to an event, which is included in the event stream 143, transitioned from each node of the NFA 142. In addition, an ID illustrated in FIG. 10 is assumed to be an identifier that uniquely represents a series.

In the transition type determining table, a transition type and “transition with ID designation” or “transition without ID designation” are stored in association with each other. As the transition types, there are a transition with an interval condition and a transition without an interval condition. The “transition with ID designation” is a transition that is output from each node of the NFA 142 and represents a transition with an ID being designated, and, as the relation with an input event, there are “ID matching with event” and “ID mismatching with event”. Here, the “ID matching with event” represents a case where an event relating to a transition output from the node and an input event match each other, and an ID relating to the transition output from the node and an ID for which an input event occurs match each other. On the other hand, “ID no-matching with event” represents a case where there is mismatching in any one of them. The “transition without ID designation” is a transition that is output from each node of the NFA 142 and represents a transition to which any ID is not designated.

In the “ID matching with event”, in a case where the transition type of a transition that is output from the node is a transition with an interval condition, a transition type corresponding to the event is determined as the transition with an interval condition. On the other hand, in a case where the transition type of the transition that is output from the node is a transition without an interval condition, a transition type corresponding to the event is determined as the transition without an interval condition. In the “ID no-matching with event”, in a case where the transition type of a transition that is output from the node is either a transition with an interval condition or a transition without an interval condition, no transition is determined. In the “transition without ID designation”, in a case where the transition type of a transition that is output from the node is a transition with an interval condition, a transition type corresponding to the event is determined as the transition with an interval condition. On the other hand, in a case where the transition type of a transition that is output from the node is a transition without an interval condition, a transition type corresponding to the event is determined as the transition without an interval condition.

Processing Sequence for Building NFA Performed by NFA Generating Unit According to Embodiment

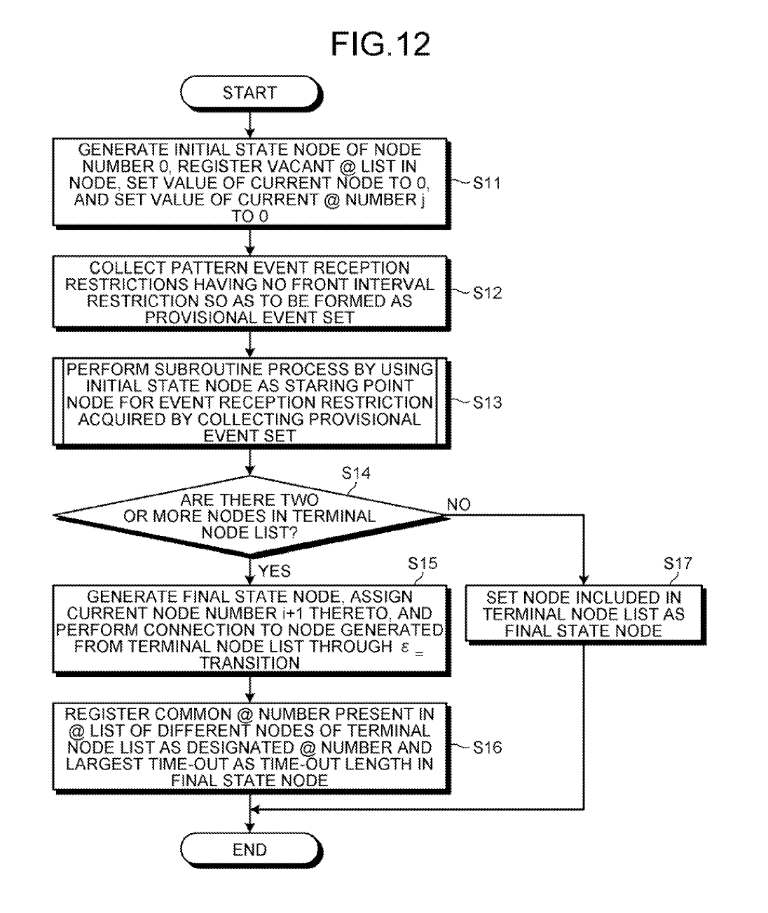

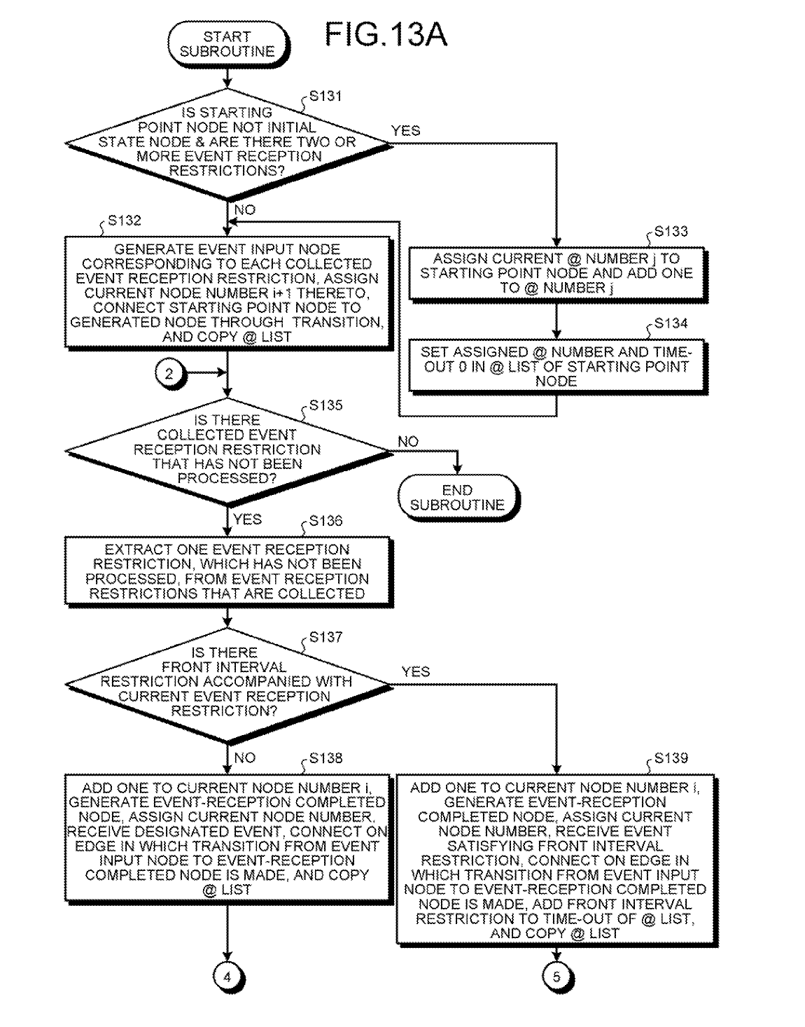

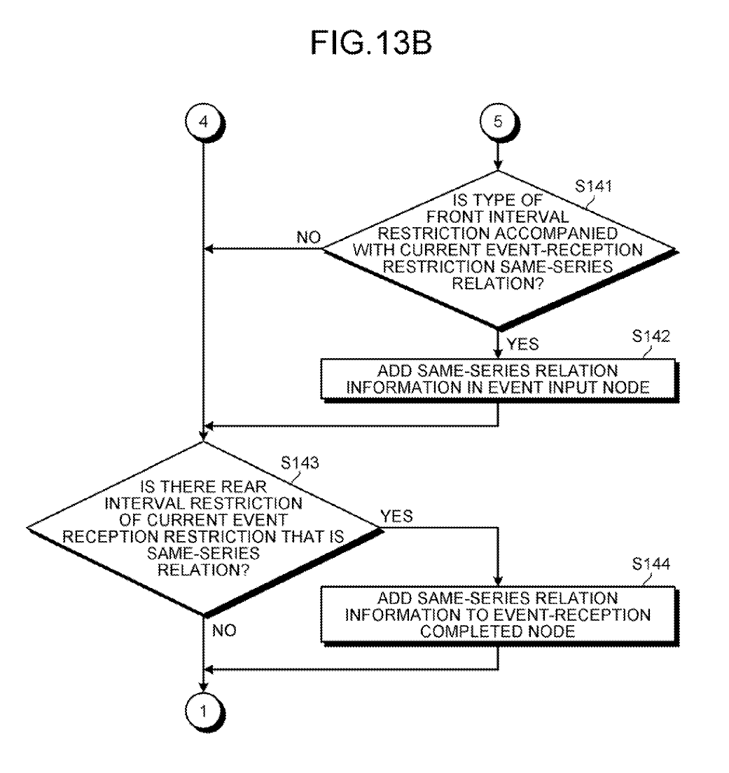

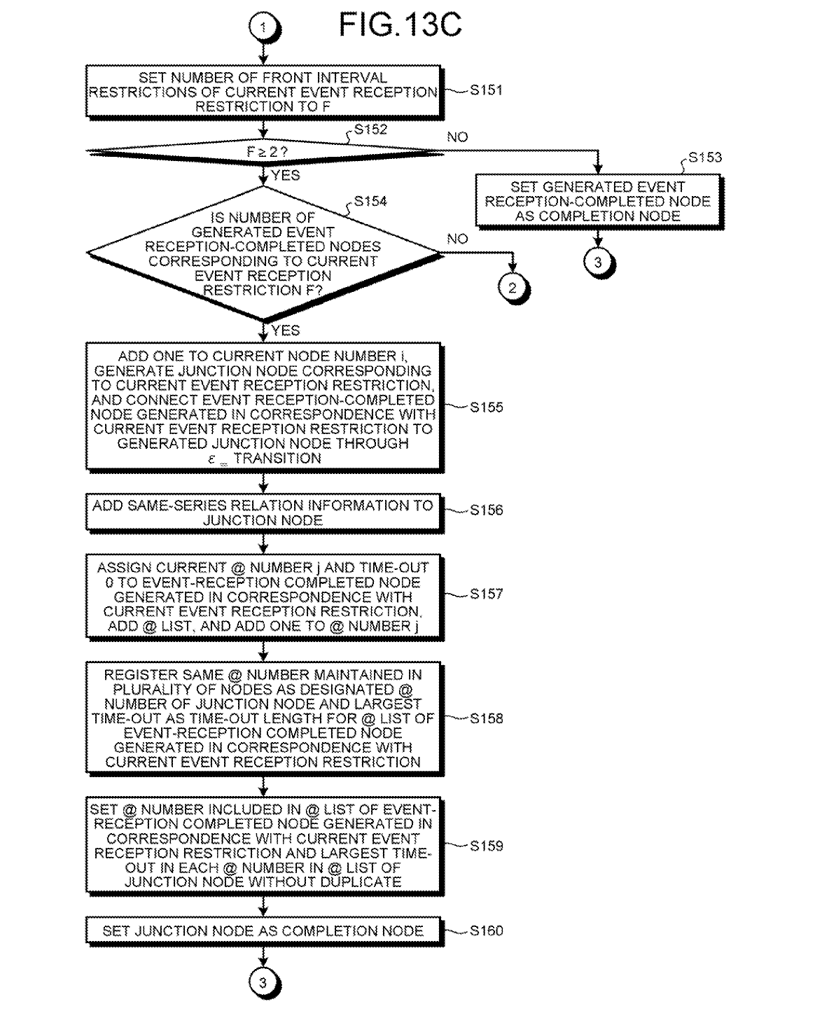

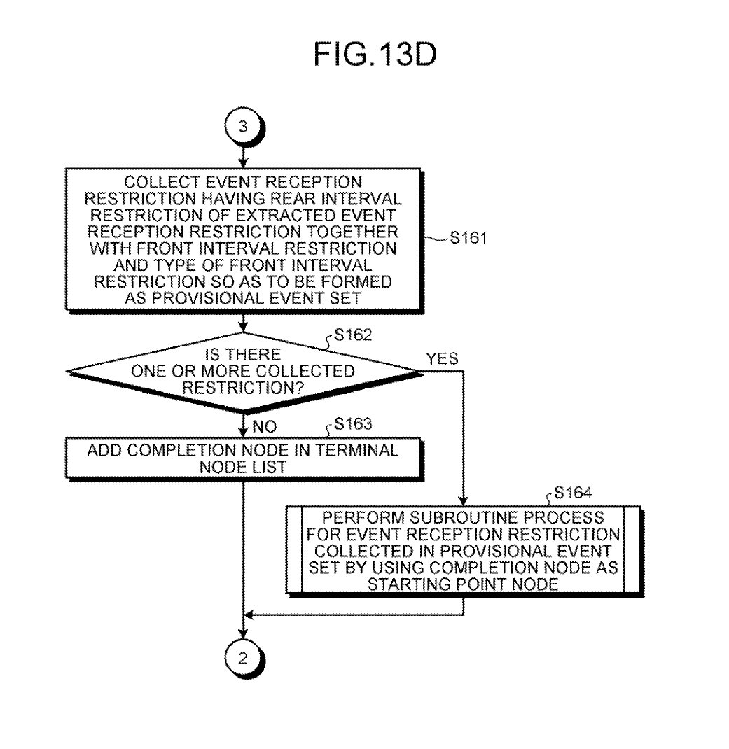

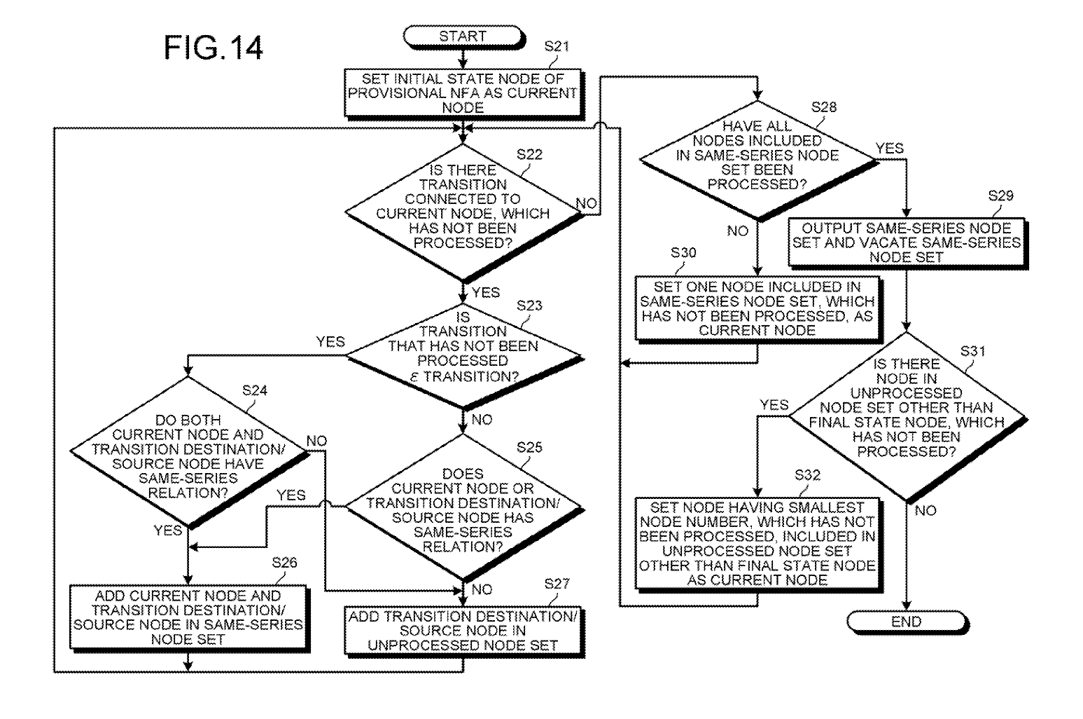

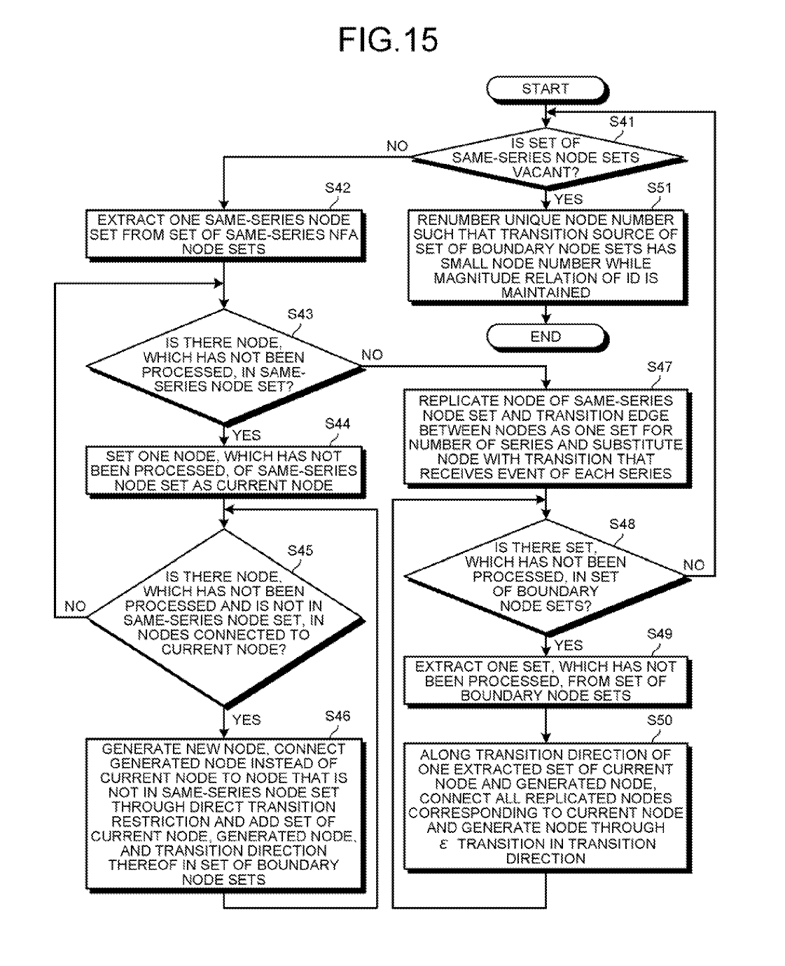

Next, the processing sequence for building an NFA that is performed by the NFA generating unit 152 will be described with reference to FIGS. 11 to 15. FIG. 11 illustrates the sequence of a main process for building an NFA that is performed by the NFA generating unit. FIGS. 12 to 13D illustrate the sequence of a provisional NFA converting process that is performed by the NFA generating unit 152. FIG. 14 illustrates the sequence of a same-series NFA searching process that is performed by the NFA generating unit 152. FIG. 15 illustrates the sequence of a same-series NFA converting process that is performed by the NFA generating unit 152.

Sequence of Main Process for Building NFA

First, the sequence of the main process for building an NFA will be described with reference to FIG. 11. FIG. 11 is a flowchart that illustrates the sequence of the main process for building an NFA that is performed by the NFA generating unit according to an embodiment. For example, the process illustrated in FIG. 11 receives a pattern P of events as an input and outputs N(P) that represents an NFA.

First, the NFA generating unit 152 converts the event pattern P into a provisional NFA and generates N(P′) that illustrates the provisional NFA in Step S10A.

Subsequently, the NFA generating unit 152 determines whether or not there is an NFA part of a same series, which has not been processed, in the generated provisional NFA in Step S10B.

In a case where it is determined that there is an NFA part of a same series, which has not been processed, in the provisional NFA (Yes in Step S10B), the NFA generating unit 152 separates the NFA part of the same series, which has not been processed, from the provisional NFA. Then, the NFA generating unit 152 connects a node located on each separated side and a generated connection node through an ε transition and converts the separated NFA part of the same series into an NFA corresponding to the same series. Then, the NFA generating unit 152 connects each separated leading node and the generated connection node through an ε transition in Step S10C. Then, the NFA generating unit 152 proceeds to Step S10B so as to process an NFA part of a same series that has not been processed.

In Step S10B, in a case where it is determined that there is no NFA part of a same series, which has not been processed, in the provisional NFA (No in Step S10B), the NFA generating unit 152 ends the NFA building process.

Sequence of Provisional NFA Converting Process

Next, the provisional NFA converting process illustrated in Step S10A illustrated in FIG. 11 will be described with reference to FIGS. 12 to 13D. FIGS. 12 to 13D are flowcharts that illustrate the sequence of the provisional NFA converting process that is performed by the NFA generating unit 152. The process illustrated in FIG. 12 receives a pattern P of events as an input and outputs N(P′) that illustrates the provisional NFA. In addition, a node number is represented by a variable i, and an @ number is represented by a variable j. Here, the node number is a unique number that is assigned to each node and represents the same meaning as that of a state number. As the kinds of the state, for example, there are an initial state and a final state depending on the node. The @ number represents a number that corresponds to a reception time maintaining node (@ node).

First, the NFA generating unit 152 generates a node, of which the node number is “0”, that is in the initial state and registers an empty “@ list” in the generated node. Then, the NFA generating unit 152 sets the value of the current node number i to “0” and sets the value of the current @ number j to “0” in Step S11. Here, the “@ list” is a list in which each @ number and a time-out period are associated with each other.

Then, the NFA generating unit 152, among events (hereinafter, the same meaning as that of an “event reception restriction”) appearing in the input pattern P, collects events having no interval restriction before the events and sets the collected events as a provisional event set in Step S12. Here, the interval restriction has the same meaning as the interval condition.

Then, the NFA generating unit 152 performs a subroutine process for event reception restrictions collected in the provisional event set with the node that is in the initial state set as a starting point node in Step S13.

Thereafter, when the subroutine process ends, the NFA generating unit 152 determines whether or not there are two or more nodes in a “terminal node list” in Step S14. Here, the “terminal node list” is a list in which terminal nodes are collected and is generated through a subroutine process.

In a case where it is determined that there are two or more nodes in the “terminal node list” (Yes in Step S14), the NFA generating unit 152 generates a node that is in the final state and assigns a value acquired by adding one to the current node number i to the generated node. Then, the NFA generating unit 152 connects each node included in the “terminal node list” to the generated node that is in the final state through an ε=transition in Step S15.

Then, the NFA generating unit 152 extracts the @ list of each one of the other nodes that are included in the terminal node list. Then, the NFA generating unit 152 registers the largest time-out in the node that is in the final state as a time-out length in Step S16 with a common @ number that is present in the extracted @ list as a designation @ number and ends the provisional NFA converting process.

On the other hand, in a case where it is determined that there are not two or more nodes in the “terminal node list” (No in Step S14), the NFA generating unit 152 sets the node included in the terminal node list as a final state node in Step S17 and ends the provisional NFA converting process.

Sequence of Subroutine Process

Next, the subroutine process that is illustrated in Step S13 illustrated in FIG. 12 will be described with reference to FIGS. 13A to 13D. FIGS. 13A to 13D represent a flowchart that illustrates the sequence of the subroutine process.

The NFA generating unit 152 determines whether or not the starting point node is the node that is in the initial state and there are two or more event reception restrictions collected in the provisional event set in Step S131. In a case where the starting point node is the node that is in the initial state or in a case where the starting point node is not the node that is in the initial state and there are not two or more event reception restrictions collected in the provisional event set (No in Step S131), the NFA generating unit 152 proceeds to Step S132.

In Step S132, the NFA generating unit 152 generates a node (hereinafter, referred to as an “event input node”) to which events corresponding to the collected event reception restrictions are input. Then, while adding one to the current node number i, the NFA generating unit 152 assigns the current node number i to the generated node. Then, the NFA generating unit 152 connects the starting point node to the generated event input node through an ε transition. In other words, the NFA generating unit 152 sets the transition from the starting point node to the event input node as an ε transition. In addition, the NFA generating unit 152 copies the @ list of the starting point node to the @ list of the generated node in Step S132.

On the other hand, in a case where the starting point node is not the node that is in the initial state and there are two or more event reception restrictions that are collected in the provisional event set (Yes in Step S131), the NFA generating unit 152 proceeds to Step S133. In other words, it is a case where the event reception restriction has a pattern (branching pattern) in which the event reception restrictions collected in the provisional event set branch.

In Step S133, the NFA generating unit 152 assigns the current @ number j to the starting point node and adds one to the @ number j in Step S133. In other words, this starting point node becomes the “reception time maintaining node” that maintains the reception time of the event that is a branch starting point. Then, the NFA generating unit 152 sets the assigned @ number and time-out 0 to the @ list of the starting point node in Step S134 and proceeds to Step S132.

After the process of Step S132, the NFA generating unit 152 determines whether or not there is any one of the event reception restrictions collected in the provisional event set, which has not been processed, in Step S135. In a case where there is no event reception restriction, which has not been processed, out of the collected event reception restrictions (No in Step S135), the NFA generating unit 152 ends the subroutine process.

On the other hand, in a case where there are some event reception restrictions, which have not been processed, out of the collected event reception restrictions (Yes in Step S135), the NFA generating unit 152 extracts one event reception restriction, which has not been processed, from the collected event reception restrictions in Step S136.

Then, the NFA generating unit 152 determines whether or not there is a front interval restriction accompanied with the current event reception restriction in Step S137. In a case where there is no front interval restriction accompanied with the current event reception restriction (No in Step S137), the NFA generating unit 152 adds one to the current node number i, generates an event-reception completed node, and assigns the added current node number to the generated node. Then, the NFA generating unit 152 makes a connection on the edge in which a transition from the event input node to the event-reception completed node is made in accordance with the reception of a designated event. In other words, the NFA generating unit 152 sets a transition from the event input node to the event-reception completed node as a “normal transition without an interval condition”. In addition, the NFA generating unit 152 copies the @ list of the event input node to the @ list of the event-reception completed node in Step S138. Thereafter, the NFA generating unit 152 proceeds to Step S143.

On the other hand, in a case where there is a front interval restriction accompanied with the current event reception restriction (Yes in Step S137), the NFA generating unit 152 adds one to the current node number i, generates an event-reception completed node, and assigns the added current node number to the generated node. Then, the NFA generating unit 152 makes a connection on the edge in which a transition from the event input node to the event-reception completed node is made in accordance with the reception of an event that satisfies the front interval restriction. In other words, the NFA generating unit 152 sets the transition from the event input node to the event-reception completed node as a “normal transition with an interval condition”. In addition, the NFA generating unit 152 adds a front interval restriction to each time output of the @ list of the event input node and copies the results to the @ list of the generated event-reception completed node in Step S139. Thereafter, the NFA generating unit 152 proceeds to Step S141.

In Step S141, the NFA generating unit 152 determines whether or not the type of the front interval restriction accompanied with the current event reception restriction is the same series relation in Step S141. In a case where the type of the front interval restriction accompanied with the current event reception restriction is determined to be the same series relation (Yes in Step S141), the NFA generating unit 152 adds same-series relation information to the event input node in Step S142 and proceeds to Step S143. On the other hand, in a case where the type of the front interval restriction accompanied with the current event reception restriction is determined not to be the same-series relation (No in Step S141), the NFA generating unit 152 proceeds to Step S143.

In Step S143, the NFA generating unit 152 determines whether or not there is a restriction of the same-series relation out of rear interval restrictions of the current event reception restrictions in Step S143. In a case where it is determined that there is a restriction of the same-series relation out of the rear interval restrictions of the current event reception restrictions (Yes in Step S143), the NFA generating unit 152 adds same-series relation information to the event-reception completed node in Step S144 and proceeds to Step S151. On the other hand, in a case where it is determined that there is no restriction of the same-series relation out of the rear interval restrictions of the current event reception restrictions (No in Step S143), the NFA generating unit 152 proceeds to Step S151.

Subsequently, the NFA generating unit 152 sets the number of the front interval restrictions of the current event reception restrictions as F in Step S151. Then, the NFA generating unit 152 determines whether or not the value of F is 2 or more in Step S152. In a case where the value of F is not 2 or more (No in Step S152), the NFA generating unit 152 sets the generated event-reception completed node as a completion node in Step S153. Thereafter, the NFA generating unit 152 proceeds to Step S161 so as to perform the process in the rear interval restriction of the current event reception restriction.

On the other hand, in a case where the value of F is 2 or more (Yes in Step S152), the NFA generating unit 152 determines whether or not the number of generated event reception-completed nodes corresponding to the current event reception restriction coincides with the value of F in Step S154. In a case where the number of generated event reception-completed nodes corresponding to the current reception restriction does not coincide with the value of F (No in Step S154), the NFA generating unit 152 proceeds to Step S135 so as to process event reception restrictions, which have not been processed, out of the collected event reception restrictions.

On the other hand, in a case where the number of generated event reception-completed nodes corresponding to the current reception restrictions coincides with the value of F (Yes in Step S154), the NFA generating unit 152 adds one to the current node number i and generates a junction node corresponding to the current event reception restrictions. Then, the NFA generating unit 152 connects all the generated event reception-completed nodes corresponding to the current event reception restrictions to the generated junction node through ε=transitions in Step S155. In other words, the NFA generating unit 152 sets transitions from the event reception-completed nodes to the junction node as “ε=transitions”.

Then, the NFA generating unit 152 adds the same-series relation information to the junction node in Step S156.

Subsequently, the NFA generating unit 152 assigns the current @ number j and time-out 0 to all the generated event-reception completed nodes corresponding to the current event reception restrictions and adds the current @ number j and time-out 0 to each @ list. In other words, all the generated event-reception completed nodes are formed as “reception time maintaining nodes”. In addition, the NFA generating unit 152 adds one to the @ number j in Step S157.

Subsequently, the NFA generating unit 152, in the @ list of the generated event-reception completed nodes corresponding to the current event reception restrictions, sets the same @ number that is included in a plurality of the generated event-reception completed nodes as a designation @ number of the junction node. Then, the NFA generating unit 152 registers a largest value of the time-out values as a time-out length together with the @ number in the junction node in association with each other in Step S158.

Subsequently, the NFA generating unit 152 sets the @ numbers included in the @ list of the generated event-reception completed nodes corresponding to the current event reception restrictions and a maximum time-out value for each @ number in the @ list of the junction node without any duplicate in Step S159. Then, the NFA generating unit 152 sets the junction node as a completion node in Step S160 and proceeds to Step S161 so as to process the rear interval restriction of the current event reception restrictions.

In Step S161, the NFA generating unit 152 collects event reception restrictions having a rear interval restriction out of the event reception restrictions extracted in Step S136 together with front interval restrictions and the types of the front interval restrictions so as to be set as a provisional event set in Step S161. Then, the NFA generating unit 152 determines whether or not the number of the event reception restrictions collected in the provisional event set is 1 or more in Step S162. In a case where the number of the collected event reception restrictions is not 1 or more, that is, “0” (No in Step S162), the NFA generating unit 152 adds a completion node in the terminal node list in Step S163. Thereafter, the NFA generating unit 152 proceeds to Step S135 so as to process the event reception restriction, which has not been processed, out of the collected event reception restrictions.

On the other hand, in a case where the number of the collected event reception restrictions is one or more (Yes in Step S162), the NFA generating unit 152 recursively performs the subroutine process for the event reception restrictions that are collected in the provisional event set by using the completion node as a starting point node in Step S164. Thereafter, the NFA generating unit 152 proceeds to Step S135 so as to process the event reception restriction, which has not been processed, out of the collected event reception restrictions.

Sequence of Same-Series NFA Searching Process

Next, the same-series NFA searching process illustrated in Step S10B illustrated in FIG. 11 will be described with reference to FIG. 14. FIG. 14 is a flowchart that illustrates the sequence of the same-series NFA searching process. The process illustrated in FIG. 14 receives N(P′) that represents a provisional NFA as an input and outputs a set of node sets (set of same-series nodes) of NFA portions having the same-series relation in the provisional NFA.

The NFA generating unit 152 sets the node of the input provisional NFA, which is in the initial state, as the current node in Step S21. Then, the NFA generating unit 152 determines whether or not there is a transition, which has not been processed, for a connection with the current node in Step S22. In a case where it is determined that there is a transition, which has not been processed, for a connection with the current node (Yes in Step S22), the NFA generating unit 152 determines whether or not the transition, which has not been processed, is an ε transition in Step S23. In a case where the transition, which has not been processed, is determined to be an ε transition (Yes in Step S23), the NFA generating unit 152 determines whether or not both the current node and the transition source/transition destination node have the same-series relation in Step S24. On the other hand, in a case where the transition, which has not been processed, is determined not to be an ε transition (No in Step S23), the NFA generating unit 152 determines whether or not the current node or a transition destination/transition source node has the same-series relation in Step S25.

In a case where both the current node and the transition destination/transition source node have the same-series relation (Yes in Step S24) or in a case where the current node and one thereof have the same-series relation (Yes in Step S25), the NFA generating unit 152 performs the following process. The NFA generating unit 152 adds the current node and the transition destination/transition source node in the same-series node set in Step S26. On the other hand, in a case where both the current node and the transition destination/transition source node do not have the same-series relation (No in Step S24) or in a case where any one thereof does not have the same-series relation (No in Step S25), the NFA generating unit 152 adds the transition destination/transition source nodes in an unprocessed node set in Step S27. Then, the NFA generating unit 152 proceeds to Step S22 so as to process the transition, which has not been processed, for a connection with the current node.

In Step S22, in a case where it is determined that there is no transition, which has not been processed, for a connection with the current node (No in Step S22), the NFA generating unit 152 determines whether or not all the nodes included in the same-series node set have been processed in Step S28. In a case where it is determined that all the nodes included in the same-series node set have not been processed (No in Step S28), the NFA generating unit 152 sets one of the nodes, which have not been processed, included in the same-series node set as the current node in Step S30. Then, the NFA generating unit 152 proceeds to Step S22.

On the other hand, in a case where it is determined that all the nodes included in the same-series node set have been processed (Yes in Step S28), the NFA generating unit 152 outputs the same-series node set and vacates the same-series node set after the output in Step S29. Then, the NFA generating unit 152 determines whether or not there is a node, which has not been processed, other than the final state node in the unprocessed node set in Step S31. In a case where there are nodes, which have not been processed, other than the final state node in the unprocessed node set (Yes in Step S31), the NFA generating unit 152 sets a node, which has not been processed, having a smallest series (ID) other than the final state node in the unprocessed node set as the current node in Step S32. Then, the NFA generating unit 152 proceeds to Step S22.

On the other hand, in a case where there is no node, which has not been processed, other than the final state node in the unprocessed node set (No in Step S31), the NFA generating unit 152 ends the same-series NFA searching process.

Sequence of Same-Series NFA Converting Process

Next, the same-series NFA converting process illustrated in Step S10C illustrated in FIG. 11 will be described with reference to FIG. 15. FIG. 15 is a flowchart that illustrates the sequence of the same-series NFA converting process. The process illustrated in FIG. 15 receives N(P′) that represents a provisional NFA and a set of same-series node sets as inputs and outputs N(P) that represents an NFA.

The NFA generating unit 152 determines whether or not the input set of same-series node sets is vacant in Step S41. In a case where it is determined that the set of same series node sets is not vacant (No in Step S41), the NFA generating unit 152 extracts one of the same-series node sets from the set of the same-series node sets in Step S42.

Then, the NFA generating unit 152 determines whether or not there are nodes, which have not been processed, in the same-series node set in Step S43. In a case where it is determined that there are nodes, which have not been processed, in the same-series node set (Yes in Step S43), the NFA generating unit 152 sets one node, which has not been processed, included in the same-series node set as the current node in Step S44. Then, the NFA generating unit 152 determines whether or not there is a node, which has not been processed, that is not present in the same-series node set in a node connected to the current node in Step S45.

In a case where it is determined that there is a node, which has not been processed, that is not present in the same-series node set out of nodes that are connected to the current node (Yes in Step S45), the NFA generating unit 152 generates a new node and connects the generated node, instead of the current node, and the previous node that is not present in the same-series node set through a direct transition restriction or the like. Then, the NFA generating unit 152 adds a set of the current node, the generated node, and the transition direction of the two nodes in sets of boundary node sets in which a set of nodes positioned on the boundary on which a same-series part and a non-same series part are separated from each other are collected in Step S46. Here, in a case where the node generated instead of the current node is located in front of the current node, the NFA generating unit 152 sets the transition direction to a transition direction from the generated node to the current node. On the other hand, in a case where the node generated instead of the current node is located on the rear of the current node, the NFA generating unit 152 sets the transition direction to a transition direction from the current node to the generated node. Then, the NFA generating unit 152 proceeds to Step S45 so as to determine a node, which has not been processed, that is not present in the same-series node set out of the nodes connected to the current node.

On the other hand, in a case where it is determined that there is no node, which has not been processed, that is not present in the same-series node set out of nodes that are connected to the current node (No in Step S45), the NFA generating unit 152 proceeds to Step S43 so as to determine a node, which has not been processed, included in the same-series node set.

On the other hand, in a case where it is determined that there is no node, which has not been processed, included in the same-series node set (No in Step S43), the NFA generating unit 152 replicates the nodes included in the same-series node set and all the transition edges between the nodes as one set in correspondence with the number of the series. Then, the NFA generating unit 152 substitutes each replicated part with a transition that is received in an event of each series in Step S47. In other words, the NFA generating unit 152 replaces a normal transition with an interval condition and a normal transition without an interval condition so as to be received only in an event of each series.

Subsequently, the NFA generating unit 152 determines whether or not there are sets, which have not been processed, in the set of the boundary node sets in Step S48. In a case where it is determined that there are sets, which have not been processed, in the set of the boundary node sets (Yes in Step S48), the NFA generating unit 152 extracts one set, which has not been processed, from the set of the boundary node sets in Step S49. Then, the NFA generating unit 152 connects all the replicated nodes corresponding to the current node and the generated node through ε transitions in the transition direction based on the current node, which is one set that has been extracted, the generated node, and the transition direction in Step S50. Then, the NFA generating unit 152 proceeds to Step S48 so as to determine whether or not there are sets, which have not been processed, in the set of boundary node sets.

On the other hand, in a case where it is determined that there is no sets which has not been processed, in the set of the boundary node sets (No in Step S48), the NFA generating unit 152 proceeds to Step S41 so as to process the following same-series node set.

In Step S41, in a case where it is determined that the set of same-series node sets is vacant (Yes in Step S41), the NFA generating unit 152 renumbers the node numbers as below. In other words, the NFA generating unit 152 renumbers the unique node numbers such that the transition source of the set of boundary node sets has a small number while maintaining the magnitude relation of the series (IDs), in Step S51. Then, the NFA generating unit 152 ends the same-series NFA converting process.

Example of NFA Generating Process

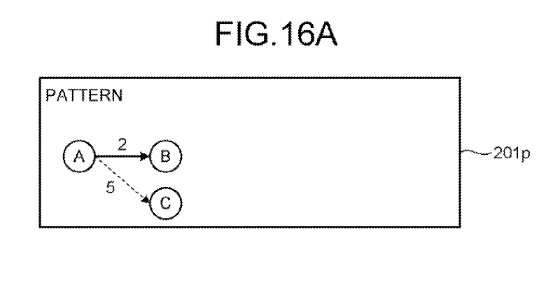

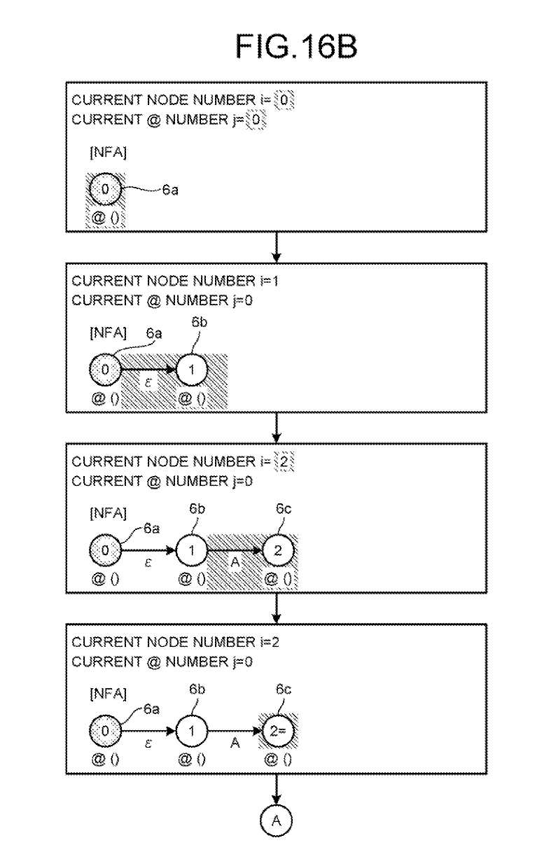

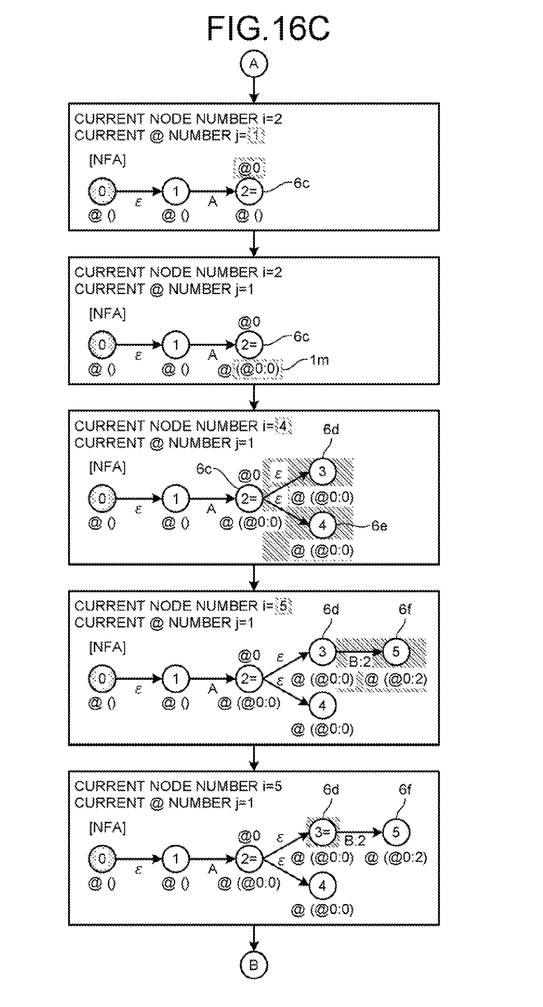

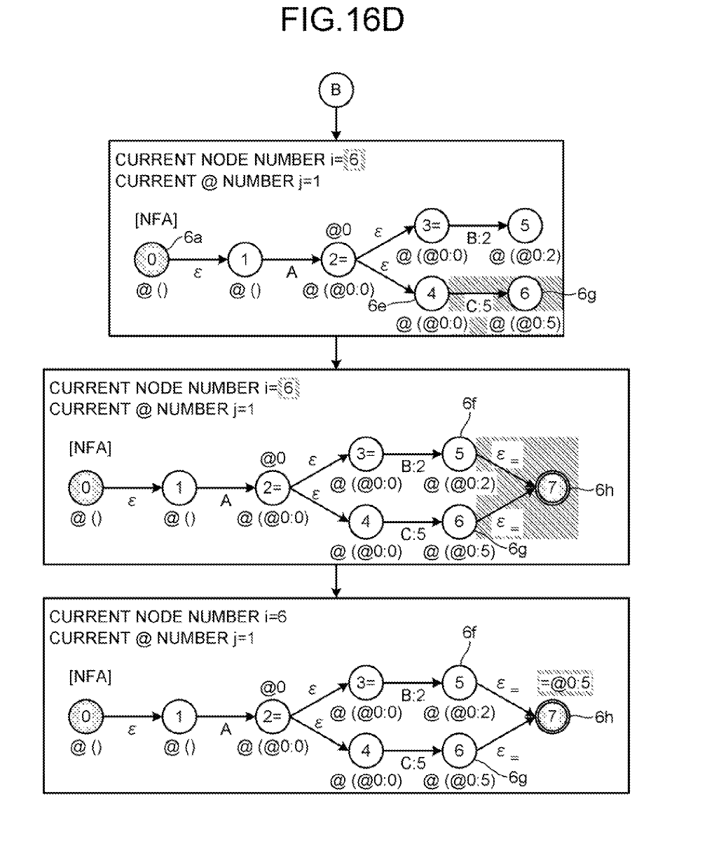

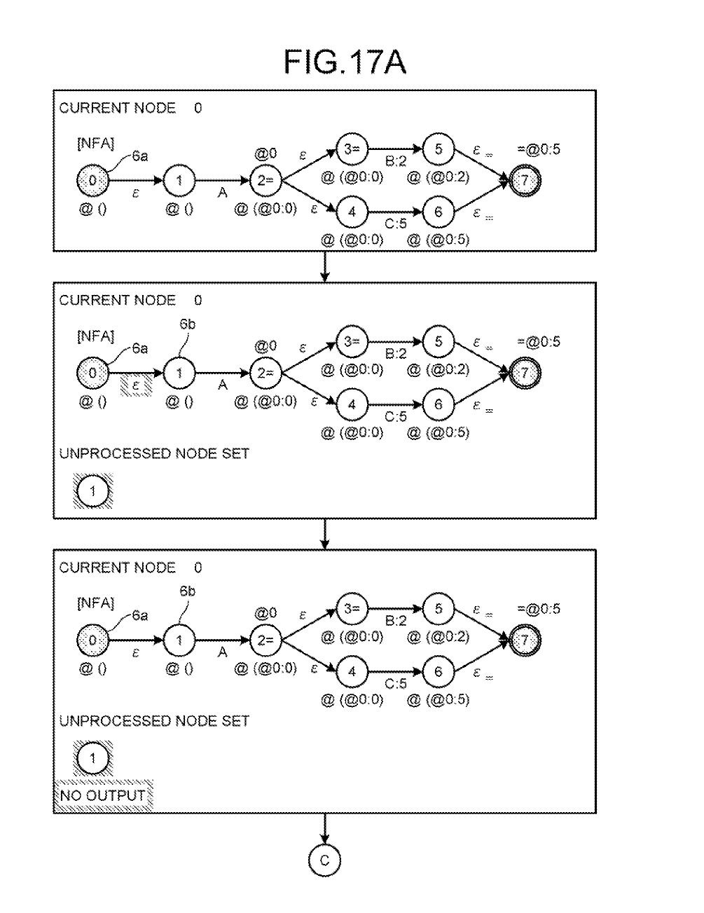

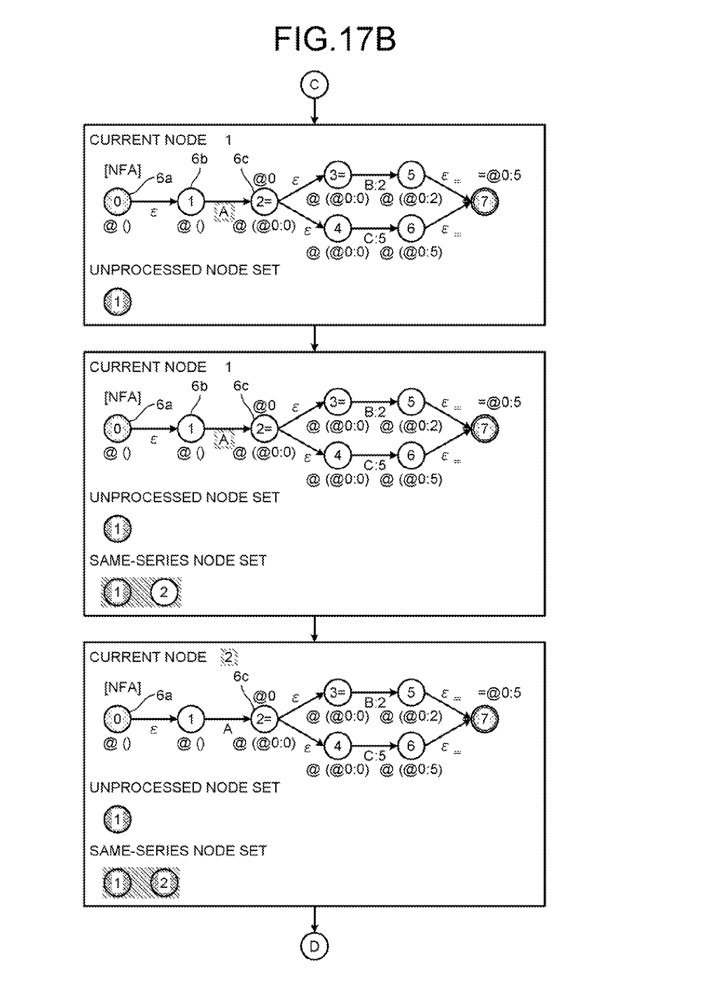

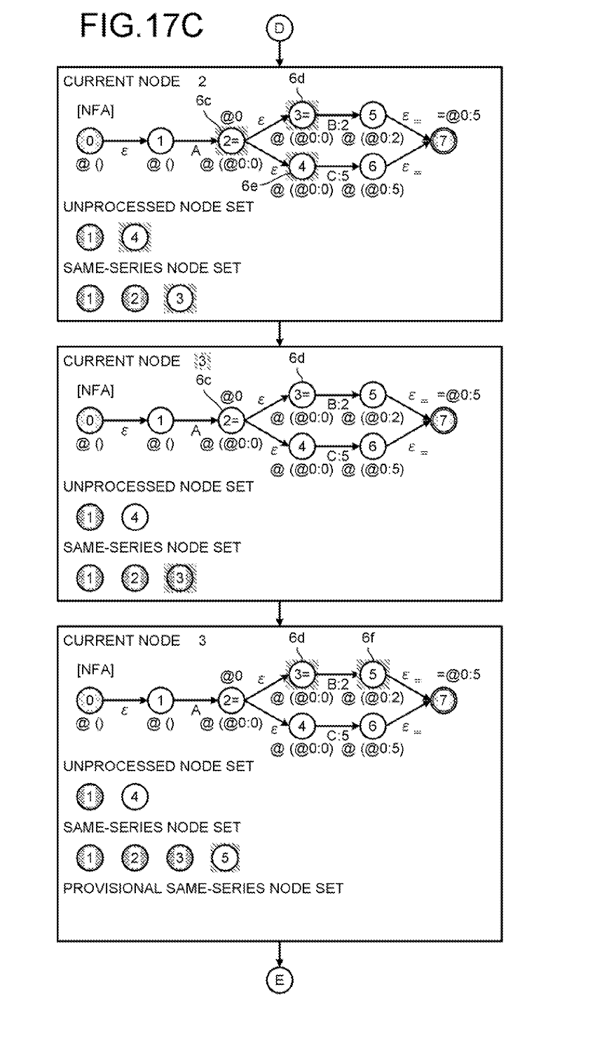

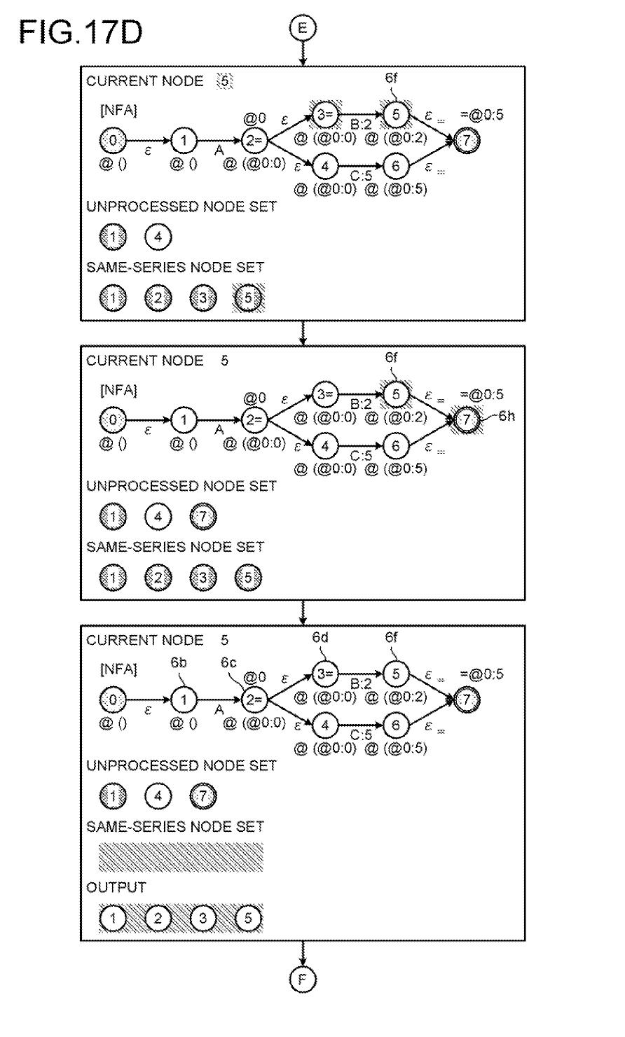

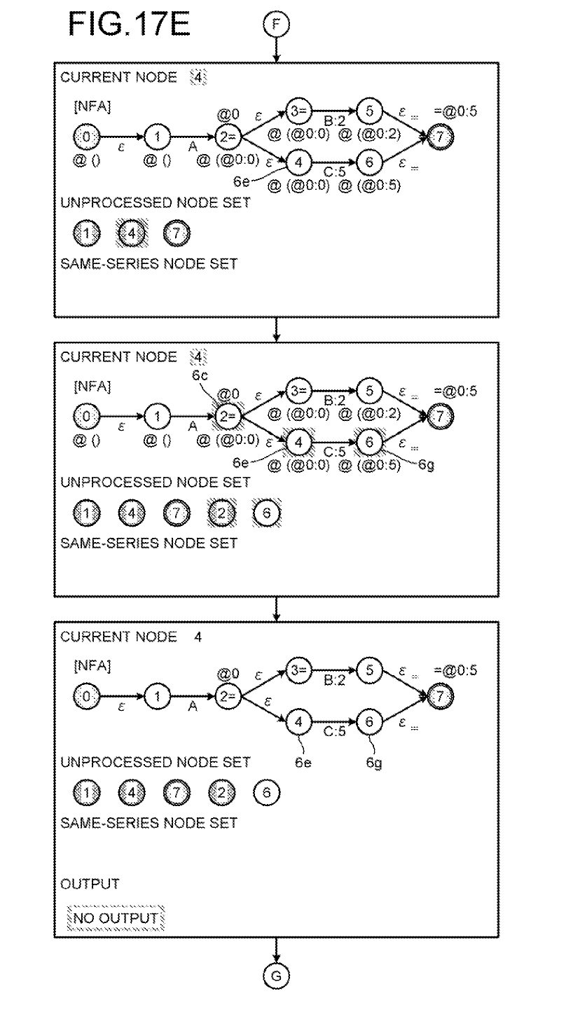

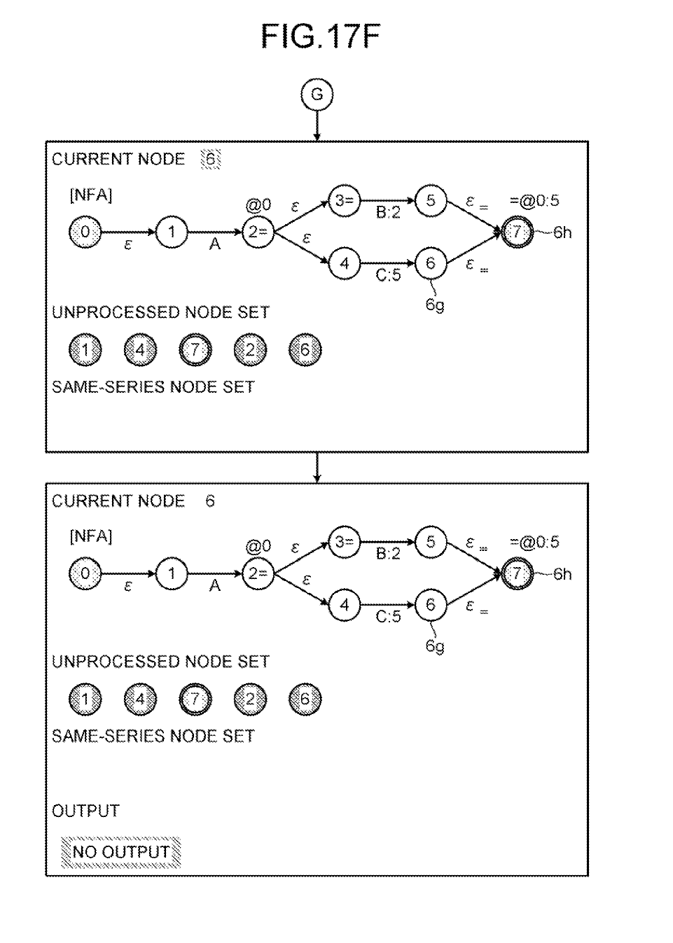

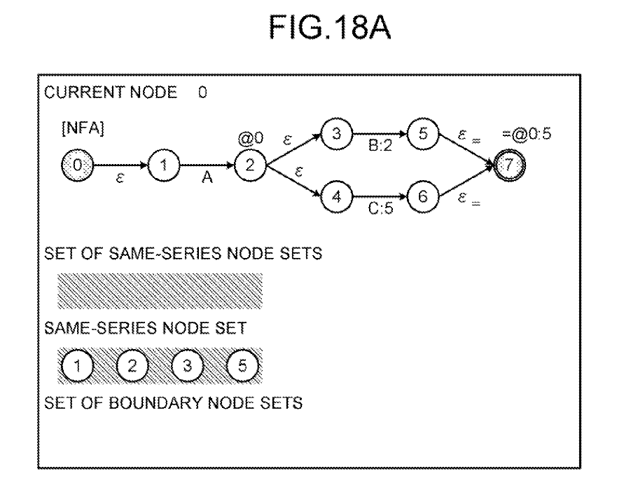

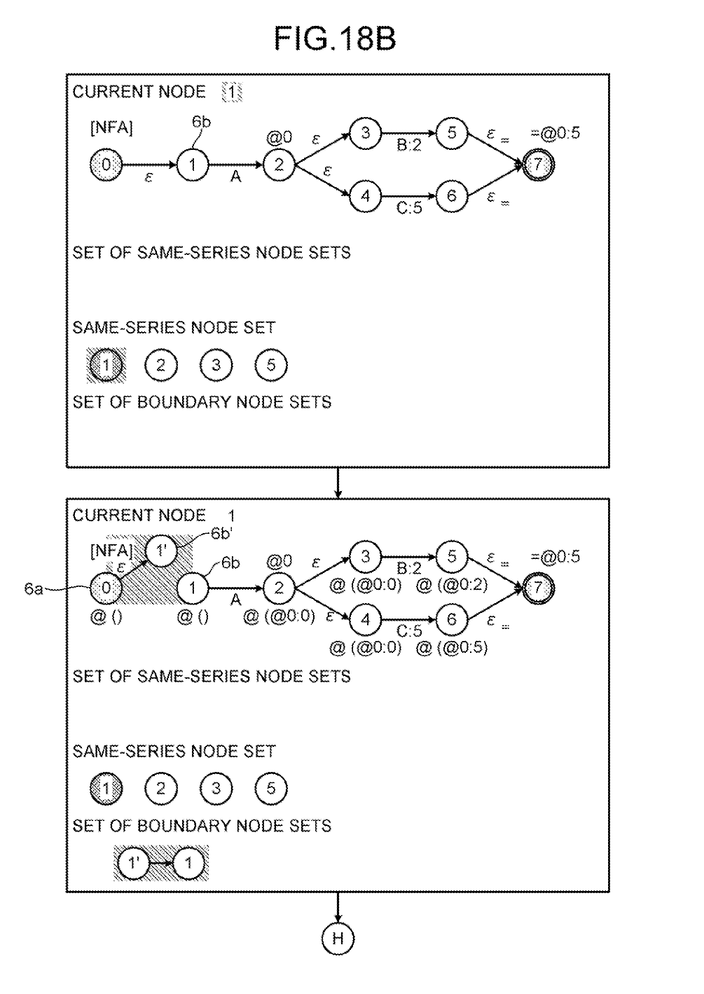

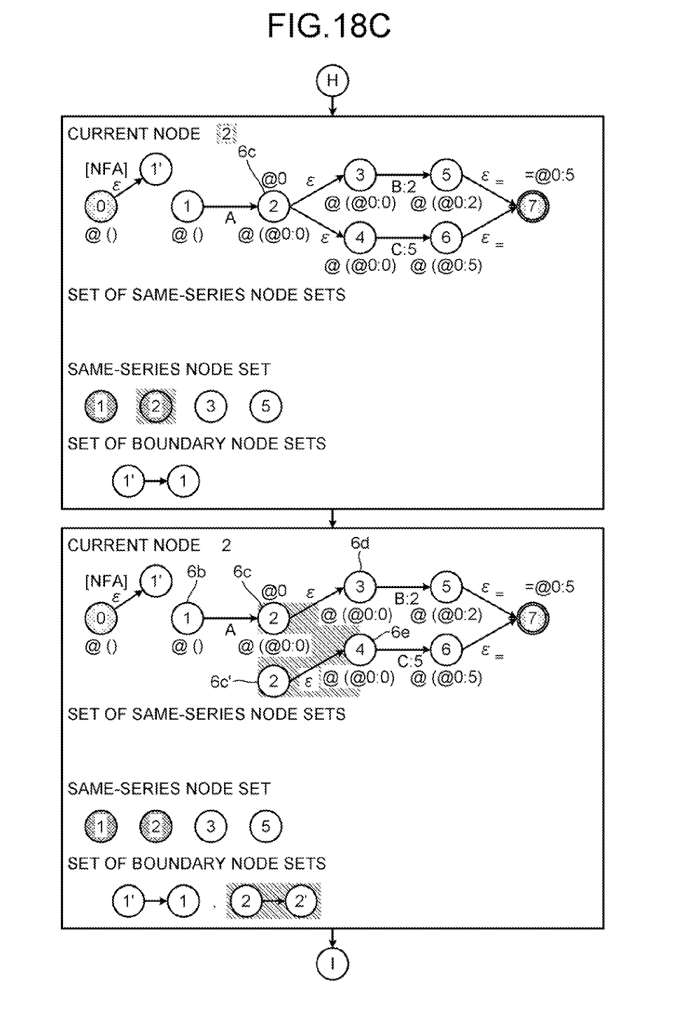

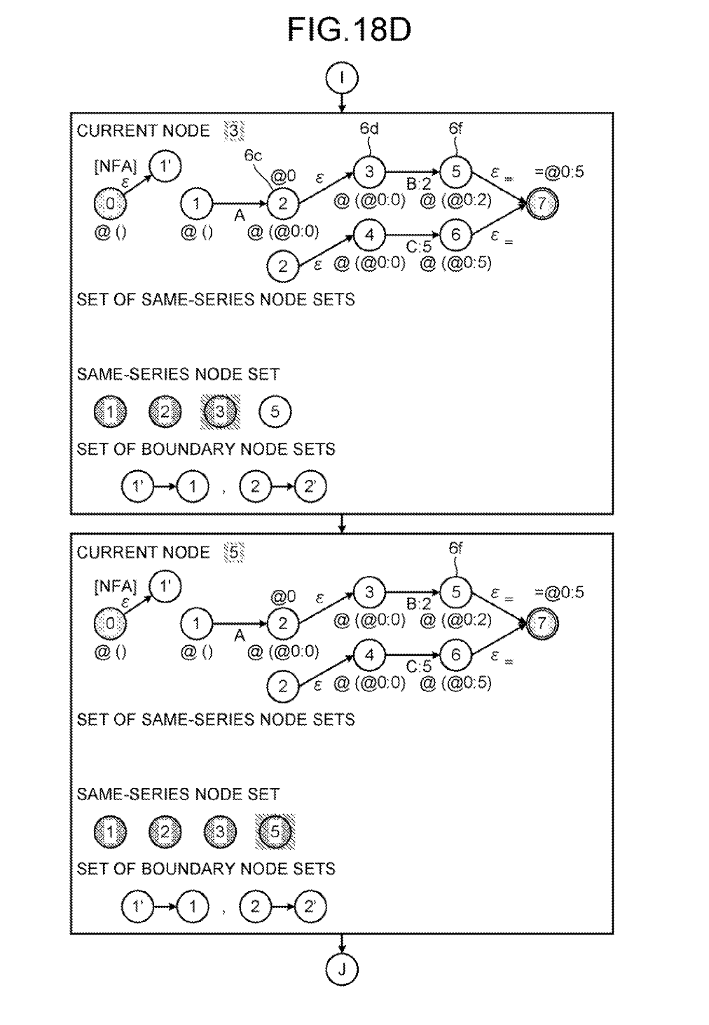

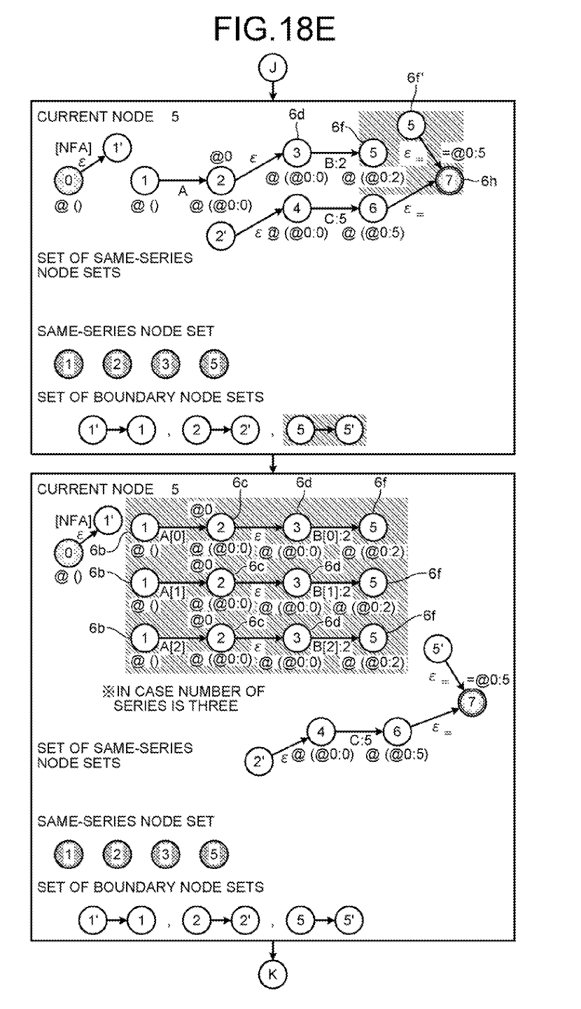

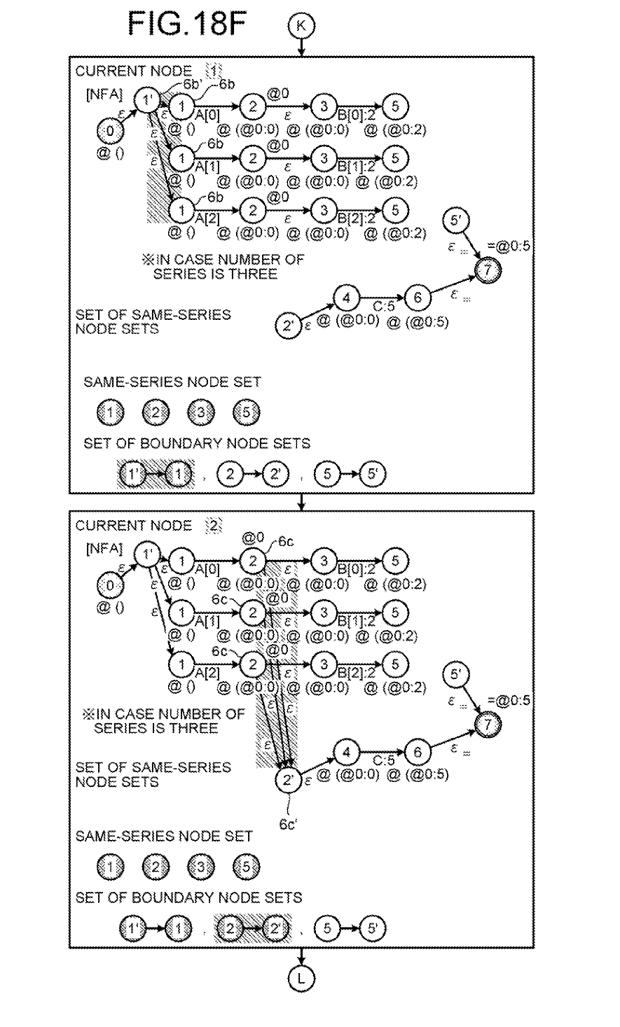

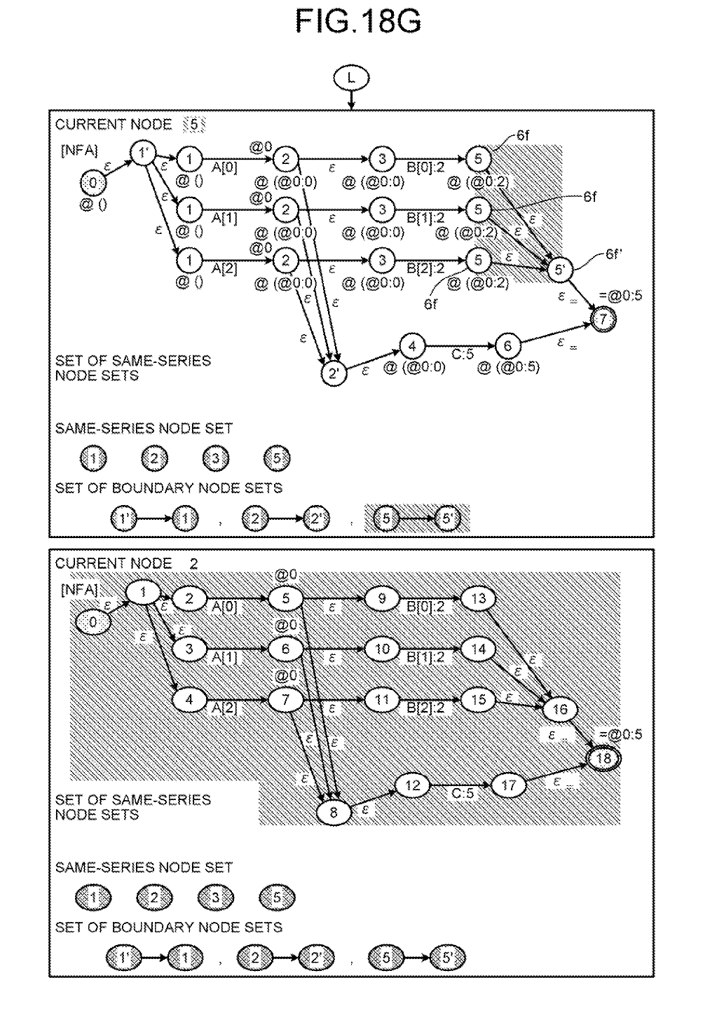

Next, an example of a process will be described in which the NFA generating unit 152 generates an NFA 142 based on the event pattern 141 by using a method of building an NFA illustrated in FIGS. 11 to 15 in a case where a specific pattern is set as the event pattern 141. FIGS. 16A to 16D are diagrams that illustrate a provisional NFA generating process. FIGS. 17A to 17F are diagrams that illustrate a same-series NFA searching process. FIGS. 18A to 18G are diagrams that illustrate the same-series NFA converting process.

Provisional NFA Generating Process

As illustrated in FIG. 16A, the data structure of the event pattern 141 is denoted by reference symbol 201p. In the event pattern 141, event A occurs in an arbitrary series, and thereafter, event B occurs in the same series as that of event A within “2”. In addition, the event pattern 141 is a pattern in which event C occurs in an arbitrary series within five after the occurrence of event A in an arbitrary series.

As illustrated in a first stage of FIG. 16B, the NFA generating unit 152 generates a node 6a, of which the node number is “0”, that is in the initial state and registers a vacant @ list in the generated node 6a. Then, the NFA generating unit 152 sets the value of the current node number i to “0” and sets the value of the current @ number j to “0”. Then, the NFA generating unit 152 collects event reception restrictions appearing in the input event pattern 141, which do not have front interval restrictions, so as to be formed as a provisional event set. Here, the NFA generating unit 152 sets the event reception restrictions of event A as the provisional event set. Then, the NFA generating unit 152 sets the node 6a that is in the initial state as a starting point node.

As illustrated in a second stage of FIG. 16B, since the starting point node is the node 6a that is in the initial state, the NFA generating unit 152 generates an event input node 6b corresponding to the event reception restrictions (A) collected in the provisional event set. Then, the NFA generating unit 152 assigns a value 1 that is acquired by adding one to the current node number i to the generated node 6b. Then, the NFA generating unit 152 connects the starting point node 6a to the event input node 6b through an ε transition.

As illustrated in a third stage of FIG. 16B, the NFA generating unit 152 extracts one event reception restriction, which has not been processed, from the event reception restriction (A) collected in the provisional event set. Here, the NFA generating unit 152 extracts event A. Then, the NFA generating unit 152 generates an event-reception completed node 6c and assigns a value 2 acquired by adding one to the current node number i to the generated node 6c. Then, the NFA generating unit 152 makes a connection on the edge in which a transition from the event input node 6b to the event-reception completed node 6c is made in accordance with the reception of event A. In other words, the transition from the event input node 6b to the event-reception completed node 6c is a “normal transition without an interval condition”. In addition, the NFA generating unit 152 copies the @ list of the event input node 6b to the @ list of the event-reception completed node 6c.

As illustrated in a fourth stage of FIG. 16B, since there is a rear interval restriction B, which has the same-series relation, out of the rear interval restrictions of the current event reception restriction A, the NFA generating unit 152 adds the same-series relation information “=” to the event-reception completed node 6c.

Subsequently, the NFA generating unit 152 sets the number of front interval restrictions of the current event reception restriction (A) to F. Here, since there is no restriction for the front interval of event A, the NFA generating unit 152 sets F to “0”. Then, since F is not 2 or more, the NFA generating unit 152 sets the event-reception completed node 6c as a completion node. Furthermore, the NFA generating unit 152 collects event reception restrictions with rear interval restrictions out of the extracted event reception restriction (A) together with front interval restrictions and the types of the front interval restrictions so as to be formed as a provisional event set. The type of the front interval restriction is a type accompanied with the front interval restriction and is a type that is used for distinguishing between a transition relation of a same series and a transition relation of an arbitrary series. Here, since the interval restriction of event A until a rear event B is “2” and the relation is a transition relation of a same series, the NFA generating unit 152 sets the event reception restriction B together with the front interval restriction of “2” and the type that represents a restriction of a transition relation of a same series as a provisional event set. In addition, since the interval restriction of event A until the rear event C is “5” and the relation is a transition relation of an arbitrary series, the NFA generating unit 152 sets the event reception restriction C together with the front interval restriction of “5” and the type that represents a restriction of the transition relation of an arbitrary series as a provisional event set. Then, the NFA generating unit 152 sets the completion node 6c as a starting point node.

As illustrated in a first stage of FIG. 16C, since the starting point node 6c is not a node that is in the initial state and the number of event reception restrictions (B and C) collected in the provisional event set is two or more, the NFA generating unit 152 assigns the value “0” of the current @ number j to the starting point node 6c. In other words, this starting point node 6c is a reception time maintaining node having an @ number of 0 (@0). Then, the NFA generating unit 152 sets the value of the current @ number j to a value of “1” acquired by adding one thereto.

As illustrated in a second stage of FIG. 16C, the NFA generating unit 152 sets the assigned @ number “0” and time-out “0” in the @ list 1m of the starting point node 6c.

As illustrated in a third stage of FIG. 16C, the NFA generating unit 152 generates event input nodes 6d and 6e that correspond to the event reception restrictions (B and C) collected in the provisional event set. Then, the NFA generating unit 152 assigns a value of “3” that is acquired by adding one to the current node number i (2) to the generated node 6d and assigns a value of “4” that is acquired by further adding one to the current node number i (3) to the generated node 6e. Then, the NFA generating unit 152 connects the starting point node 6c to the event input node 6d through an ε transition and connects the starting point node 6c to the event input node 6e through an ε transition. Then, the NFA generating unit 152 copies the @ list of the starting point node 6c to the @ lists of the event input nodes 6d and 6e.

As illustrated in a fourth stage of FIG. 16C, the NFA generating unit 152 extracts one event reception restriction, which has not been processed, from the event reception restrictions (B and C) collected in the provisional event set. Here, the NFA generating unit 152 extracts event B. Then, the NFA generating unit 152 generates an event-reception completed node 6f and assigns a value 5 acquired by adding one to the current node number to the generated node 6f. Then, the NFA generating unit 152 makes a connection on the edge in which a transition from the event input node 6d to the event-reception completed node 6f is made in accordance with the reception of event B that satisfies the front interval restriction of “2”. In other words, the transition from the event input node 6d to the event-reception completed node 6f is a “normal transition with an interval condition”. In addition, the NFA generating unit 152 adds the front interval restriction of “2” to the time-out of the @ list of the event input node 6d and copies the @ list of the event input node 6d to the @ list of the event-reception completed node 6f.

As illustrated in a fifth stage of FIG. 16C, since the type of the front interval restriction accompanied with the current event reception restriction (B) is a same-series relation, the NFA generating unit 152 adds the same-series relation information “=” to the event input node 6d.

Subsequently, the NFA generating unit 152 sets the number of front interval restrictions of the current event reception restriction (B) to F. Here, since the front interval restriction of event B is “2”, the NFA generating unit 152 sets the number F of the front interval restrictions to “1”. Then, since F is not 2 or more, the NFA generating unit 152 sets the event-reception completed node 6f as a completion node. Furthermore, the NFA generating unit 152 collects event reception restrictions with rear interval restrictions out of the extracted event reception restriction (B) so as to be formed as a provisional event set. Here, since there is no event reception restriction with a rear interval restriction in event B, the NFA generating unit 152 sets a vacant provisional event set. Since the provisional event set is vacant, the NFA generating unit 152 adds a completion node 6f to the terminal node list. Here, the process of the event reception restriction B ends.

As illustrated in a first stage of FIG. 16D, the NFA generating unit 152 extracts one event reception restriction, which has not been processed, from the event reception restrictions (B and C) collected in the provisional event set. Here, since the process of event B has ended, the NFA generating unit 152 extracts event C that has not been processed. Then, the NFA generating unit 152 generates an event-reception completed node 6g and assigns a value 6 acquired by adding one to the current node number i to the generated node 6g. Then, the NFA generating unit 152 makes a connection on the edge in which a transition from the event input node 6e to the event-reception completed node 6g is made in accordance with the reception of event C that satisfies the front interval restriction of “5”. In other words, the transition from the event input node 6e to the event-reception completed node 6g is a “normal transition with an interval condition”. In addition, the NFA generating unit 152 adds the front interval restriction of “5” to the time-out of the @ list of the event input node 6e and copies the @ list of the event input node 6e to the @ list of the event-reception completed node 6g.

Subsequently, since the number of front interval restriction is one and there is no rear interval restriction in the current event reception restriction (C), similarly to event B, the NFA generating unit 152 adds a completion node 6g to the terminal node list. In other words, in the terminal node list, there are the completion nodes 6f and 6g. Here, the process of the event reception restriction C ends. As a result, the process of the event reception restriction A ends.

Subsequently, since the process of the event reception restrictions (B and C) collected in the provisional event set has ended, the NFA generating unit 152 returns the provisional event set and the starting point node to the original provisional event set and the original starting point node. In other words, the starting point node becomes the node 6a that is in the initial state, and the provisional event set becomes a provisional event set that includes the event reception restriction A.

As illustrated in a second stage of FIG. 16D, since the process of the event reception restriction A that is included in the returned provisional event set ends, the

NFA generating unit 152 generates a node 6h that is in the final state and assigns a value “7” acquired by adding one to the current node number i to the generated node 6h. Then, the NFA generating unit 152 connects the completion nodes 6f and 6g included in the “terminal node list” to the generated node 6h that is in the final state through ε=transitions.

As illustrated in a fifth stage of FIG. 16D, the NFA generating unit 152 extracts the @ list of each one of the other nodes that are included in the terminal node list. Here, the NFA generating unit 152 extracts the @ lists of the completion nodes 6f and 6g that are included in the terminal node list. Then, the NFA generating unit 152 registers a common @ number that is present in the extracted @ lists as a designated @ number and a largest time-out value as a time-out length in the node 6h that is in the final state. Here, the @ list of the completion node 6f is associated with an @ number of “0” and a time-out length of “2”, and the @ list of the completion node 6g is associated with an @ number of “0” and a time-out length of “5”. Accordingly, the NFA generating unit 152 registers a designation @ number of “0” and a time-out length of “5” in the node 6h that is in the final state.

As described above, the NFA generating unit 152 generates a provisional NFA based on the event pattern 141 illustrated in FIG. 16A by performing the process illustrated in FIGS. 16A to 16D.

Same-Series NFA Searching Process

Next, the same-series NFA searching process will be described. As illustrated in a first stage of FIG. 17A, the NFA generating unit 152 sets an initial state node 6a of the generated provisional NFA as the current node. In addition, the NFA generating unit 152 vacates an unprocessed node set and a same-series node set. Here, the unprocessed node set represents a set of nodes for which a searching process for checking whether or not a transition of each node has the same-series relation is not performed. The same-series node set represents a set of nodes that have the same-series relation.

As illustrated in a second stage of FIG. 17A, since a transition, which has not been processed, for a connection with the current node 6a is an ε transition, the NFA generating unit 152 determines whether or not both the current node 6a and a node 6b as a transition destination have the same-series relation. Here, since the same-series relation information “=” is not added to both the current node 6a and the node 6b as the transition destination, the NFA generating unit 152 determines that there is no same-series relation. Then, the NFA generating unit 152 adds the node 6b as the transition destination in the unprocessed node set.

As illustrated in a third stage of FIG. 17A, since there is no transition, which has not been processed, for a connection with the current node 6a and the node included in the same-series node set is vacant, the NFA generating unit 152 does not output the same-series node set.

As illustrated in a first stage of FIG. 17B, the NFA generating unit 152 sets a node, which has not been processed, having a smallest node number other than the final state node in the unprocessed node set as the current node. Here, the NFA generating unit 152 sets the node 6b having a node number of “1”, which is included in the unprocessed node set, as the current node.

As illustrated in a second stage of FIG. 17B, since the transition, which has not been processed, for a connection with the current node 6a is a normal transition without an interval condition, the NFA generating unit 152 determines whether or not the current node 6b or the node 6c as the transition destination has the same-series relation. Here, since the same-series relation information “=” is added to the node 6c as the transition destination, the NFA generating unit 152 determines the same-series relation. Then, the NFA generating unit 152 adds the current node 6b and the node 6c as the transition destination in the same-series node set.

As illustrated in a third stage of FIG. 17B, since there is no transition, which has not been processed, for a connection with the current node 6a, the NFA generating unit 152 determines whether or not all the nodes included in the same-series node set have been processed. Then, since there is a node, which has not been processed, included in the same-series node set, the NFA generating unit 152 sets a node 6c having a node number of “2”, which has not been processed, as the current node.

As illustrated in a first stage of FIG. 17C, since a transition, which has not been processed, for a connection with the current node 6c is an ε transition, the NFA generating unit 152 determines whether or not both the current node 6c and a node as a transition destination have the same-series relation. Here, since the same-series relation information “=” is added to both the current node 6c and the node 6d as the transition destination, the NFA generating unit 152 determines the same-series relation. Then, the NFA generating unit 152 adds the current node 6c and the node 6d as the transition destination in the same-series node set. Although the same-series relation information “=” is added in the current node 6c, the same-series relation information is not added in a node 6e as a transition destination, and accordingly, the NFA generating unit 152 adds the node 6e as a transition destination in the unprocessed node set.

As illustrated in a second stage of FIG. 17C, since there is no transition, which has not been processed, for a connection with the current node 6c, the NFA generating unit 152 determines whether or not all the nodes included in the same-series node set have been processed. Then, since there is a node, which has not been processed, included in the same-series node set, the NFA generating unit 152 sets a node 6d having a node number of “3”, which has not been processed, as the current node.

As illustrated in a third stage of FIG. 17C, since a transition, which has not been processed, for a connection with the current node 6d is a normal transition with an interval condition, the NFA generating unit 152 determines whether or not the current node 6d or a node 6f as a transition destination has the same-series relation. Here, since the same-series relation information “=” is added to the current node 6d, the NFA generating unit 152 determines the same-series relation. Then, the NFA generating unit 152 adds the current node 6d and the node 6f as the transition destination in the same-series node set.

As illustrated in a first stage of FIG. 17D, since there is no transition, which has not been processed, for a connection with the current node 6d, the NFA generating unit 152 determines whether or not all the nodes included in the same-series node set have been processed. Then, since there is a node, which has not been processed, included in the same-series node set, the NFA generating unit 152 sets a node 6f having a node number of “5”, which has not been processed, as the current node.

As illustrated in a second stage of FIG. 17D, since a transition, which has not been processed, for a connection with the current node 6f is not an ε transition, the NFA generating unit 152 determines whether or not the current node 6f or a node as a transition destination has the same-series relation. Here, the same-series relation information “=” is not added to any of the current node 6f and the node 6h as a transition destination. Accordingly, the NFA generating unit 152 determines that there is no same-series relation and adds the node 6h as the transition destination in the unprocessed node set.

As illustrated in a third stage of FIG. 17D, since there is no transition, which has not been processed, for a connection with the current node 6f and the node included in the same-series node set is vacant, the NFA generating unit 152 outputs the same-series node set. Here, the NFA generating unit 152 outputs the nodes having node numbers of 1, 2, 3, and 5 as the same-series node set. Then, the NFA generating unit 152 vacates the same-series node set after the output.

As illustrated in a first stage of FIG. 17E, the NFA generating unit 152 sets a node, which has not been processed, having a smallest node number other than the final state node in the unprocessed node set as the current node. Here, the NFA generating unit 152 sets the node 6b having a node number of “4”, which is included in the unprocessed node set, as the current node.

As illustrated in a second stage of FIG. 17E, since a transition, which has not been processed, for a connection with the current node 6b is a normal transition with an interval condition, the NFA generating unit 152 determines whether or not the current node or the transition destination/source node has the same-series relation. Here, the NFA generating unit 152 determines that the current node or the transmission destination/source node does not have the same-series relation. Then, the NFA generating unit 152 adds the transition destination/source nodes 6c and 6g in the unprocessed node set.

As illustrated in a third stage of FIG. 17E, since there is no transition, which has not been processed, for a connection with the current node 6e and the node included in the same-series node set is vacant, the NFA generating unit 152 does not output the same-series node set.

As illustrated in a first stage of FIG. 17F, the NFA generating unit 152 sets a node, which has not been processed, having a smallest node number other than the final state node in the unprocessed node set as the current node. Here, the NFA generating unit 152 sets the node 6g having a node number of “6”, which is included in the unprocessed node set, as the current node.

Subsequently, since a transition, which has not been processed, for a connection with the current node 6g is not an ε transition, the NFA generating unit 152 determines whether or not the current node 6g or a node as a transition destination has the same-series relation. Here, the same-series relation information “=” is not added to any of the current node 6g and the node 6h as a transition destination. Accordingly, the NFA generating unit 152 determines that there is no same-series relation and adds the node 6h as the transition destination in the unprocessed node set.

As illustrated in a second stage of FIG. 17F, since there is no transition, which has not been processed, for a connection with the current node 6g and the node included in the same-series node set is vacant, the NFA generating unit 152 does not output the same-series node set. Then, the NFA generating unit 152 determines whether or not there is a node, which has not been processed, other than the final state node 6h in the unprocessed node set. Here, since all the nodes having node numbers of 1, 4, 2, and 6 other than the final state node 6h (node number 7) included in the unprocessed node set have been processed, the NFA generating unit 152 determines that there is no node that has not been processed. Then, the NFA generating unit 152 ends the same-series NFA searching process.

As described above, the NFA generating unit 152 outputs the same-series node set based on the provisional NFA by performing the process illustrated in FIGS. 17A to 17F. In other words, the NFA generating unit 152 outputs the same-series node set in which nodes having node numbers of 1, 2, 3, and 5 are formed as one set.

Same-Series NFA Converting Process

Next, the same-series NFA converting process will be described. As illustrated in a first stage of FIG. 18A, the NFA generating unit 152 determines whether or not the set of same-series node sets is vacant. Here, since there is a set of same-series node sets, the NFA generating unit 152 determines that the set is not vacant. Thus, the NFA generating unit 152 extracts one set of same-series node sets from the sets of same-series node sets. In other words, the NFA generating unit 152 extracts a same-series node set in which nodes having node numbers of 1, 2, 3, and 5 are formed as one set.

As illustrated in a first stage of FIG. 18B, the NFA generating unit 152 sets one node, which has not been processed, included in the extracted same-series node set as the current node. Here, the NFA generating unit 152 sets a node 6b having a node number of “1”, which has not been processed, included in the same-series node set as the current node.

As illustrated in a second stage of FIG. 18B, the NFA generating unit 152 determines whether or not there is a node, which has not been processed, connected to the current node that is not present in the same-series node set. Here, since a node 6a, which has a node number of “0”, out of nodes 6a and 6b that are connected to the current node 6b has not been processed and is not present in the same-series node set, the NFA generating unit 152 determines that there is a node that has not been processed. Then, the NFA generating unit 152 generates a new node 6b′ and connects the generated node 6b′ instead of the current node 6b and the node 6a that is not present in the previous same-series node set through a direct transition (ε transition). Then, the NFA generating unit 152 adds a set of the current node 6b, the generated node 6b′, and the transition direction of the two nodes in the set of boundary node sets. Such a case is a case where the generated node 6b′ is positioned in front of the current node 6b, and accordingly, the NFA generating unit 152 sets the transition direction to a transition direction from the generated node 6b′ to the current node 6b.

As illustrated in a first stage of FIG. 18C, the NFA generating unit 152 sets one node, which has not been processed, included in the same-series node set as the current node. Here, the NFA generating unit 152 sets a node 6c having a node number of “2”, which has not been processed, included in the same-series node set as the current node.

As illustrated in a second stage of FIG. 18C, the NFA generating unit 152 determines whether or not there is a node, which has not been processed, connected to the current node that is not present in the same-series node set. Here, since a node 6e, which has a node number of “4”, out of nodes 6b and 6d that are connected to the current node 6c has not been processed and is not present in the same-series node set, the NFA generating unit 152 determines that there is a node that has not been processed. Then, the NFA generating unit 152 generates a new node 6c′ and connects the generated node 6c′ instead of the current node 6c and the node 6e that is not present in the previous same-series node set through a direct transition (ε transition). Then, the NFA generating unit 152 adds a set of the current node 6c, the generated node 6c′, and the transition direction of the two nodes in the set of boundary node sets. Such a case is a case where the generated node 6b′ is positioned in the rear of the current node 6b, and accordingly, the NFA generating unit 152 sets the transition direction to a transition direction from the current node 6c to the generated node 6c′.

As illustrated in a first stage of FIG. 18D, the NFA generating unit 152 sets one node, which has not been processed, included in the same-series node set as the current node. Here, the NFA generating unit 152 sets a node 6d having a node number of “3”, which has not been processed, included in the same-series node set as the current node.

Subsequently, the NFA generating unit 152 determines whether or not there is a node, which has not been processed, connected to the current node that is not present in the same-series node set. Here, since there is no node, which has not been processed and is not present in the same-series node set, out of nodes 6c and 6f that are connected to the current node 6d, the NFA generating unit 152 determines that there is no node that has not been processed.

As illustrated in a second stage of FIG. 18D, the NFA generating unit 152 sets one node, which has not been processed, included in the same-series node set as the current node. Here, the NFA generating unit 152 sets a node 6f having a node number of “5”, which has not been processed, included in the same-series node set as the current node.

As illustrated in a first stage of FIG. 18E, the NFA generating unit 152 determines whether or not there is a node, which has not been processed, connected to the current node that is not present in the same-series node set. Here, since a node 6h, which has a node number of “7”, out of nodes 6d and 6h that are connected to the current node 6f has not been processed and is not present in the same-series node set, the NFA generating unit 152 determines that there is a node that has not been processed. Then, the NFA generating unit 152 generates a new node 6f′ and connects the generated node 6f′ instead of the current node 6f and the node 6h that is not present in the previous same-series node set through a direct transition (ε transition). Then, the NFA generating unit 152 adds a set of the current node 6f, the generated node 6f′, and the transition direction of the two nodes in the set of boundary node sets. Such a case is a case where the generated node 6f′ is positioned in the rear of the current node 6f, and accordingly, the NFA generating unit 152 sets the transition direction to a transition direction from the current node 6f to the generated node 6f′.

As illustrated in a second stage of FIG. 18E, since there is no node, which has not been processed, in the same-series node set, the NFA generating unit 152 replicates the nodes included in the same-series node set and all the transition edges between the nodes as one set in correspondence with the number of series. Here, in a case where the number of series is three, the NFA generating unit 152 replicates the nodes 6b, 6c, 6d, and 6f included in the same-series node set and all the transition edges between the nodes in correspondence with three series. Then, the NFA generating unit 152 substitutes the transition between nodes with a transition that is received in accordance with an event of each series. In other words, the NFA generating unit 152 substitutes the transition of the first stage of a replication source with a transition that is received in accordance with an event of series 0, substitutes the replicated transition of the second stage with a transition that is received in accordance with an event of series 1, and substitutes the replicated transition of the third stage with a transition that is received in accordance with an event of series 2.

As illustrated in a first stage of FIG. 18F, the NFA generating unit 152 extracts one set of boundary nodes, which have not been processed, from the set of boundary node sets. Here, the NFA generating unit 152 extracts a set of boundary nodes in a transition direction from a generated node 6b′ having a node number of 1′ to the current node 6b having a node number of 1 from the set of boundary node sets. Then, the NFA generating unit 152 connects all the replicated nodes and generated nodes corresponding to the current node in the transition direction through all ε transitions along the transition direction of the current node and the generated node of one set, which has been extracted. Here, the NFA generating unit 152 connects the nodes 6b and the generated nodes 6b′ of three series, which have been replicated, corresponding to the current node 6b through all ε transitions in the transition direction from the generated node 6b′ to the current node 6b.

As illustrated in a second stage of FIG. 18F, the NFA generating unit 152 extracts one set of boundary nodes, which have not been processed, from the set of boundary node sets. Here, the NFA generating unit 152 extracts a set of boundary nodes in a transition direction from the current node 6c having a node number of 2 to a generated node 6c′ having a node number of 2′ from the set of boundary node sets. Then, the NFA generating unit 152 connects all the replicated nodes and generated nodes corresponding to the current node in the transition direction through all ε transitions along the transition direction of the current node and the generated node of one set, which has been extracted. Here, the NFA generating unit 152 connects the nodes 6c and the generated nodes 6c′ of three series, which have been replicated, corresponding to the current node 6c through all ε transitions in the transition direction from the current node 6c to the generated node 6c′.

As illustrated in a first stage of FIG. 18G, the NFA generating unit 152 extracts one set of boundary nodes, which have not been processed, from the set of boundary node sets. Here, the NFA generating unit 152 extracts a set of boundary nodes in a transition direction from the current node 6f having a node number of 5 to a generated node 6f′ having a node number of 5′ from the set of boundary node sets. Then, the NFA generating unit 152 connects all the replicated nodes and generated nodes corresponding to the current node in the transition direction through all ε transitions along the transition direction of the current node and the generated node of one set, which has been extracted. Here, the NFA generating unit 152 connects the nodes 6f and the generated nodes 6f′ of three series, which have been replicated, corresponding to the current node 6f through all ε transitions in the transition direction from the current node 6f to the generated node 6f′.

As illustrated in a second stage of FIG. 18G, since the set of same-series node sets is vacant, the NFA generating unit 152 maintains the magnitude relation of values of the series and renumbers unique node numbers such that the transition source of the set of boundary node sets has a small node number.

Example of NFA Generating Process for Another Pattern

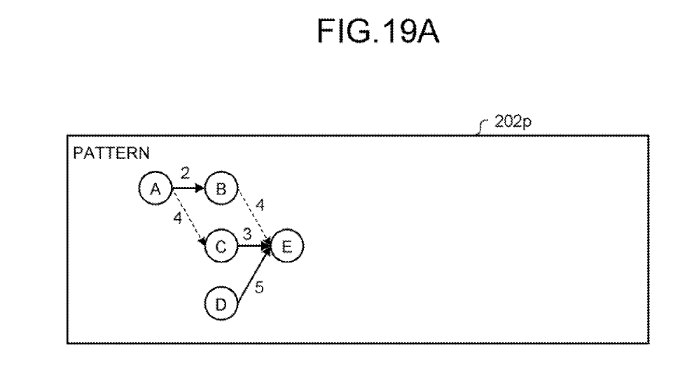

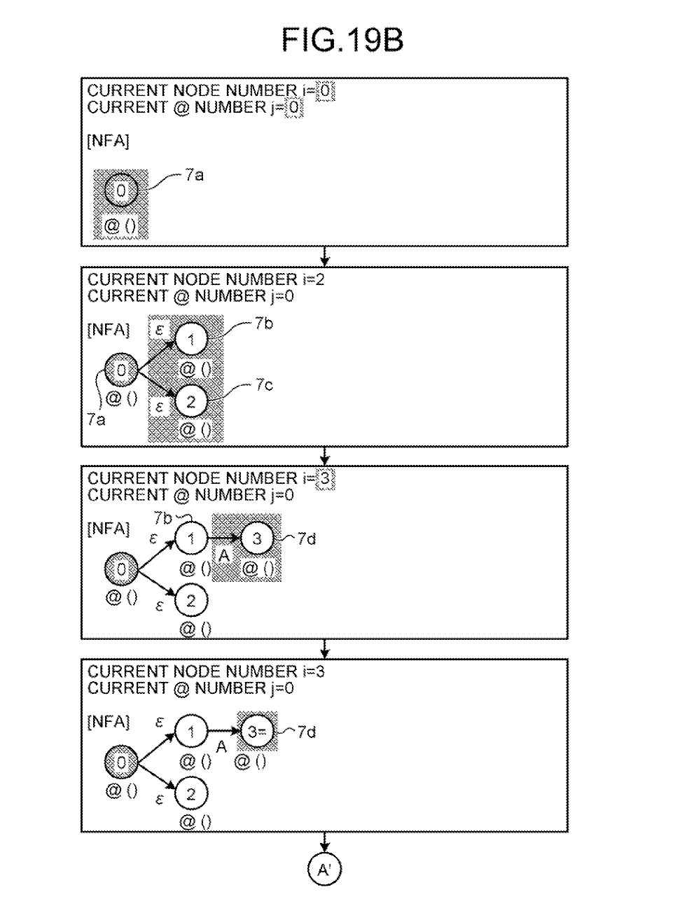

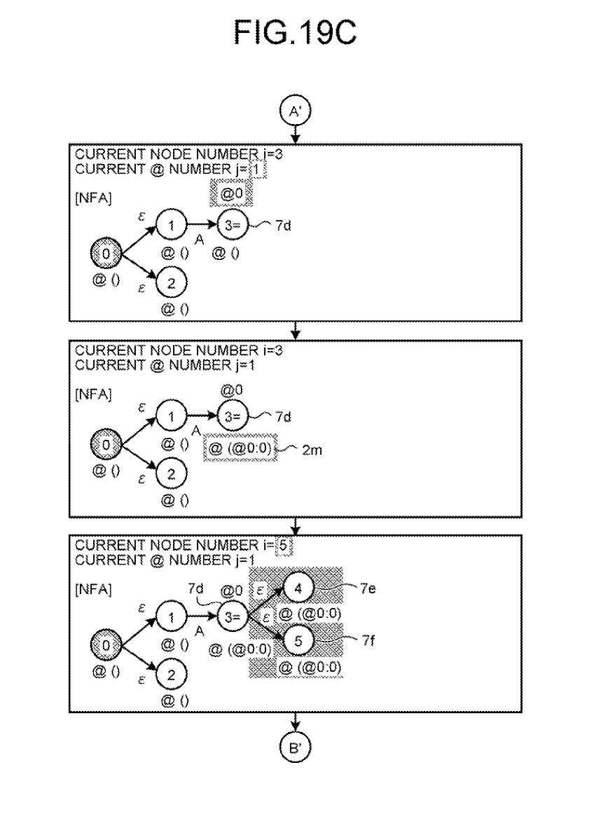

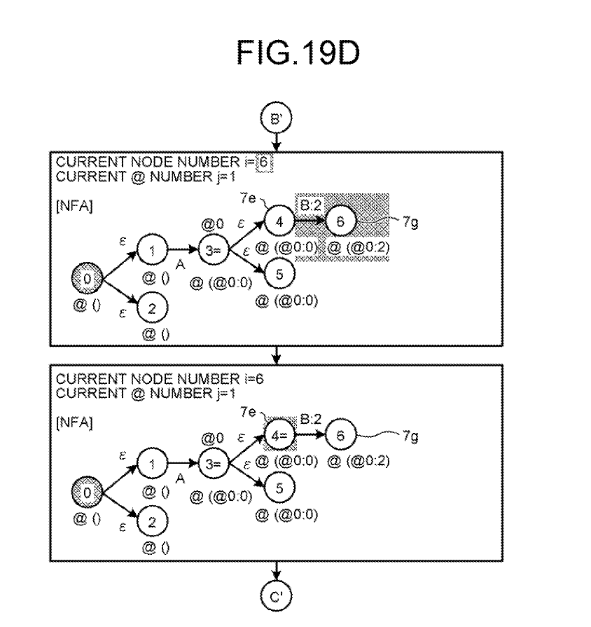

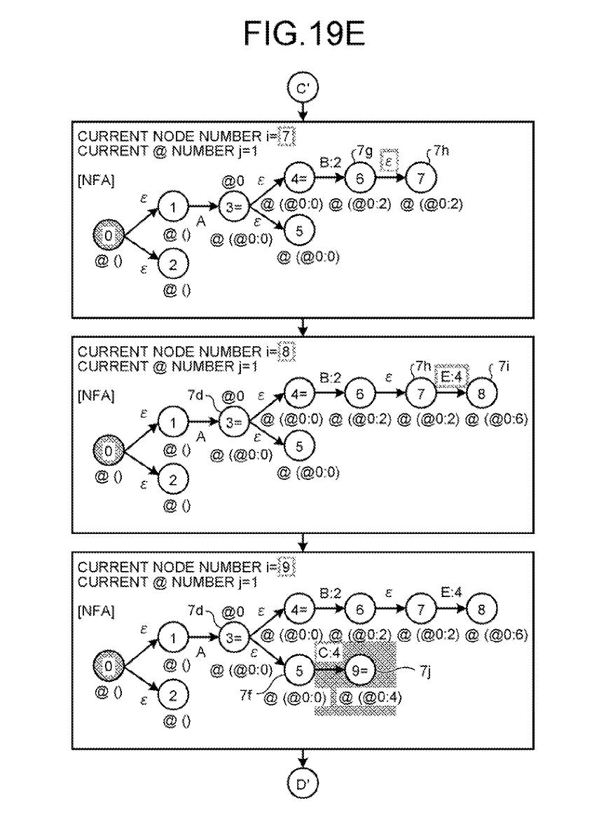

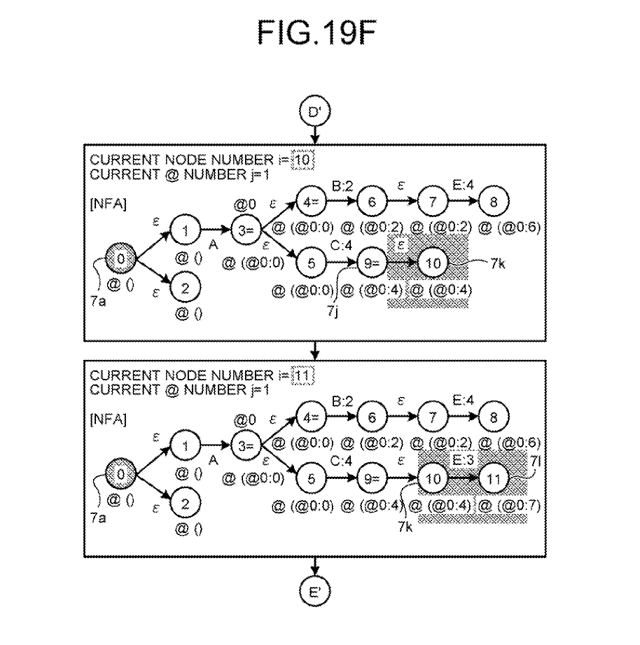

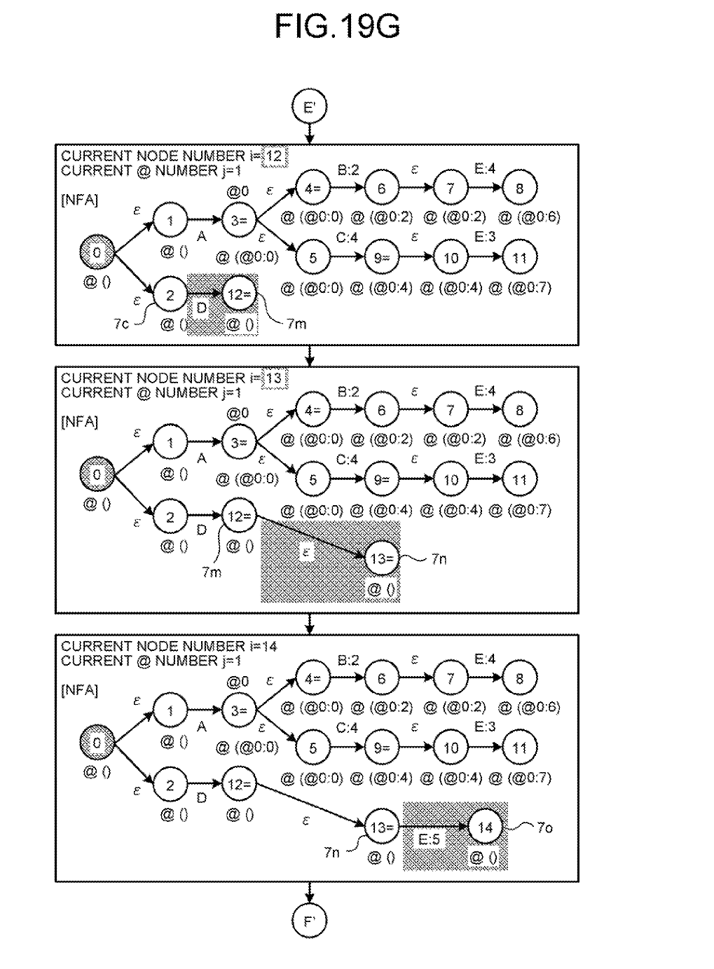

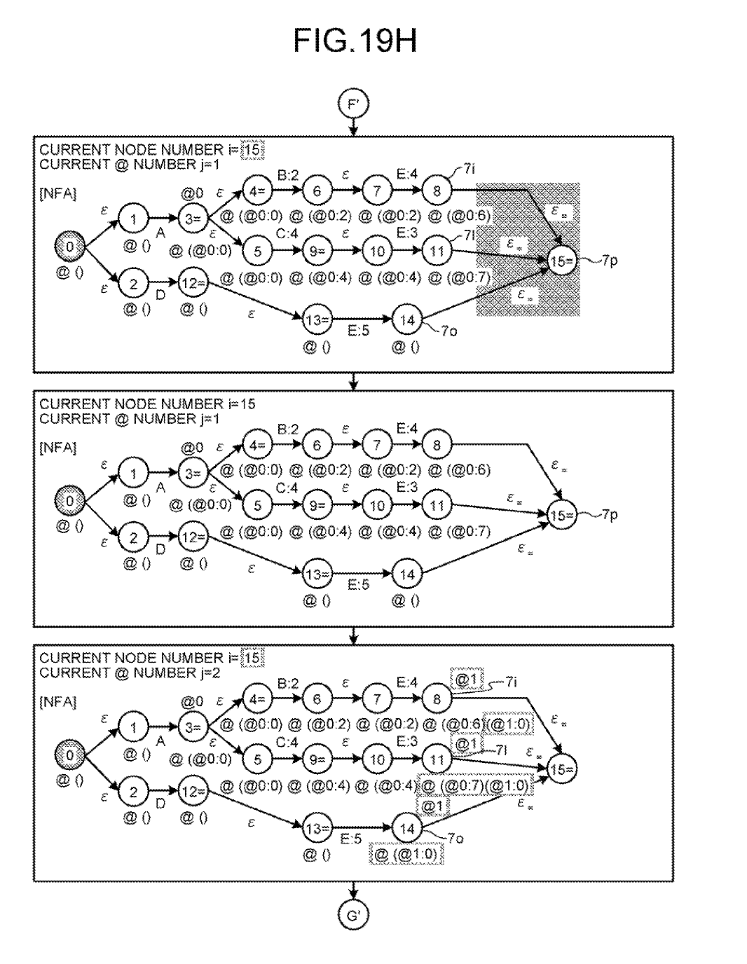

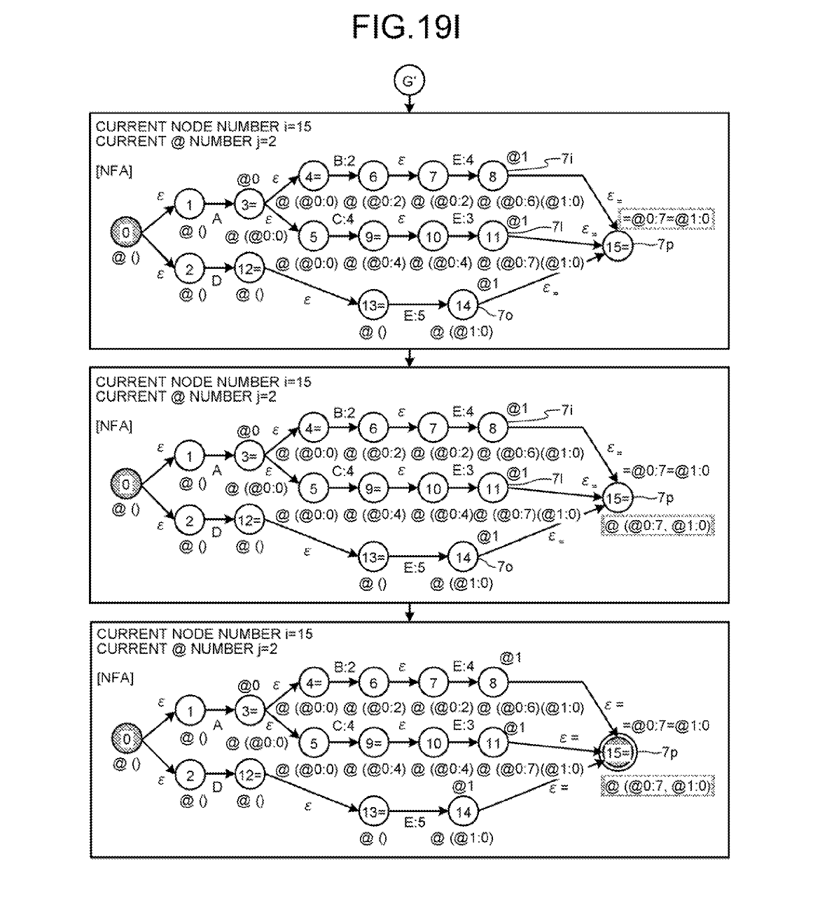

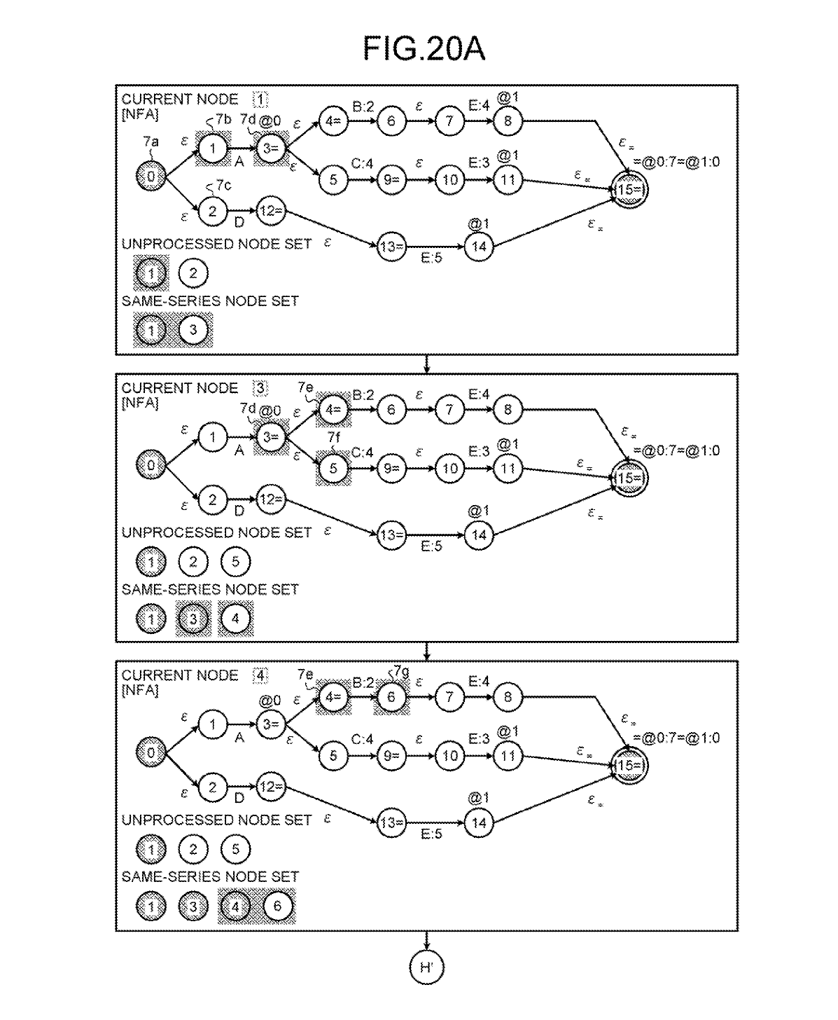

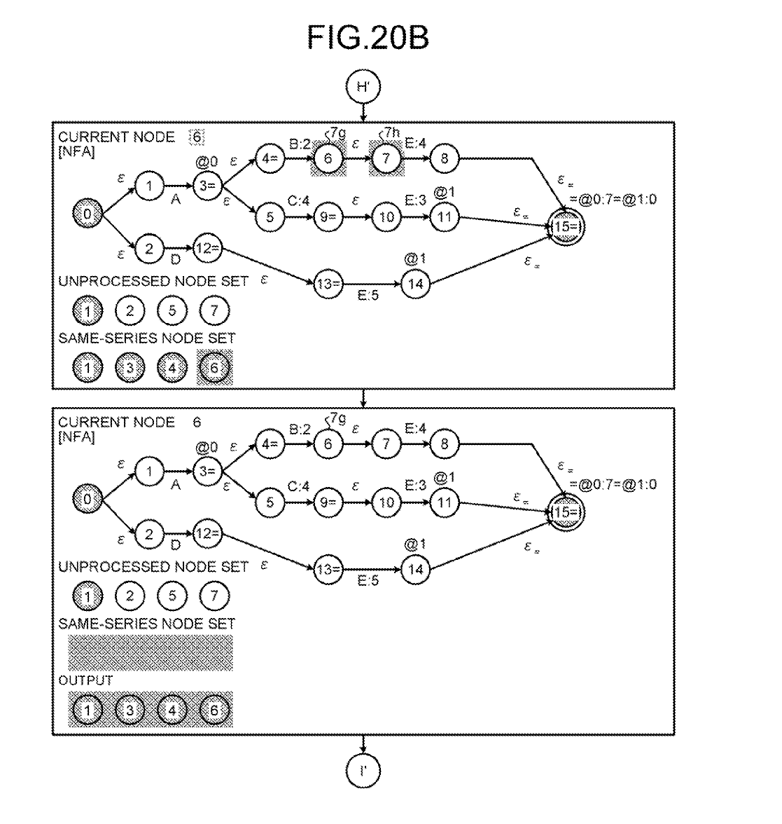

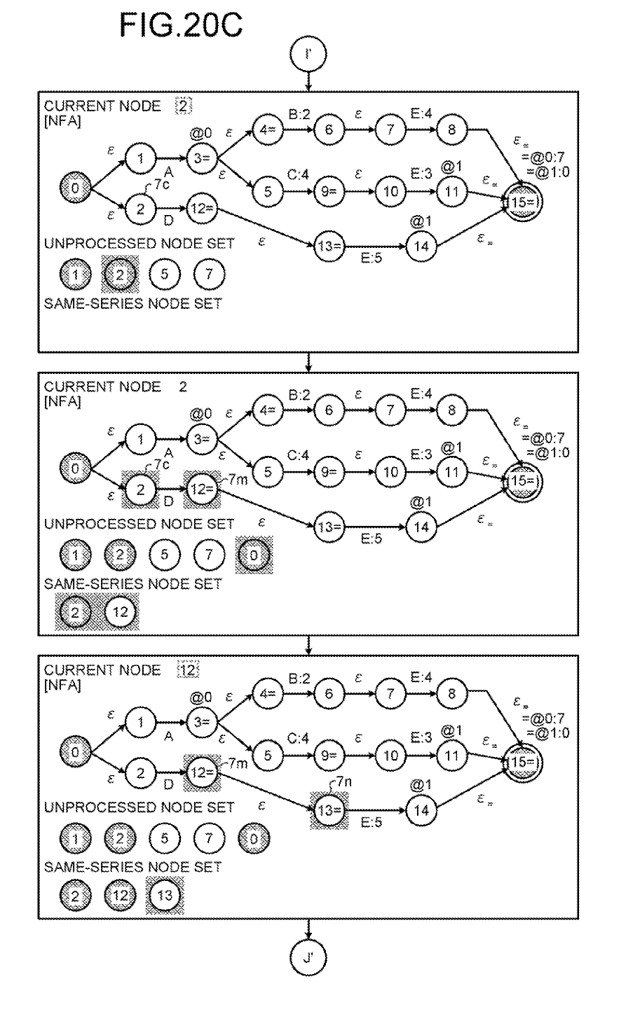

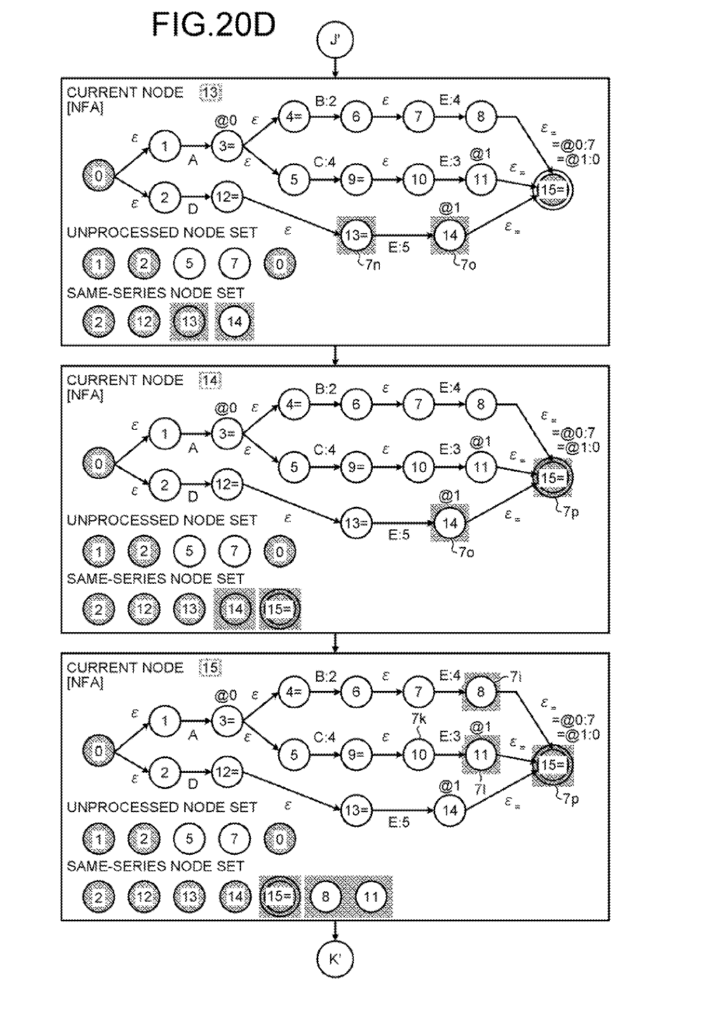

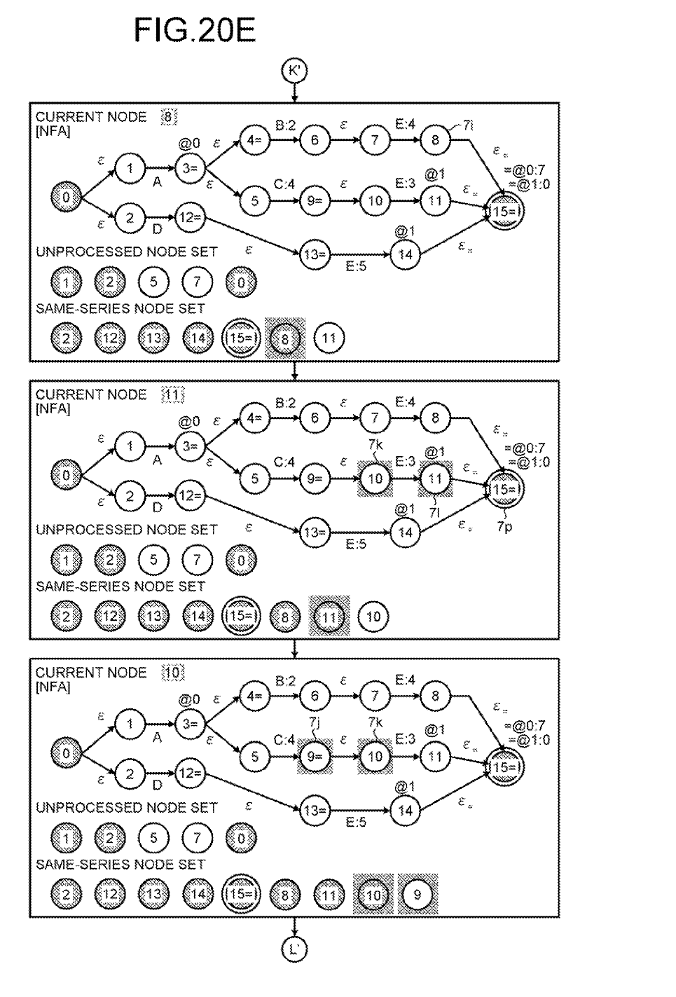

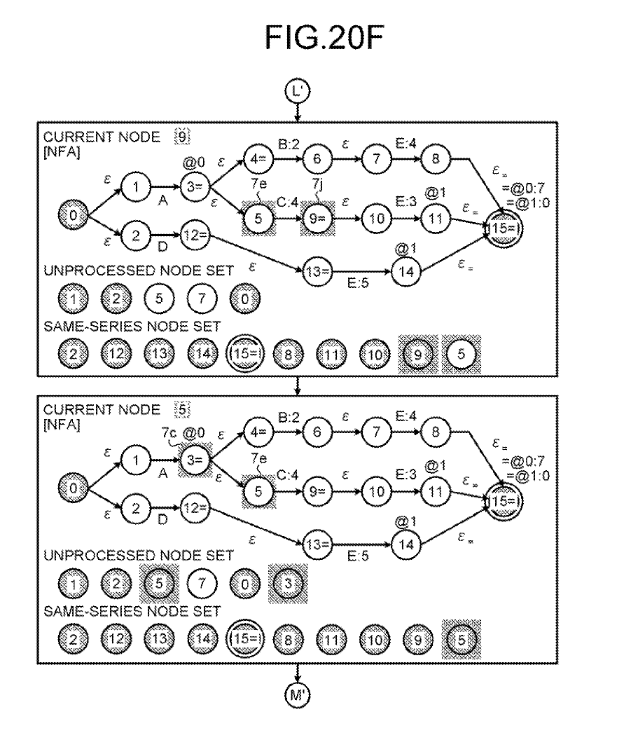

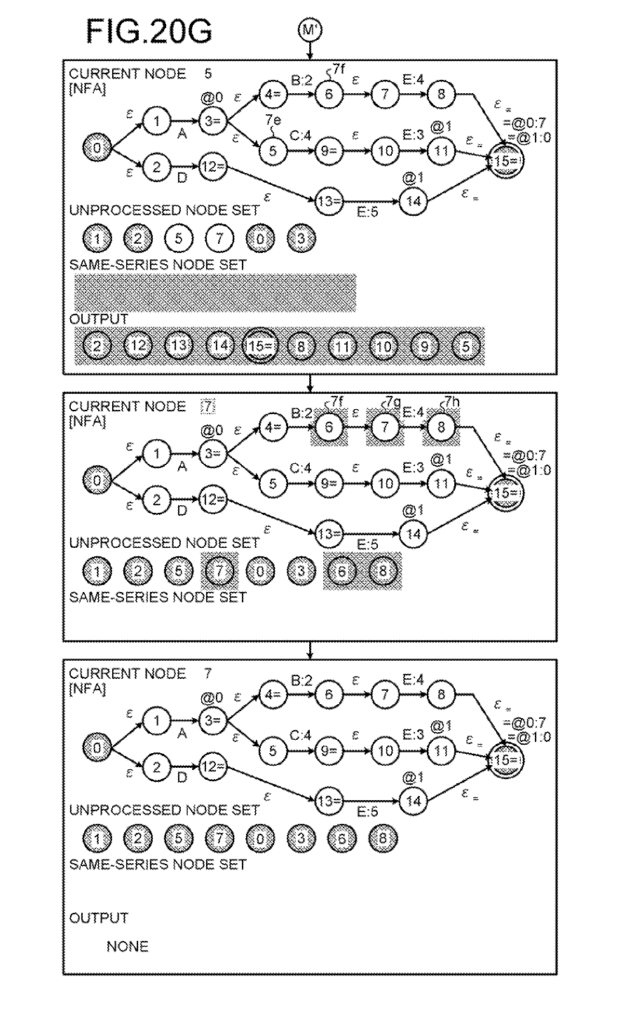

Next, an example of a process will be described in which the NFA generating unit 152 generates an NFA 142 based on the event pattern 141 by using a method of building an NFA illustrated in FIGS. 11 to 15 in a case where another pattern is set as the event pattern 141. FIGS. 19A to 19G are diagrams that illustrate a provisional NFA generating process. FIGS. 20A to 20G are diagrams that illustrate a same-series NFA searching process. FIGS. 21A to 21M are diagrams that illustrate the same-series NFA converting process.

Provisional NFA Generating Process

As illustrated in FIG. 19A, the data structure of an event pattern 141 is denoted by reference symbol 202p. The event pattern 141 has a pattern in which event A occurs in an arbitrary series, and thereafter, event B occurs in the same series as that of event A within 2. In addition, the event pattern 141 has a pattern in which event C occurs in an arbitrary series within 4 after the occurrence of event A in an arbitrary series. Furthermore, the event pattern 141 has a pattern in which event E occurs in the same series as that of event C within 3 after the occurrence of event C, within 5 after the occurrence of event D, and within 4 after the occurrence of event B.

As illustrated in a first stage of FIG. 19B, the NFA generating unit 152 generates a node 7a, of which the node number is “0”, that is in the initial state and registers a vacant @ list in the generated node 7a. Then, the NFA generating unit 152 sets the value of the current node number i to “0” and sets the value of the current @ number j to “0”. Then, the NFA generating unit 152 collects event reception restrictions appearing in the input event pattern 141, which do not have front interval restrictions, so as to be formed as a provisional event set. Here, the NFA generating unit 152 sets the event reception restrictions of event A and the event reception restrictions of event D as the provisional event set. Then, the NFA generating unit 152 sets the node 7a that is in the initial state as a starting point node.

As illustrated in a second stage of FIG. 19B, since the starting point node is the node 7a that is in the initial state, the NFA generating unit 152 generates an event input node 7b corresponding to one event reception restriction (A) collected in the provisional event set. Then, the NFA generating unit 152 assigns a value 1 that is acquired by adding one to the current node number i to the generated node 7b. Then, the NFA generating unit 152 connects the starting point node 7a to the event input node 7b through an ε transition. In addition, the NFA generating unit 152 generates an event input node 7c corresponding to another event reception restriction (D) collected in the provisional event set. Then, the NFA generating unit 152 assigns a value 2 that is acquired by adding one to the current node number i to the generated node 7c. Then, the NFA generating unit 152 connects the starting point node 7a to the event input node 7c through an ε transition.

As illustrated in a third stage of FIG. 19B, the NFA generating unit 152 extracts one event reception restriction, which has not been processed, from the event reception restrictions collected in the provisional event set. Here, the NFA generating unit 152 extracts event A. Then, since there is no front interval restriction accompanied with the extracted event A, the NFA generating unit 152 generates an event-reception completed node 7d and assigns a value 3 acquired by adding one to the current node number i to the generated node 7d. Then, the NFA generating unit 152 makes a connection on the edge in which a transition from the event input node 7b to the event-reception completed node 7d is made in accordance with the reception of event A. In addition, the NFA generating unit 152 copies the @ list of the event input node 7b to the @ list of the event-reception completed node 7d.

As illustrated in a fourth stage of FIG. 19B, since there is a rear interval restriction B, which has the same-series relation, out of the rear interval restrictions of the current event reception restriction A, the NFA generating unit 152 adds the same-series relation information “=” to the event-reception completed node 7d.

Subsequently, the NFA generating unit 152 sets the number of front interval restrictions of the current event reception restriction (A) to F. Here, since there is no restriction for the front interval of event A, the NFA generating unit 152 sets F to “0”. Then, since F is not 2 or more, the NFA generating unit 152 sets the event-reception completed node 7d as a completion node. Furthermore, the NFA generating unit 152 collects event reception restrictions with rear interval restrictions out of the extracted event reception restriction (A) together with front interval restrictions and the types of the front interval restrictions so as to be formed as a provisional event set. Here, since the interval restriction of event A until a rear event B is “2” and the relation is a transition relation of the same series, the NFA generating unit 152 sets the event reception restriction B together with the front interval restriction of “2” and the type that represents a restriction of a transition relation of the same series as a provisional event set. In addition, since the interval restriction of event A until the rear event C is “4” and the relation is a transition relation of an arbitrary series, the NFA generating unit 152 sets the event reception restriction C together with the front interval restriction of “4” and the type that represents a restriction of the transition relation of an arbitrary series as a provisional event set. Then, the NFA generating unit 152 sets the completion node 7d as a starting point node.

As illustrated in a first stage of FIG. 19C, since the starting point node 7d is not a node that is in the initial state and the number of event reception restrictions (B and C) collected in the provisional event set is two or more, the NFA generating unit 152 assigns the value “0” of the current @ number j to the starting point node 7d. In other words, this starting point node 7d is a reception time maintaining node having an @ number of 0 (@0). Then, the NFA generating unit 152 sets the value of the current @ number j to a value of “1” acquired by adding one thereto.

As illustrated in a second stage of FIG. 19C, the NFA generating unit 152 sets the assigned @ number “0” and time-out “0” in the @ list 2m of the starting point node 7d.

As illustrated in a third stage of FIG. 19C, the NFA generating unit 152 generates event input nodes 7e and 7f that correspond to the event reception restrictions (B and C) collected in the provisional event set. Then, the NFA generating unit 152 assigns a value of “4” that is acquired by adding one to the current node number i (3) to the generated node 7e and assigns a value of “5” that is acquired by further adding one to the current node number i (4) to the generated node 7f. Then, the NFA generating unit 152 connects the starting point node 7d to the event input node 7e through an ε transition and connects the starting point node 7d to the event input node 7f through an ε transition. Then, the NFA generating unit 152 copies the @ list of the starting point node 7d to the @ lists of the event input nodes 7e and 7f.

As illustrated in a first stage of FIG. 19D, the NFA generating unit 152 extracts one event reception restriction, which has not been processed, from the event reception restrictions (B and C) collected in the provisional event set. Here, the NFA generating unit 152 extracts event B. Then, the NFA generating unit 152 generates an event-reception completed node 7g and assigns a value 6 acquired by adding one to the current node number to the generated node 7g. Then, the NFA generating unit 152 makes a connection on the edge in which a transition from the event input node 7e to the event-reception completed node 7g is made in accordance with the reception of event B that satisfies the front interval restriction of “2”. In other words, the transition from the event input node 7e to the event-reception completed node 7g is a “normal transition with an interval condition”. In addition, the NFA generating unit 152 adds the front interval restriction of “2” to the time-out of the @ list of the event input node 7e and copies the @ list of the event input node 7e to the @ list of the event-reception completed node 7g.

As illustrated in a second stage of FIG. 19D, since the type of the front interval restriction accompanied with the current event reception restriction (B) is a same-series relation, the NFA generating unit 1 52 adds the same-series relation information “=” to the event input node 7e.

Subsequently, the NFA generating unit 152 sets the number of front interval restrictions of the current event reception restriction (B) to F. Here, since the front interval restriction of event B is “2”, the NFA generating unit 152 sets the number F of the front interval restrictions to “1”. Then, since F is not 2 or more, the NFA generating unit 152 sets the event-reception completed node 7g as a completion node. Furthermore, the NFA generating unit 152 collects event reception restrictions with rear interval restrictions out of the extracted event reception restriction (B) so as to be formed as a provisional event set. Here, since an interval restriction of event B until the rear event E is “4” and the transition has a transition relation of an arbitrary series, the NFA generating unit 152 sets the event reception restriction E as a provisional event set together with a front interval restriction of 4 and a type that represents a restriction of the transition relation of an arbitrary series. Then, the NFA generating unit 152 sets the completion node 7g as the starting point node.

As illustrated in a first stage of FIG. 19E, the NFA generating unit 152 generates an event input node 7h corresponding to the event reception restriction (E) collected in the provisional event set. Then, the NFA generating unit 152 assigns a value 7 acquired by adding one to the current node number i (6) to the generated node 7h. Then, the NFA generating unit 152 connects the starting point node 7g to the event input node 7h through an ε transition. Then, the NFA generating unit 152 copies the @ list of the starting point node 7g to the @ list of the event input node 7h.

As illustrated in a second stage of FIG. 19E, the NFA generating unit 152 extracts one event reception restriction, which has not been processed, from the event reception restrictions collected in the provisional event set. Here, the NFA generating unit 152 extracts event E. Then, the NFA generating unit 152 generates an event-reception completed node 7i and assigns a value 8 acquired by adding one to the current node number i to the generated node 7i. Then, the NFA generating unit 152 makes a connection on the edge in which a transition from the event input node 7h to the event-reception completed node 7i is made in accordance with the reception of event E that satisfies the front interval restriction of “4”. In addition, the NFA generating unit 152 adds the front interval restriction of “4” to the time-out of the @ list of the event input node 7h and copies the @ list of the event input node 7h to the @ list of the event-reception completed node 7i.

Subsequently, since the type of the front interval restriction accompanied with the current event reception restriction (E) is not the same-series relation, the NFA generating unit 152 does not add the same-series relation information to the event input node 7h. In addition, since there is no rear interval restriction of the current event reception restriction (E), the NFA generating unit 152 does not add the same-series relation information to the event-reception completed node 7i.

Subsequently, the NFA generating unit 152 sets the number of front interval restrictions of the current event reception restriction (E) to F. Here, since there are a restriction of “4” from event B, a restriction of “3” from event C, and a restriction of “5” from event D as the front interval restrictions of event E, the NFA generating unit 152 sets the number F of front interval restrictions to “3”. Then, since the number F is 2 or more and the number of the generated event-reception completed node corresponding to the current event reception restriction (E) is only one, which is the node 7i, the NFA generating unit 152 determines whether or not there is an event reception restriction, which has not been processed, out of event reception restrictions collected in the provisional event set. Here, since the process of the event reception restriction E collected in the provisional event set has ended, the NFA generating unit 152 returns the provisional event set and the starting point node to the original provisional event set and the original starting point node. In other words, the starting point node is the node 7d having a node number of 3, and the provisional event set includes the event reception restrictions B and C.

As illustrated in a third stage of FIG. 19E, the NFA generating unit 152 extracts one event reception restriction, which has not been processed, from the event reception restrictions (B and C) collected in the provisional event set. Here, since the process of event B has ended, the NFA generating unit 152 extracts the event reception restriction C. Then, the NFA generating unit 152 generates an event-reception completed node 7j and assigns a value 9 acquired by adding one to the current node number to the generated node 7j. Then, the NFA generating unit 152 makes a connection on the edge in which a transition from the event input node 7f to the event-reception completed node 7j is made in accordance with the reception of event C and copies the @ list. In addition, since there is a rear interval restriction of the current event reception restriction C that has the same-series relation, the NFA generating unit 152 adds the same-series relation information “=” to the event-reception completed node 7j.

Subsequently, since the number of the front interval restriction of the current event reception restriction (C) is one, the NFA generating unit 152 sets the event-reception completed node 7j as a completion node. In addition, the NFA generating unit 152 collects event reception restrictions with rear interval restrictions of the extracted event reception restriction (C) together with front interval restrictions and the types of the front interval restrictions so as to be formed as a provisional event set. Here, since the interval restriction of event C until event E located on the rear side is “3” and the transition has the transition relation of the same series, the NFA generating unit 152 sets the event reception restriction E as a provisional event set together with a front interval restriction of 3 and a type that represents a restriction of the transition relation of the same series. Then, the NFA generating unit 152 sets the completion node 7j as the starting point node.

As illustrated in a first stage of FIG. 19F, the NFA generating unit 152 generates an event input node 7k that corresponds to the event reception restriction (E) collected in the provisional event set. Then, the NFA generating unit 152 assigns a value of “10” that is acquired by adding one to the current node number i (9) to the generated node 7k. Then, the NFA generating unit 152 connects the starting point node 7j to the event input node 7k through an ε transition. Then, the NFA generating unit 152 copies the @ list of the starting point node 7j to the @ lists of the event input node 7k.

As illustrated in a second stage of FIG. 19F, the NFA generating unit 152 extracts one event reception restriction, which has not been processed, from the event reception restrictions collected in the provisional event set. Here, the NFA generating unit 152 extracts event E. Then, the NFA generating unit 152 generates an event-reception completed node 7l and assigns a value 11 acquired by adding one to the current node number i to the generated node 7l. Then, the NFA generating unit 152 makes a connection on the edge in which a transition from the event input node 7k to the event-reception completed node 7l is made in accordance with the reception of event E that satisfies a front interval restriction of 3. In addition, the NFA generating unit 152 adds the front interval restriction of 3 to the time-out of the @ list of the event input node 7k and then copies the @ list of the event input node 7k to the @ list of the event-reception completed node 7l.

Subsequently, since the type of the front interval restriction accompanied with the current event reception restriction (E) is not the same-series relation, the NFA generating unit 152 does not add the same-series relation information to the event input node 7k. In addition, since there is no rear interval restriction of the current event reception restriction (E), the NFA generating unit 152 does not add the same-series relation information to the event-reception completed node 7l.

Subsequently, the NFA generating unit 152 sets the number of front interval restrictions of the current event reception restriction (E) to F. Here, since there are a restriction of “4” from event B, a restriction of “3” from event C, and a restriction of “5” from event D as the front interval restrictions of event E, the NFA generating unit 152 sets the number F of front interval restrictions to “3”. Then, since the number F is 2 or more and the number of the generated event-reception completed nodes corresponding to the current event reception restriction (E) is two, which are the nodes 7i and 7l, the NFA generating unit 152 determines whether or not there is an event reception restriction, which has not been processed, out of event reception restrictions collected in the provisional event set. Here, since the process of the event reception restriction E collected in the provisional event set has ended, the NFA generating unit 152 returns the provisional event set and the starting point node to the original provisional event set and the original starting point node. In other words, the starting point node is the node 7a that is in the initial state, and the provisional event set includes the event reception restrictions A and D.

As illustrated in a first stage of FIG. 19G, the NFA generating unit 152 extracts one event reception restriction, which has not been processed, from the event reception restrictions (A and D) collected in the provisional event set. Here, since the process of event A has ended, the NFA generating unit 152 extracts event D. Then, the NFA generating unit 152 generates an event-reception completed node 7m and assigns a value 12 acquired by adding one to the current node number i to the generated node 7m. Then, the NFA generating unit 152 makes a connection on the edge in which a transition from the event input node 7c to the event-reception completed node 7m is made in accordance with the reception of event D and copies the @ list. In addition, since there is a rear interval restriction of the current event reception restriction D that has the same-series relation, the NFA generating unit 152 adds the same-series relation information “=” to the event-reception completed node 7m.

Subsequently, since the number of the front interval restrictions of the current event reception restriction (D) is one, the NFA generating unit 152 sets the event-reception completed node 7m as a completion node. In addition, the NFA generating unit 152 collects event reception restrictions with rear interval restrictions of the extracted event reception restriction (D) together with front interval restrictions and the types of the front interval restrictions so as to be formed as a provisional event set. Here, since the interval restriction of event D until event E located on the rear side is “5” and the transition has the transition relation of a same series, the NFA generating unit 152 sets the event reception restriction E as a provisional event set together with a type that represents a front interval restriction of “5” and the restriction of the transition relation of a same series. Then, the NFA generating unit 152 sets the completion node 7m as the starting point node.

As illustrated in a second stage of FIG. 19G, the NFA generating unit 152 generates an event input node 7n that corresponds to the event reception restriction (E) collected in the provisional event set. Then, the NFA generating unit 152 assigns a value of “13” that is acquired by adding one to the current node number i (12) to the generated node 7n. Then, the NFA generating unit 152 connects the starting point node 7m to the event input node 7n through an ε transition. Then, the NFA generating unit 152 copies the @ list of the starting point node 7m to the @ lists of the event input node 7n.

As illustrated in a third stage of FIG. 19G, the NFA generating unit 152 extracts one event reception restriction, which has not been processed, from the event reception restrictions collected in the provisional event set. Here, the NFA generating unit 152 extracts event E. Then, the NFA generating unit 152 generates an event-reception completed node 7o and assigns a value 14 acquired by adding one to the current node number i to the generated node 7o. Then, the NFA generating unit 152 makes a connection on the edge in which a transition from the event input node 7n to the event-reception completed node 7o is made in accordance with the reception of event E that satisfies a front interval restriction of “5”. In addition, the NFA generating unit 152 adds the front interval restriction of “5” to the time-out of the @ list of the event input node 7n and then copies the @ list of the event input node 7n to the @ list of the event-reception completed node 7o.

Subsequently, the NFA generating unit 152 sets the number of front interval restrictions of the current event reception restriction (E) to F. Here, since there are a restriction of “4” from event B, a restriction of “3” from event C, and a restriction of “5” from event D as the front interval restrictions of event E, the NFA generating unit 152 sets the number F of front interval restrictions to “3”. Then, since the number F is 2 or more and the number of the generated event-reception completed nodes corresponding to the current event reception restriction (E) is three, which are the nodes 7i, 7l, and 7o, the NFA generating unit 152 performs the following process.

As illustrated in a first stage of FIG. 19H, the NFA generating unit 152 generates a junction node 7p corresponding to the current event reception restriction (E). Then, the NFA generating unit 152 assigns a value of 15 that is acquired by adding one to the current node number i to the generated node 7p. Then, the NFA generating unit 152 connects all the generated event reception-completed nodes 7i, 7l, and 7o to the junction node 7p through ε=transitions.

As illustrated in a second stage of FIG. 19H, the NFA generating unit 152 adds the same-series relation information “=” to the junction node 7p.

As illustrated in a third stage of FIG. 19H, the NFA generating unit 152 assigns the current @ number j (1) and time-out “0” to the generated event-reception completed nodes 7i, 7l, and 7o corresponding to the current event reception restriction (E) and adds them to each @ list. In other words, the event-reception completed nodes 7i, 7l, and 7o become reception time maintaining nodes having an @ number of “1” (@1). Then, the NFA generating unit 152 adds one to the @ number j so as to be set to “2”.

As illustrated in a first stage of FIG. 19I, the NFA generating unit 152, in the @ lists of the generated event-reception completed nodes 7i, 7l, and 7o corresponding to the current event reception restriction (E), sets an @ number that is the same in a plurality of nodes as the designated @ number of the junction node. Then, the NFA generating unit 152 registers a largest value of the time-out values as a time-out length for each @ number. Here, the @ number included in the node 7i is @0 and @ 1, the @ number included in the node 7l is @0 and @1, and the @ number included in the node 7o is @ 1. Accordingly, the NFA generating unit 152 sets @0 and @1 as the designated @ number of the junction node 7p, and registers the time-out length of @0 as “7” and the time-out length of @1 as “0”.

As illustrated in a second stage of FIG. 19I, the NFA generating unit 152 sets @ numbers included in the @ lists of the generated event-reception completed nodes 7i, 7l, and 7o corresponding to the current event reception restriction (E) and a maximum time-out length for each @ number in an @ list of the junction node 7p. Here, the NFA generating unit 152 sets the @ number @0 and a time-out length of “7” in association with each other and sets the @ number @1 and a time-out length of “0” in association with each other. Then, the NFA generating unit 152 sets the junction node 7p as a completion node. In addition, the NFA generating unit 152 adds the completion node 7p in the terminal node list.

As illustrated in a third stage of FIG. 19I, the NFA generating unit 152 determines whether or not there are two or more nodes in the terminal node list. Here, since there is only one node 7p in the terminal node list, the NFA generating unit 152 sets the node 7p of the terminal node list as a final state node.

As described above, the NFA generating unit 152 generates a provisional NFA based on the event pattern 141 illustrated in FIG. 19A by performing the process illustrated in FIGS. 19A to 191.

Same-Series NFA Searching Process for Another Pattern

Next, a same-series NFA searching process for another pattern will be described. First, the NFA generating unit 152 sets an initial state node 7a of a generated provisional NFA as the current node. In addition, the NFA generating unit 152 vacates an unprocessed node set and a same-series node set. Then, since both the current node 7a and a node 7b as a transition destination do not have the same-series relation for one ε transition for a connection with the current node 7a, the NFA generating unit 152 adds the node 7b as the transition destination in the unprocessed node set. Similarly, since both the current node 7a and a node 7c as a transition destination do not have the same-series relation for one ε transition for a connection with the current node 7a, the NFA generating unit 152 adds the node 7c as the transition destination in the unprocessed node set. Furthermore, since there is no transition, which has not been processed, for a connection with the current node 7a and the node included in the same-series node set is vacant, the NFA generating unit 152 does not output the same-series node set. Then, the NFA generating unit 152 sets a node having a smallest node number, which has not been processed, other than the final state node in the unprocessed node set as the current node. Here, the NFA generating unit 152 sets the node 7b having a node number of “1” in the unprocessed node set as the current node.

As illustrated in a first stage of FIG. 20A, since the transition, which has not been processed, for a connection with the current node 7b is a normal transition without an interval condition, the NFA generating unit 152 determines whether or not the current node 7b or the node 7d as the transition destination has the same-series relation. Here, since the same-series relation information “=” is added to the node 7d as the transition destination, the NFA generating unit 152 determines the same-series relation. Then, the NFA generating unit 152 adds the current node 7b and the node 7d as the transition destination in the same-series node set.

As illustrated in a second stage of FIG. 20A, since there is no transition, which has not been processed, for a connection with the current node 7b, the NFA generating unit 152 determines whether or not all the nodes included in the same-series node set have been processed. Then, since there is a node, which has not been processed, included in the same-series node set, the NFA generating unit 152 sets a node 7d having a node number of “3”, which has not been processed, as the current node. Then, since a transition, which has not been processed, for a connection with the current node 7d is an ε transition, the NFA generating unit 152 determines whether or not the current node 7d and the node 7e as the transition destination have the same-series relation altogether. Here, since the same series relation information “=” is added to both the current node 7d and the node 7e as the transition destination, the NFA generating unit 152 determines that both the current node 7d and the node 7e as the transition destination have the same-series relation. Then, the NFA generating unit 152 adds the current node 7d and the node 7e as the transition destination in the same-series node set. Since the same-series relation information “=” is not added to both the current node 7d and the node 7f as the transition destination, the NFA generating unit 152 determines that both the current node 7d and the node 7f as the transition destination do not have the same-series relation. Then, the NFA generating unit 152 adds the node 7f as the transition destination in the unprocessed node set.

As illustrated in a third stage of FIG. 20A, since there is no transition, which has not been processed, for a connection with the current node 7d, the NFA generating unit 152 determines whether or not all the nodes included in the same-series node set have been processed. Then, since there is a node, which has not been processed, included in the same-series node set, the NFA generating unit 152 sets a node 7e having a node number of “4”, which has not been processed, as the current node. Since a transition, which has not been processed, for a connection with the current node 7e is a normal transition with an interval condition, the NFA generating unit 152 determines whether or not the current node 7e or a node 7g as a transition destination has the same-series relation. Here, since the same series relation information “=” is added to the current node 7e, the NFA generating unit 152 determines the same-series relation. Then, the NFA generating unit 152 adds the current node 7e and the node 7g as the transition destination in the same-series node set.

As illustrated in a first stage of FIG. 20B, since there is no transition, which has not been processed, for a connection with the current node 7e, the NFA generating unit 152 determines whether or not all the nodes included in the same-series node set have been processed. Then, since there is a node, which has not been processed, included in the same-series node set, the NFA generating unit 152 sets a node 7g having a node number of “6”, which has not been processed, as the current node. Since a transition, which has not been processed, for a connection with the current node 7e is an ε transition, the NFA generating unit 152 determines whether or not both the current node 7e and a node 7h as a transition destination have the same-series relation. Here, since the same series relation information “=” is not added to both the current node 7e and the node 7h as the transition destination, the NFA generating unit 152 determines that both the current node 7e and the node 7h as the transition destination do not have the same-series relation. Then, the NFA generating unit 152 adds the node 7h as the transition destination in the unprocessed node set.

As illustrated in a second stage of FIG. 20B, since there is no transition, which has not been processed, for a connection with the current node 7g and all the nodes included in the same-series node set are processed, the NFA generating unit 152 outputs the same-series node set. Here, the NFA generating unit 152 outputs the nodes having node numbers of 1, 3, 4, and 6 as the same-series node set. Then, the NFA generating unit 152 vacates the same-series node set after the output.

As illustrated in a first stage of FIG. 20C, the NFA generating unit 152 sets a node, which has not been processed, having a smallest node number other than the final state node in the unprocessed node set as the current node. Here, the NFA generating unit 152 sets the node 7c having a node number of “2”, which is included in the unprocessed node set, as the current node.

As illustrated in a second stage of FIG. 20C, since the transition, which has not been processed, for a connection with the current node 7c is a normal transition without an interval condition, the NFA generating unit 152 determines whether or not the current node 7c or a node 7m as a transition destination has the same-series relation. Here, since the same-series relation information “=” is added to the node 7m as the transition destination, the NFA generating unit 152 determines the same-series relation. Then, the NFA generating unit 152 adds the current node 7c and the node 7m as the transition destination in the same-series node set. Then, since there is no transition, which has not been processed, for a connection with the current node 7c, the NFA generating unit 152 determines whether or not all the nodes included in the same-series node set have been processed. Then, since there is a node, which has not been processed, included in the same-series node set, the NFA generating unit 152 sets the node 7m having a node number of “12”, which has not been processed, as the current node.

As illustrated in a third stage of FIG. 20C, since a transition, which has not been processed, for a connection with the current node 7m is an ε transition, the NFA generating unit 152 determines whether or not the current node 7m and a node 7n as a transition destination have the same-series relation. Here, since the same series relation information “=” is added to both the current node 7m and the node 7n as the transition destination, the NFA generating unit 152 determines that both the current node 7m and the node 7n as the transition destination have the same-series relation. Then, the NFA generating unit 152 adds the current node 7m and the node 7n as the transition destination in the same-series node set. Then, since there is no transition, which has not been processed, for a connection with the current node 7m, the NFA generating unit 152 determines whether or not all the nodes included in the same-series node set have been processed. Then, since there is a node, which has not been processed, included in the same-series node set, the NFA generating unit 152 sets the node 7n having a node number of “13”, which has not been processed, as the current node.

As illustrated in a first stage of FIG. 20D, since a transition, which has not been processed, for a connection with the current node 7n is a normal transition with an interval condition, the NFA generating unit 152 determines whether or not the current node 7n or a node 7o as a transition destination has the same-series relation. Here, since the same series relation information “=” is added to the current node 7n, the NFA generating unit 152 determines the same-series relation. Then, the NFA generating unit 152 adds the current node 7n and the node 7o as the transition destination in the same-series node set. Then, since there is no transition, which has not been processed, for a connection with the current node 7n, the NFA generating unit 152 determines whether or not all the nodes included in the same-series node set have been processed. Then, since there is a node, which has not been processed, included in the same-series node set, the NFA generating unit 152 sets the node 7o having a node number of “14”, which has not been processed, as the current node.

As illustrated in a second stage of FIG. 20D, since a transition, which has not been processed, for a connection with the current node 7o is not an ε transition, the NFA generating unit 152 determines whether or not the current node 7o or a node as a transition destination/source has the same-series relation. Here, since the current node 7o is included in the same series relation set, and the same series relation information “=” is added to the transition destination node 7p, the NFA generating unit 152 determines the same-series relation. Then, the NFA generating unit 152 adds the current node 7o and the transition destination/source node 7p (a node number of “15”) in the same-series node set. Then, since there is a node, which has not been processed, included in the same-series node set, the NFA generating unit 152 sets the node 7p having a node number of “15”, which has not been processed, as the current node.

As illustrated in a third stage of FIG. 20D, since a transition, which has not been processed, for a connection with the current node 7p is not an ε transition, the NFA generating unit 152 determines whether or not the current node 7p or a node as a transition destination/source node has the same-series relation. Here, since the current node 7p has the same series relation, the NFA generating unit 152 adds the current node 7p and the transition destination/source node 7i (a node number of “8”) in the same-series node set. In addition, since the current node 7p has the same-series relation, the NFA generating unit 152 adds the current node 7p and the transition destination/source node 7l (a node number of “11”) in the same-series node set.

As illustrated in a first stage of FIG. 20E, since there is a node, which has not been processed, included in the same-series node set, the NFA generating unit 152 sets a node 7i having a node number of “8”, which has not been processed, as the current node.

As illustrated in a second stage of FIG. 20E, since there is no transition, which has not been processed, for a connection with the current node 7i, the NFA generating unit 152 determines whether or not there is a node, which has not been processed, included in the same-series node set. Here, since there is a node, which has not been processed, included in the same-series node set, the NFA generating unit 152 sets a node 7l having a node number of “11”, which has not been processed, as the current node. Then, since a transition, which has not been processed, for a connection with the current node 7l is a normal transition with an interval condition, the NFA generating unit 152 determines whether or not the current node 7l or the transition destination/source node has the same-series relation. Here, since the transition destination/source node 7k has the same-series relation, the NFA generating unit 152 adds the current node 7l and the transition destination/source node 7k in the same-series node set.

As illustrated in a third stage of FIG. 20E, since there is a node, which has not been processed, included in the same-series node set, the NFA generating unit 152 sets a node 7j having a node number of “9”, which has not been processed, as the current node.

As illustrated in a first stage of FIG. 20F, since a transition, which has not been processed, for a connection with the current node 7j is a normal transition with an interval condition, the NFA generating unit 152 determines whether or not the current node 7j or a transition destination/source node has the same-series relation. Here, since the current node 7j has the same-series relation, the NFA generating unit 152 adds the current node 7j and the transition destination/source node 7e in the same-series node set.

As illustrated in a second stage of FIG. 20F, since there is a node, which has not been processed, included in the same-series node set, the NFA generating unit 152 sets a node 7e having a node number of “5”, which has not been processed, as the current node. Then, since a transition, which has not been processed, for a connection with the current node 7e is an ε transition, the NFA generating unit 152 determines whether or not both the current node 7e and the transition destination/source node has the same-series relation. Here, since both the current node 7e and the transition destination/source node do not have the same-series relation, the NFA generating unit 152 adds the transition destination/source node 7c (a node number of “3”) in the unprocessed node set.

As illustrated in a first stage of FIG. 20G, since there is no transition, which has not been processed, for a connection with the current node 7f and the node included in the same-series node set is vacant, the NFA generating unit 152 outputs the same-series node set. Here, the NFA generating unit 152 outputs the nodes having node numbers of 2, 12, 13, 14, 15, 8, 11, 10, 9, and 5 as the same-series node set. Then, the NFA generating unit 152 vacates the same-series node set after the output. In addition, the NFA generating unit 152 sets a node, which has not been processed, having a smallest node number other than the final state node in the unprocessed node set as the current node. Here, the NFA generating unit 152 sets the node 7e having a node number of “5”, which is included in the unprocessed node set, as the current node. The NFA generating unit 152 determines that there is no transition, which has not been processed, for a connection with the current node 7e.

As illustrated in a second stage of FIG. 20G, the NFA generating unit 152 sets a node, which has not been processed, having a smallest node number other than the final state node in the unprocessed node set as the current node. Here, the NFA generating unit 152 sets the node 7e having a node number of “7”, which is included in the unprocessed node set, as the current node. Since the transition destination/source node connected to the current node 7e does not have the same-series relation, the NFA generating unit 152 adds the transition destination/source nodes 7f and 7h in the unprocessed node set. Since there is no transition, which has not been processed, for a connection with the nodes 7f and 7h, the NFA generating unit 152 ends the process of setting the nodes as the current node.

As illustrated in a third stage of FIG. 20G, since there is no node, which has not been processed, other than the final state node in the unprocessed node set, the NFA generating unit 152 ends the same-series NFA searching process.

As described above, the NFA generating unit 152 outputs the same-series node set based on the provisional NFA by performing the process illustrated in FIGS. 20A to 20G. In other words, the NFA generating unit 152 outputs the same-series node set in which nodes having node numbers of 1, 3, 4, and 6 are formed as one set, and the same-series node set in which nodes having node numbers of 2, 12, 13, 14, 15, 8, 11, 10, 9, and 5 are formed as one set.

Same-Series NFA Converting Process for Another Pattern

Next, the same-series NFA converting process for another pattern will be described. As illustrated in FIG. 21A, the NFA generating unit 152 determines whether or not the set of same-series node sets is vacant. Here, since there is a set of same-series node sets, the NFA generating unit 152 determines that the set is not vacant.

As illustrated in FIG. 21B, the NFA generating unit 152 extracts one set of same-series node sets from the sets of same series node sets. In other words, the NFA generating unit 152 extracts a same-series node set in which nodes having node numbers of 1, 3, 4, and 6 are formed as one set.

As illustrated in a first stage of FIG. 21C, the NFA generating unit 152 sets one node, which has not been processed, included in the extracted same series node set as the current node. Here, the NFA generating unit 152 sets a node 7b having a node number of “1”, which has not been processed, included in the same-series node set as the current node. Then, the NFA generating unit 152 determines whether or not there is a node, which has not been processed, connected to the current node that is not present in the same-series node set. Here, since a node 7a (a node number of “0”) that is connected to the current node 7b has not been processed and is not present in the same-series node set, the NFA generating unit 152 determines that there is a node that has not been processed. Then, the NFA generating unit 152 generates a new node 7b′ and connects the generated node 7b′ instead of the current node 7b and the node 7a that is not present in the previous same-series node set through a direct transition (ε transition). Then, the NFA generating unit 152 adds a set of the current node 7b, the generated node 7b′, and the transition direction of the two nodes in the set of boundary node sets. Such a case is a case where the generated node 7b′ is positioned in front of the current node 7b, and accordingly, the NFA generating unit 152 sets the transition direction to a transition direction from the generated node 7b′ to the current node 7b.

As illustrated in a second stage of FIG. 21C, the NFA generating unit 152 sets one node, which has not been processed, included in the same series node set as the current node. Here, the NFA generating unit 152 sets a node 7d having a node number of “3”, which has not been processed, included in the same-series node set as the current node. Then, the NFA generating unit 152 determines whether or not there is a node, which has not been processed, connected to the current node that is not present in the same-series node set. Here, since a node 7f, which has a node number of “5”, out of nodes 7e and 7f that are connected to the current node 7d has not been processed and is not present in the same-series node set, the NFA generating unit 152 determines there is a node that has not been processed. Then, the NFA generating unit 152 generates a new node 7d′ and connects the generated node 7d′ instead of the current node 7d and the node 7d that is not present in the previous same-series node set through a direct transition (ε transition). Then, the NFA generating unit 152 adds a set of the current node 7d, the generated node 7d′, and the transition direction of the two nodes in the set of boundary node sets. Such a case is a case where the generated node 7d′ is positioned in the rear of the current node 7d, and accordingly, the NFA generating unit 152 sets the transition direction to a transition direction from the current node 7d to the generated node 7d′.

As illustrated in a first stage of FIG. 21D, the NFA generating unit 152 sets one node, which has not been processed, included in the same series node set as the current node. Here, the NFA generating unit 152 sets a node 7e having a node number of “4”, which has not been processed, included in the same-series node set as the current node. Then, the NFA generating unit 152 determines whether or not there is a node, which has not been processed, connected to the current node that is not present in the same-series node set. Here, since there is no node, which has not been processed and is not present in the same-series node set, out of nodes 7g and 7d that are connected to the current node 7e, the NFA generating unit 152 determines that there is no node that has not been processed.

As illustrated in a second stage of FIG. 21D, the NFA generating unit 152 sets one node, which has not been processed, included in the same series node set as the current node. Here, the NFA generating unit 152 sets a node 7g having a node number of “6”, which has not been processed, included in the same-series node set as the current node. Then, the NFA generating unit 152 determines whether or not there is a node, which has not been processed, connected to the current node that is not present in the same-series node set. Here, since a node 7h, which has a node number of “7”, out of nodes 7e and 7h that are connected to the current node 7g has not been processed and is not present in the same-series node set, the NFA generating unit 152 determines that there is a node that has not been processed. Then, the NFA generating unit 152 generates a new node 7g′ and connects the generated node 7g′ instead of the current node 7g and the node 7h that is not present in the previous same-series node set through a direct transition (ε transition). Then, the NFA generating unit 152 adds a set of the current node 7g, the generated node 7g′, and the transition direction of the two nodes in the set of boundary node sets. Such a case is a case where the generated node 7g′ is positioned in the rear of the current node 7g, and accordingly, the NFA generating unit 152 sets the transition direction to a transition direction from the current node 7g to the generated node 7g′.

As illustrated in a first stage of FIG. 21E, since there is no node, which has not been processed, in the same-series node set, the NFA generating unit 152 replicates the nodes included in the same-series node set and all the transition edges between the nodes as one set in correspondence with the number of series. Here, in a case where the number of series is three, the NFA generating unit 152 replicates the nodes 7b, 7d, 7e, and 7g included in the same-series node set and all the transition edges between the nodes in correspondence with three series. Then, the NFA generating unit 152 substitutes the transition between nodes with a transition that is received in accordance with an event of each series. In other words, the NFA generating unit 152 substitutes the transition of the first stage of a replication source with a transition that is received in accordance with an event of series 0, substitutes the replicated transition of the second stage with a transition that is received in accordance with an event of series 1, and substitutes the replicated transition of the third stage with a transition that is received in accordance with an event of series 2.

As illustrated in a second stage of FIG. 21E, the NFA generating unit 152 extracts one set of boundary nodes, which have not been processed, from the set of boundary node sets. Here, the NFA generating unit 152 extracts a set of boundary nodes in a transition direction from a generated node 7b′ having a node number of 1′ to the current node 7b having a node number of 1 from the set of boundary node sets. Then, the NFA generating unit 152 connects all the replicated nodes and generated nodes corresponding to the current node in the transition direction through all ε transitions along the transition direction of the current node and the generated node of one set, which has been extracted. Here, the NFA generating unit 152 connects the nodes 7b and the generated nodes 7b′ of three series, which have been replicated, corresponding to the current node 7b through all ε transitions in the transition direction from the generated node 7b′ to the current node 7b.

As illustrated in a first stage of FIG. 21F, the NFA generating unit 152 extracts one set of boundary nodes, which have not been processed, from the set of boundary node sets. Here, the NFA generating unit 152 extracts a set of boundary nodes in a transition direction from the current node 7d having a node number of 3 to a generated node 7d′ having a node number of 3′ from the set of boundary node sets. Then, the NFA generating unit 152 connects all the replicated nodes and generated nodes corresponding to the current node in the transition direction through all ε transitions along the transition direction of the current node and the generated node of one set, which has been extracted. Here, the NFA generating unit 152 connects the nodes 7d and the generated nodes 7d′ of three series, which have been replicated, corresponding to the current node 7b through all ε transitions in the transition direction from the current node 7d to the generated node 7d′.

As illustrated in a second stage of FIG. 21F, the NFA generating unit 152 extracts one set of boundary nodes, which have not been processed, from the set of boundary node sets. Here, the NFA generating unit 152 extracts a set of boundary nodes in a transition direction from the current node 7g having a node number of 6 to a generated node 7g′ having a node number of 6′ from the set of boundary node sets. Then, the NFA generating unit 152 connects all the replicated nodes and generated nodes corresponding to the current node in the transition direction through all ε transitions along the transition direction of the current node and the generated node of one set, which has been extracted. Here, the NFA generating unit 152 connects the nodes 7g and the generated nodes 7g′ of three series, which have been replicated, corresponding to the current node 7g through all ε transitions in the transition direction from the current node 7g to the generated node 7g′.

As illustrated in a first stage of FIG. 21G, the NFA generating unit 152 determines whether or not the set of same-series node sets is vacant. Here, since there is a set of same-series node sets, the NFA generating unit 152 determines that the set is not vacant. Thus, the NFA generating unit 152 extracts one set of same-series node sets from the sets of same series node sets. In other words, the NFA generating unit 152 extracts a same-series node set in which nodes having node numbers of 2, 12, 13, 14, 15, 8, 11, 10, 9, and 5 are formed as one set.

As illustrated in a second stage of FIG. 21G, the NFA generating unit 152 sets one node 7c having a node number of 2, which has not been processed, included in the extracted same series node set as the current node. Here, since there is a node 7a, which has not been processed and is not present in the same series node set, out of nodes connected to the current node, the NFA generating unit 152 generates a new node 7c′. Then, the NFA generating unit 152 connects the generated node 7c′ instead of the current node 7c and the node 7a that is not present in the previous same-series node set through a direct transition (ε transition). Then, the NFA generating unit 152 adds a set of the current node 7c, the generated node 7c′, and the transition direction of the two nodes in the set of boundary node sets. Such a case is a case where the generated node 7c′ is positioned in front of the current node 7c, and accordingly, the NFA generating unit 152 sets the transition direction to a transition direction from the generated node 7c′ to the current node 7c.

As illustrated in a first stage of FIG. 21H, the NFA generating unit 152 sets a node 7i having a node number of 8 as one node, which has not been processed, included in the extracted same-series node set as the current node. Then, since there is a node 7h, which has not been processed and is not included in the same-series node set, out of nodes connected to the current node, the NFA generating unit 152 generates a new node 7i′. Then, the NFA generating unit 152 connects the generated node 7i′ instead of the current node 7i and the node 7h that is not present in the previous same-series node set through a direct transition (normal transition with an interval condition). Then, the NFA generating unit 152 adds a set of the current node 7i, the generated node 7i′, and the transition direction of the two nodes in the set of boundary node sets. Such a case is a case where the generated node 7i′ is positioned in front of the current node 7i, and accordingly, the NFA generating unit 152 sets the transition direction to a transition direction from the generated node 7i′ to the current node 7i.

As illustrated in a second stage of FIG. 21H, the NFA generating unit 152 sets one node 7f having a node number of 5, which has not been processed, included in the extracted same series node set as the current node. Here, since there is a node 7d′, which has not been processed and is not present in the same series node set, out of nodes connected to the current node, the NFA generating unit 152 generates a new node 7f′. Then, the NFA generating unit 152 connects the generated node 7f′ instead of the current node 7f and the node 7d′ that is not present in the previous same-series node set through a direct transition (ε transition). Then, the NFA generating unit 152 adds a set of the current node 7f, the generated node 7f′, and the transition direction of the two nodes in the set of boundary node sets. Such a case is a case where the generated node 7f′ is positioned in front of the current node 7f, and accordingly, the NFA generating unit 152 sets the transition direction to a transition direction from the generated node 7f′ to the current node 7f.

As illustrated in a first stage of FIG. 21I, since there is no node, which has not been processed, in the same-series node set, the NFA generating unit 152 replicates the nodes included in the same-series node set and all the transition edges between the nodes as one set in correspondence with the number of series. Here, in a case where the number of series is three, the NFA generating unit 152 replicates the nodes 7c, 7m, 7n, 7o, 7p, 7l, 7k, 7j, 7f, and 7i included in the same-series node set and all the transition edges between the nodes in correspondence with three series. Then, the NFA generating unit 152 substitutes the transition between nodes with a transition that is received in accordance with an event of each series.

As illustrated in FIG. 21J, the NFA generating unit 152 extracts one set of boundary nodes in the transition direction from the generated node 7c′ having a node number of 2′ to the current node 7c having a node number of 2, which have not been processed, from the set of boundary node sets. Then, the NFA generating unit 152 connects all the replicated nodes and generated nodes corresponding to the current node in the transition direction through all ε transitions along the transition direction of the current node and the generated node of one set, which has been extracted.

As illustrated in FIG. 21K, the NFA generating unit 152 extracts one set of boundary nodes in the transition direction from the generated node 7i′ having a node number of 8′ to the current node 7i having a node number of 8, which have not been processed, from the set of boundary node sets. Then, the NFA generating unit 152 connects all the replicated nodes and generated nodes corresponding to the current node in the transition direction through all ε transitions along the transition direction of the current node and the generated node of one set, which has been extracted.

As illustrated in FIG. 21L, the NFA generating unit 152 extracts one set of boundary nodes in the transition direction from the generated node 7f′ having a node number of 5′ to the current node 7f having a node number of 5, which have not been processed, from the set of boundary node sets. Then, the NFA generating unit 152 connects all the replicated nodes and generated nodes corresponding to the current node in the transition direction through all ε transitions along the transition direction of the current node and the generated node of one set, which has been extracted.

As illustrated in FIG. 21M, since the set of same-series node sets is vacant, the NFA generating unit 152 maintains the magnitude relation of values of the series and renumbers unique node numbers such that the transition source of the set of boundary node sets has a small node number.

Processing Sequence of Pattern Collation Performed by Collation Unit According to Embodiment

Next, the processing sequence of pattern collation performed by the collation unit 153 according to an embodiment will be described with reference to FIGS. 22 to 24. FIG. 22 illustrates the sequence of a main process of the pattern collation performed by the collation unit, FIGS. 23A and 23B illustrate the sequence of the process for activating a normal transition, and FIG. 24 illustrates the sequence of the process for activating all the ε transitions and ε=transitions.

Sequence of Main Process of Pattern Collation

First, the sequence of the main process of the pattern collation will be described with reference to FIG. 22. FIG. 22 is a flowchart that illustrates the sequence of the main process of the pattern collation that is performed by the collation unit according to the embodiment. For example, the process illustrated in FIG. 22 is triggered by acquiring an event pattern 141 and an event stream 143 and then generating an NFA 142. In addition, the current event of each ID corresponding to a series of the event stream 143 will be denoted by S[i][ID]. Here, i represents the value of the current event position, in other words, the value of time. In addition, an ID represents the value of a series.

First, the collation unit 153 sets the value of the current event position i to “0” in Step S51. Then, the collation unit 153 determines whether or not there is an event S[i][ID] for any ID in Step S52.

In a case where there is no event S[i][ID] for any ID (No in Step S52), the collation unit 153 ends the main process. On the other hand, in a case where there is an event S[i][ID] for any ID (Yes in Step S52), the collation unit 153 reads an event S[i][ID] from the event stream 143 in Step S53.

Subsequently, the collation unit 153 activates all the normal transitions of NFA(N(P)) for the read event S[i][ID] in Step S54. Here, NFA(N(P)) corresponds to the NFA 142.

In addition, the collation unit 153 activates all the ε transitions and ε=transitions of NFA(N(P)) in Step S55. Then, the collation unit 153 adds one to the value of the current event position i in Step S56 and proceeds to Step S52.

Sequence of Process of Activating Normal Transition

Next, the process of activating a normal transition that is illustrated in Step S54 illustrated in FIG. 22 will be described with reference to FIGS. 23A and 23B. FIGS. 23A and 23B are flowcharts that illustrate the sequence of the process of activating a normal transition.

As illustrated in FIGS. 23A and 23B, the collation unit 153 sets the value of the state j to 1 and sets the value of the transition destination state k to 0 in Step S511. Here, the state j corresponds to the node number of the NFA 142, that is, the state number. In addition, the transition destination state k corresponds to the node number of the transition destination, that is, the transition state number.

Then, the collation unit 153 determines whether or not there is the state j in Step S512 and ends the process in a case where there is no state j (No in Step S512). On the other hand, in a case where there is the state j (Yes in Step S512), the collation unit 153 determines whether or not a normal transition for the event S[i][ID] is output from the state j in Step S513. In a case where the normal transition is not output (No in Step S513), the collation unit 153 adds one to the value of the state j in Step S514 and proceeds to Step S512.

On the other hand, in a case where the normal transition is output (Yes in Step S513), the collation unit 153 determines the transition type corresponding to the event S[i][ID] by using the transition type determining table in Step S513A. More specifically, the collation unit 153 determines whether or not the normal transition output from the state j is an ID-designated transition. Then, in the case of the ID-designated transition, the collation unit 153 determines the transition type corresponding to the event S[i][ID] based on the coincidence of the event and the ID. In other words, in a case where an event relating to the output normal transition and the event S[i][ID] coincide with each other and the ID relating to the output normal transition and the ID for which the event S[i][ID] occurs coincide with each other, the collation unit 153 sets the output normal transition as the transition type corresponding to the event. Such a transition type represents a normal transition with an interval condition or a normal transition without interval condition. In addition, in a case where the event relating to the output normal transition and the event S[i][ID] do not coincide with each other, or the ID relating to the output normal transition and the ID for which the current event S[i][ID] occurs do not coincide with each other, the transition type corresponding to the event is assumed to be no-transition. In addition, in a case where the normal transition output from the state j is not the ID-designated transition, the collation unit 153 sets the output normal transition as the transition type corresponding to the event.

Then, the collation unit 153 determines whether or not the transition type corresponding to the event is no-transition in Step S513B. In a case where the transition type corresponding to the event is determined to be no-transition (Yes in Step S513B), the collation unit 153 proceeds to Step S514. On the other hand, in a case where the transition type corresponding to the event is determined not to be no-transition (No in Step S513B), the collation unit 153 determines whether or not the transition type corresponding to the event is a normal transition with an interval condition in Step S513C. Then, in a case where the transition type is not a normal transition with an interval condition (No in Step S513C), the collation unit 153 sets a provisional list to be vacant in Step S515. Here, the provisional list is a temporary list that is temporarily used for generating an event list and has the same configuration as that of the event list. In addition, the event list is associated with each node that receives an event, and the reception state of the event is set therein. In the reception state, for example, the @ number position and the final reception position are associated with each other. The @ number position represents an area in which the event position of an event received by the reception time maintaining node, to which the @ number is assigned, is written. In addition, the final reception position represents an area in which the event position of an event received finally in the current state is written.

Then, the collation unit 153 sets the normal transition destination state number of the state j to the state k in Step S516. Then, the collation unit 153 determines whether or not an @ number is assigned to the state k in Step S517. In other words, the collation unit 153 determines whether or not a node corresponding to the node number of the state k is a reception time maintaining node. In a case where the @ number is assigned to the state k (Yes in Step S517), the collation unit 153 writes the current event position i at the @ number position of the provisional list in Step S518 and proceeds to Step S519. Then, the collation unit 153 writes the current event position i at the final reception position of the provisional list so as to be added as an event list of the state k in Step S519. Then, the collation unit 153 proceeds to Step S524.

On the other hand, in the case of a normal transition with an interval condition (Yes in Step S513C), the collation unit 153 determines whether or not there is an event list, which has not been processed, in the state j in Step S520. In a case where there is an event list, which has not been processed, in the state j (Yes in Step S520), the collation unit 153 selects the event list, which has not been processed, and determines whether or not the final reception position of the selected event list and the current event position i satisfy the interval condition in Step S521. Then, in a case where the interval condition is not satisfied (No in Step S521), the collation unit 153 removes the selected event list in Step S522 and proceeds to Step S520 so as to continue the process of the state j. On the other hand, in a case where the interval condition is satisfied (Yes in Step S521), the collation unit 153 copies the selected event list to the provisional list in Step S523 and proceeds to Step S516.

In other words, the collation unit 153 sets the normal transition destination state number of the state j to the state k. Then, in a case where the @ number is assigned to the state k, the collation unit 153 overwrites the current event position i at the @ number position of the provisional list and overwrites the current event position i at the final reception position of the provisional list so as to be added as an event list of the state k. On the other hand, in a case where the @ number is not assigned to the state k, the collation unit 153 overwrites the current event position i at the final reception position of the provisional list so as to be added as an event list of the state k.

Subsequently, the collation unit 153 determines whether or not the state k is the final state and there is an event list in Step S524. In a case where the state k is the final state and there is an event list (Yes in Step S524), the collation unit 153 gives notification of the current event position i and removes the event list of the state k in Step S525. In other words, the collation unit 153 gives notification of the event position i as end time of the event pattern. Then, the collation unit 153 proceeds to Step S520 so as to continue to process the state j. On the other hand, in a case where the state k is not the final state, or in a case where there is no event list (No in Step S524), the collation unit 153 proceeds to Step S520 so as to continue to process the state j.

Sequence of Process of Activating All ε Transitions And ε=Transitions

Next, a process of activating all the ε transitions and ε=transitions, which is illustrated in Step S55 illustrated in FIG. 22, will be described with reference to FIG. 24. FIG. 24 is a flowchart that illustrates the sequence of a process of activating all the ε transitions and ε=transitions.

As illustrated in FIG. 24, the collation unit 153 sets 1 to the value of the state j in Step S551. Then, the collation unit 153 determines whether or not there is the state j in Step S552. In a case where there is no state j (No in Step S552), the collation unit 153 ends the process.

On the other hand, in a case where there is the state j (Yes in Step S552), the collation unit 153 determines whether or not the state j is a junction node in Step S553. In a case where the state j is not a junction node (No in Step S553), the collation unit 153 determines whether or not an ε transition is output from the state j in Step S554. In a case where the ε transition is not output from the state j (No in Step S554), the collation unit 153 adds one to the value of the state j in Step S555 and proceeds to Step S552. On the other hand, in a case where the ε transition is output from the state j (Yes in Step S554), the collation unit 153 adds all the event lists of the state j as event lists of all the transition destination states and removes the event list of the state j in Step S556.

Subsequently, the collation unit 153 determines whether or not the state k is the final state and there is an event list in Step S557. In a case where the state k is the final state and there is an event list (Yes in Step S557), the collation unit 153 gives notification of the current event position i as a result of the collation and removes the event list of the state k in Step S558. In other words, the collation unit 153 gives notification of the end time of the event pattern as a result of the completion of the collation. Then, the collation unit 153 proceeds to Step S555 so as to continue to process the state j. On the other hand, in a case where the state k is not the final state, or in a case where there is no event list (No in Step S557), the collation unit 153 proceeds to Step S555 so as to continue to process the state j.

On the other hand, in a case where the state j is a junction node (Yes in Step S553), the collation unit 153 searches for an event list in which the event position coincides with the event position of the @ number position of the designated @ number, which is designated by the state j, in the event list of the ε=transition source of the state j. Then, the collation unit 153, as a result of the search, combines event lists for all the combinations of the event lists in which the event positions of the @ number positions coincide with each other and adds the combined event lists to the state j in Step S559.

Then, the collation unit 153 extracts the event position of the @ number position of the designated @ number designated by the state j from the event list of each ε=transition source of the state j. Then, in a case where the extracted event position is {“current event position”−“time-out length corresponding to each @ number of the state j”} or less, the collation unit 153 determines time-out and removes the event list in Step S560.

Subsequently, the collation unit 153 determines whether or not the state j is the final state and there is an event list in Step S561. In a case where the state j is the final state and there is an event list (Yes in Step S561), the collation unit 153 gives notification of the current event position i as a result of the collation and removes the event list of the state j in Step S562. In other words, the collation unit 153 gives notification of end time of the event pattern as a result of the completion of the collation. Then, the collation unit 153 proceeds to Step S554 so as to continue to process the state j. On the other hand, in a case where the state j is not the final state, or in a case where there is no event list (No in Step S561), the collation unit 153 proceeds to Step S554 so as to continue to process the state j.

Example of Pattern Collating Process

Next, the process performed by the collation unit 153 will be described with reference to the drawings. FIGS. 25A to 25X are diagrams that illustrate the process performed by the collation unit. In addition, in the description presented with reference to FIGS. 25A to 25X, each node will be distinguished by a state number. Hereinafter, the nodes having state numbers 1 to 49 will be described as states 1 to 49. An event stream 143 to be compared with the NFA 142 is illustrated in FIG. 3, and each event of each ID corresponding to the series is assumed to be maintained as S[i][ID] (here, i=0 to 10, and ID=0 to 2).

As illustrated in FIG. 25A, the data structure of the event pattern 143 is denoted by a reference sign 204p. The event pattern 143 has a pattern in which event A occurs in an arbitrary series, and thereafter, event B occurs in the same series as that of event A within “2”. In addition, the event pattern 143 has a pattern in which event C occurs in an arbitrary series within “4” after the occurrence of event A in an arbitrary series. Furthermore, the event pattern 143 has a pattern in which event E occurs in the same series as that of event C within “3” after the occurrence of event C, within “5” after the occurrence of event D, and within “4” after the occurrence of event B. The NFA that is generated by the NFA generating unit 152 using the event pattern 143 as an input is as denoted by a reference sign 204n.

As illustrated in a first stage of FIG. 25A, the collation unit 153 sets the value of the current event position i to “0” and reads an event S[0][0] of event position 0 and series 0, that is, event “A” from the event stream 143. In other words, the collation unit 153 reads event “A” of series 0 at time 0.

As illustrated in a second stage of FIG. 25A, the collation unit 153 initializes the value of the state j and the value of the transition destination state k, sets the value of the state j to 1, and sets the value of the transition destination state k to 0. The collation unit 153 determines whether or not a normal transition for event “A” is output from the state j while increasing the value of the state j by one each time. Here, from state 2, a normal transition without an interval condition for event “A” is output. Thus, the collation unit 153 determines the transition type corresponding to event “A” using the transition type determining table. Here, since the normal transition output from state 2 is a transition with ID designation, the collation unit 153 determines whether or not the events and the IDs of the read event and the normal transition output from the state respectively coincide with each other. Since both events are “A” and both IDs are “0”, the collation unit 153 determines that the events and the IDs respectively coincide with each other. Thus, the collation unit 153 sets an output normal transition without an interval condition as a transition type that corresponds to the event. Accordingly, since the transition type corresponding to the event is a normal transition without an interval condition, the collation unit 153 sets a provisional list that sets the reception state of the event to be vacant and sets state 9, which is a normal transition destination of state 3, to the state k. Then, since the @ number “0” is assigned to state 9, the collation unit 153 writes the current event position 0 to the @ number position of the provisional list. The collation unit 153 sets the current event position 0 to the final reception position of the provisional list. Then, the collation unit 153 adds the provisional list as an event list r1 of state 9.

In addition, although a normal transition for event “A” is output from state 3 and state 4, the output normal transition is a transition with ID designation, and the ID of the output normal transition and the ID of the read event do not coincide with each other, and accordingly, the collation unit 153 determines that there is no transition.

Thereafter, since there is no normal transition for event “A” that is output from each of states 3 to 49, the collation unit 153 ends the activation of all the normal transitions for event “A” of current event position 0 (time 0) of series 0.

As illustrated in FIG. 25C, the collation unit 153 activates all the ε transitions and ε=transitions output from the state j while increasing the value of the state j by one each time. Since an ε transition is output from state 9, the collation unit 153 adds the event list r1 of state 9 as an event list r1′ of transition destination states 13, 17, 18, and 19 and removes the event list r1 of state 9. Then, when the process is completed up to state 49, the collation unit 153 ends the activation of all the ε transitions and ε=transitions.

Thereafter, since there is no event of the other series at current event position 0 (time 0), the collation unit 153 ends the collation of current event position 0 (time 0).

As illustrated in a first stage of FIG. 25D, the collation unit 153 sets the value of the current event position i to 1 and reads event S[1][1] of event position 1 and series 1, that is, event “A” from the event stream 143. In other words, the collation unit 153 reads event “A” of series 1 at time 1.

As illustrated in a second stage of FIG. 25D, since a normal transition without an interval condition for event “A” is output from state 3, the collation unit 153 determines the transition type that corresponds to event “A” using the transition type determining table. Here, since the normal transition output from state 3 is a transition with ID designation, the collation unit 153 determines whether or not the events and the IDs of the read event and the normal transition output from the state respectively coincide with each other. Since both events are “A” and both IDs are “1”, the collation unit 153 determines that the events and the IDs respectively coincide with each other. Thus, the collation unit 153 determines the output normal transition without an interval condition as the transition type corresponding to the event. Accordingly, since the transition type corresponding to the event is a normal transition without an interval condition, the collation unit 153 sets the provisional list that sets the reception state of the event to be vacant. Then, since @ number 0 is assigned to state 10 that is a normal transition destination of state 3, the collation unit 153 writes current event position 1 to the @ number position of the provisional list. The collation unit 153 sets the current event position 1 at the final reception position of the provisional list. Then, the collation unit 153 adds the provisional list as an event list r2 of state 10.

Thereafter, since there is no normal transition for event “A” that is output from each one of states 4 to 49, the collation unit 153 ends the activation of all the normal transitions for event “A” of series 1 and current event position 1 (time 1).

As illustrated in FIG. 25E, the collation unit 153 activates all the ε transitions and ε=transitions that are output from the state j while increasing the value of the state j by one each time. Since an ε transition is output from state 10, the collation unit 153 adds the event list r2 of state 10 as the event list r2′ of the transition destination states 14, 17, 18, and 19 and removes the event list r2 of state 10. Then, when the process up to state 49 is completed, the collation unit 153 ends the activation of all the ε transitions and ε=transitions.

Thereafter, since there is no event of the other series at current event position 1 (time 1), the collation unit 153 ends the collation of current event position 1 (time 1).

As illustrated in a first stage of FIG. 25F, the collation unit 153 sets the value of the current event position i to 2 and reads event S[2][0] of event position 2 and series 0, that is, event “B” from the event stream 143. In other words, the collation unit 153 reads event “B” of series 0 at time 2.

As illustrated in a second stage of FIG. 25F, since a normal transition with an interval condition for event “B” is output from state 13, the collation unit 153 determines the transition type that corresponds to event “B” using the transition type determining table. Here, since the normal transition output from state 13 is a transition with ID designation, the collation unit 153 determines whether or not the events and the IDs of the read event and the normal transition output from the state respectively coincide with each other. Since both events are “B” and both IDs are “0”, the collation unit 153 determines that the events and the IDs respectively coincide with each other. Thus, the collation unit 153 determines the output normal transition with an interval condition as the transition type corresponding to the event. Accordingly, since the transition type corresponding to the event is a normal transition with an interval condition and there is an event list, which has not been processed, at state 13, the collation unit 153 determines whether or not the final reception position of the event list and the current event position satisfy the interval condition. Here, the final reception position of the event list is 0 and the current event position is 2, the collation unit 153 determines that the interval condition of “2” of the normal transition with an interval condition is satisfied. Then, the collation unit 153 sets current event position 2 at the final reception position of the event list and adds the event list as the event list r3 of state 10.

Thereafter, since there is no normal transition for event “B” that is output from each one of states 4 to 49, the collation unit 153 ends the activation of all the normal transitions for event “B” of series 2 and current event position 2 (time 2).

As illustrated in FIG. 25G, the collation unit 153 activates all the ε transitions and ε=transitions that are output from the state j while increasing the value of the state j by one each time. Since an ε transition is output from state 20, the collation unit 153 adds the event list r3 of state 20 as the event list r3′ of the transition destination state 24 and removes the event list r3 of state 20. Then, when the process up to state 49 is completed, the collation unit 153 ends the activation of all the ε transitions and ε=transitions.

Thereafter, since there is no event of the other series at current event position 2 (time 2), the collation unit 153 ends the collation of current event position 2 (time 2).

As illustrated in a first stage of FIG. 25H, the collation unit 153 sets the value of the current event position i to 3 and reads event S[3][0] of event position 3 and series 0, that is, event “C” from the event stream 143. In addition, the collation unit 153 reads event S[3][1] of current event position 3 and series 1, that is, event “B” from the event stream 143. Then, the collation unit 153 performs the following collation process in the order of event “C” of series 0 and event “B” of series 1.

As illustrated in a second stage of FIG. 25H, for event “C” of series 0, since a normal transition with an interval condition for event “C” is output from state 17, the collation unit 153 determines the transition type that corresponds to event “C” using the transition type determining table. Here, since the normal transition output from state 17 is a transition with ID designation, and the events and the IDs of the read event and the normal transition output from the state respectively coincide with each other, the collation unit 153 determines the output normal transition with an interval condition as the transition type corresponding to the event. Accordingly, since the transition type corresponding to the event is a normal transition with an interval condition and there is an event list, which has not been processed, at state 17, the collation unit 153 determines whether or not the final reception position of the event list and the current event position satisfy the interval condition. Here, since the final reception position of one event list is 0 and the current event position is 3, the collation unit 153 determines that the interval condition of “4” of the normal transition with an interval condition is satisfied. In addition, since the final reception position of another event list is 1 and the current event position is 3, the collation unit 153 determines that the interval condition of “4” of the normal transition with an interval condition is satisfied. Then, the collation unit 153 sets current event position 3 at the final reception position of each event list and adds each event list as the event list r4 of normal transmission destination state 29.

Also for event “B” of series 1, the collation unit 153 performs the process similar to event “C” of series 0, sets current event position 3 at the final reception position of the event list of state 14, and adds the event list as the event list r5 of the normal transition destination state 21.

As illustrated in FIG. 25I, for event “C” of series 0, the collation unit 153 activates all the ε transitions and ε=transitions that are output from the state j while increasing the value of the state j by one each time. Since an ε transition is output from state 29, the collation unit 153 adds the event list r4 of state 29 as the event list r4′ of the transition destination state 32 and removes the event list r4 of state 29.

Also for event “B” of series 1, the collation unit 153 performs the process similar to that of the case of event “C” of series 1, adds the event list r5 of state 21 as the event list r5′ of the transition destination state 24 and removes the event list r5 of state 21. Then, when the process up to state 49 is completed, the collation unit 153 ends the activation of all the ε transitions and ε=transitions.

Thereafter, since there is no event of the other series at current event position 3 (time 3), the collation unit 153 ends the collation of current event position 3 (time 3).

As illustrated in a first stage of FIG. 25J, the collation unit 153 sets the value of the current event position i to 4 and reads event S[4][0] of event position 4 and series 0, that is, event “A” from the event stream 143. In addition, the collation unit 153 reads event S[4][2] of current event position 4 and series 2, that is, event “D” from the event stream 143. Then, the collation unit 153 performs the following collation process in the order of event “A” of series 0 and event “D” of series 2.

As illustrated in a second stage of FIG. 25J, for event “A” of series 0, since a normal transition without an interval condition for event “A” is output from state 2, the collation unit 153 determines the transition type that corresponds to event “C” using the transition type determining table. Here, since the normal transition output from state 2 is a transition with ID designation, and the events and the IDs of the read event and the normal transition output from the state respectively coincide with each other, the collation unit 153 determines the output normal transition without an interval condition as the transition type corresponding to the event. Accordingly, since the transition type corresponding to the event is a normal transition without an interval condition and the @ number 0 is assigned to normal transition destination state 9, the collation unit 153 writes current event position 4 at the @ number position of the event list and sets current event position 4 at the final reception position. Then, the collation unit 153 adds the event list as the event list r6 of state 9.

Also for event “D” of series 2, the collation unit 153 performs the process similar to event “A” of series 0, the normal transition without an interval condition for event “D” output from state 8 is output, and accordingly, the collation unit 153 determines the transition type that corresponds to event “D” using the transition type determining table. Here, the collation unit 153 determines the normal transition without an interval condition that is output from state 8 as the transition type corresponding to the event. Since the transition type corresponding to the event is a normal transition without an interval condition, and the @ number is not assigned to the normal transition destination state 40, the collation unit 153 sets current event position 4 at the final reception position of the event list. Then, the collation unit 153 adds the event list as the event list r7 of state 40.

As illustrated in FIG. 25K, for event “A” of series 0, the collation unit 153 activates all the ε transitions and ε=transitions that are output from the state j while increasing the value of the state j by one each time. Since an ε transition is output from state 9, the collation unit 153 adds the event list r6 of state 9 as the event list r6′ of the transition destination state 13, 18, 17, and 19 and removes the event list r6 of state 9.

Also for event “D” of series 2, the collation unit 153 performs the process similar to that of the case of event “A” of series 0, adds the event list r7 of state 40 as the event list r7′ of the transition destination state 43, and removes the event list r7 of state 40. Then, when the process up to state 49 is completed, the collation unit 153 ends the activation of all the ε transitions and ε=transitions.

Thereafter, since there is no event of the other series at current event position 4 (time 4), the collation unit 153 ends the collation of current event position 4 (time 4).

As illustrated in a first stage of FIG. 25L, the collation unit 153 sets the value of the current event position i to 5 and reads event S[5][0] of event position 5 and series 0, that is, event “E” from the event stream 143. In addition, the collation unit 153 reads event S[5][2] of current event position 5 and series 2, that is, event “C” from the event stream 143. Then, the collation unit 153 performs the following collation process in the order of event “E” of series 0 and event “C” of series 2.

As illustrated in a second stage of FIG. 25L, for event “E” of series 0, since a normal transition without an interval condition for event “E” is output from state 24, the collation unit 153 determines the transition type that corresponds to event “E” using the transition type determining table. Here, since the normal transition output from state 24 is a transition without ID designation, the collation unit 153 determines the output normal transition without an interval condition as the transition type corresponding to the event. Accordingly, since the transition type corresponding to the event is a normal transition without an interval condition and the @ number 1 is assigned to normal transition destination state 25, the collation unit 153 writes current event position 5 at the @ number position of the event list and sets current event position 5 at the final reception position. Then, the collation unit 153 adds the event list as the event list r8 of state 25.

Subsequently, since the normal transition with an interval condition for event “E” output from state 32 is output, the collation unit 153 determines the transition type that corresponds to event “E”. Here, since the normal transition output from state 32 is a transition with ID designation, the events and the IDs of the read event and the normal transition output from the state respectively coincide with each other, the collation unit 153 determines the output normal transition with an interval condition as the transition type that corresponds to the event. Thus, since the transition type corresponding to the event is a normal transition with an interval condition, and there is an event list, which has not been processed, at state 32, the collation unit 153 determines whether or not the final reception position of the event list and the current event position satisfy the interval condition. Here, the collation unit 153 determines that the interval condition of “3” is satisfied for the two event lists. Then, since the @ number 1 is assigned to the normal transition destination state 35, the collation unit 153 writes current event position 5 at the @ number position of the event list, and sets current event position 5 at the final reception position. Then, the collation unit 153 adds the event list as the event list r9 of state 35.

Also for event “C” of series 2, the collation unit 153 performs the process similar to event “E” of series 0, and the normal transition with an interval condition for event “C” output from state 19 is output, and accordingly, the collation unit 153 determines the transition type that corresponds to event “C”. Here, the collation unit 153 determines the normal transition with an interval condition that is output from state 19 as the transition type corresponding to the event. Then, the collation unit 153 selects an event list r1′ at state 19, which has not been processed, and determines whether or not the final reception position of the selected event list r1′ and current event position 5 satisfy the interval condition. The final reception position of the selected event list r1′ is “0”, an interval from current event position 5 is 5, and accordingly, the interval condition 4 is exceeded, whereby the collation unit 153 determines that the interval condition 4 is not satisfied. Then, the collation unit 153 removes the event list r1′.

Subsequently, the collation unit 153 selects an event list r2′ at state 19, which has not been processed, and determines whether or not the final reception position of the selected event list r2′ and current event position 5 satisfy the interval condition. The final reception position of the selected event list r2′ is 1, an interval from current event position 5 is 4, and accordingly, the interval condition 4 is not exceeded, whereby the collation unit 153 determines that the interval condition 4 is satisfied. Then, the collation unit 153 sets the current event position 5 at the final reception position of the event list. Then, the collation unit 153 adds the event list as the event list r10 of the normal transition destination state 31.

As illustrated in FIG. 25M, for event “E” of series 0, the collation unit 153 activates all the ε transitions and ε=transitions output from the state j while increasing the value of the state j by one each time. Since an ε transition is output from state 25, the collation unit 153 adds the event list r8 of state 25 as an event list r8′ of the transition destination states 26, 27, and 28, and removes the event list r8 of state 25.

Also for event “C” of series 2, the collation unit 153 performs the process similar to that of the case of event “E” of series 0, adds the event list r10 of state 3l as the event list r10′ of the transition destination state 34, and removes the event list r10 of state 10.

As illustrated in FIG. 25N, the collation unit 153 extracts event positions of the event lists r8′ and r9 of ε=transition sources 26 and 35 of state 47 that correspond to the designated @ numbers 0 and 1 that are designated at state 47. Here, in the case of a designated @ number 0, the collation unit 153 extracts 0 and 1 from the event list r8′ and 0 and 1 from the event list r9. In such a case, the collation unit 153 determines whether or not the extracted event position is equal to or less than {“current event position”−“time-out length corresponding to @ number 0 of state 47”}. Here, the extracted event position is 0 (or 1), the current event position is 5, the time-out length corresponding to the @ number 0 of state 47 is 7, and “0 (or 1)>5−7”, and accordingly, the collation unit 153 does not remove the event lists. On the other hand, in the case of a designated @ number of “1”, the collation unit 153 extracts 5 from the event list r8′ and extracts 5 from the event list r9. In such a case, the collation unit 153 determines whether or not the extracted event position is equal to or less than {“current event position”−“time-out length corresponding to the @ number 1 of state 47”}. Here, the extracted event position is 5, the current event position is 5, the time-out length corresponding to the @ number 1 of state 47 is 0, “5=5−0”, and accordingly, the collation unit 153 determines time-out and removes the event lists r8′ and r9.

Subsequently, also for each event list r8′ of the ε=transition source 27 of state 48 and the ε=transition source 28 of state 49, similarly to the case of state 47, time-out corresponding to the @ number 1 occurs, and accordingly, the collation unit 153 removes each event list r8′

As illustrated in a first stage of FIG. 25O, the collation unit 153 sets the value of the current event position i to 6 and reads event S[6][0] of event position 6 and series 0, that is, event “B” from the event stream 143. In addition, the collation unit 153 reads event S[6][1] of current event position 6 and series 1, that is, event “C” from the event stream 143. Then, the collation unit 153 performs the following collation process in the order of event “B” of series 0 and event “C” of series 1.

As illustrated in a second stage of FIG. 25O, for event “B” of series 0, since a normal transition with an interval condition for event “B” is output from state 13, the collation unit 153 determines the transition type that corresponds to event “B”. Here, the collation unit 153 determines the normal transition with an interval condition output from state 13 as the transition type that corresponds to the event. Then, the collation unit 153 selects the event list r1′, which has not been processed, of state 13 and determines whether or not the final reception position of the selected event list r1′ and the current event position 6 satisfy the interval condition. The final reception position of the selected event list r1′ is 0, the interval from current event position 6 is 6, and accordingly, the interval condition of 2 is exceeded, whereby the collation unit 153 determines that the interval condition of 2 is not satisfied. Then, the collation unit 153 removes the event list r1′.

Subsequently, the collation unit 153 selects the event list r6′, which has not been processed, of state 13 and determines whether or not the final reception position of the selected event list r6′ and the current event position 6 satisfy the interval condition. The final reception position of the selected event list r6′ is 4, the interval from current event position 6 is 2, and accordingly, the interval condition of 2 is not exceeded, whereby the collation unit 153 determines that the interval condition of 2 is satisfied. Then, the collation unit 153 sets current event position 6 at the final reception position of the event list. Then, the collation unit 153 adds the event list as the event list r11 of the normal transition destination state 20.

For event “C” of series 1, since a normal transition with an interval condition for event “C” is output from state 18, the collation unit 153 determines the transition type that corresponds to event “C”. Here, the collation unit 153 determines the normal transition with an interval condition output from state 18 as the transition type that corresponds to the event. Then, the collation unit 153 determines whether or not the final reception positions of the event lists r1′ and r2′, which have not been processed, of state 18 and the current event position 6 satisfy the interval condition. The final reception positions of the selected event lists r1′ and r2′ are 0 and 1 respectively, intervals from current event position 6 are 6 and 5, and an interval condition of 4 is exceeded, whereby the collation unit 153 determines that the interval condition of 4 is not satisfied. Then, the collation unit 153 removes the event lists r1′ and r2′.

Subsequently, the collation unit 153 selects the event list r6′, which has not been processed, of state 18 and determines whether or not the final reception position of the selected event list r6′ and current event position 6 satisfy the interval condition. The final reception position of the selected event list r6′ is 4, the interval from current event position 6 is 2, and accordingly, the interval condition of 4 is not exceeded, whereby the collation unit 153 determines that the interval condition of 4 is satisfied. Then, the collation unit 153 sets current event position 6 at the final reception position of the event list. Then, the collation unit 153 adds the event list as the event list r12 of the normal transition destination state 30.

As illustrated in FIG. 25P, the collation unit 153 activates all the ε transitions and ε=transitions that are output from the state j while increasing the value of the state j by one each time. Since an ε transition is output from state 20, the collation unit 153 adds the event list r11 of state 20 as the event list r11′ of the transition destination state 24 and removes the event list r11 of state 20.

Subsequently, since an ε transition is output from state 30, the collation unit 153 adds the event list r12 of state 30 as the event list r12′ of the transition destination state 33 and removes the event list r12 of state 30.

As illustrated in a first stage of FIG. 25Q, the collation unit 153 sets the value of the current event position i to 7 and reads event S[7][2] of event position 7 and series 2, that is, event “E” from the event stream 143.

As illustrated in a second stage of FIG. 25Q, since a normal transition with an interval condition for event “E” is output from state 24, the collation unit 153 determines the transition type that corresponds to event “E”. Here, the collation unit 153 determines the normal transition with an interval condition output from state 24 as the transition type that corresponds to the event. Then, the collation unit 153 determines whether or not the final reception position of the event list r3′, which has not been processed, of state 24 and current event position 7 satisfy the interval condition. The final reception position of the selected event list r3′ is 2, the interval from current event position 7 is 5, and accordingly, the interval condition of 4 is exceeded, whereby the collation unit 153 determines that the interval condition of 4 is not satisfied. Then, the collation unit 153 removes the event list r3′.

Subsequently, the collation unit 153 determines whether or not the final reception positions of the event lists r5′ and r11′, which have not been processed, of state 24 and current event position 7 satisfy the interval condition. The final reception positions of the selected event lists r5′ and r11′ are 3 and 6, the intervals from current event position 7 are 4 and 1, and accordingly, the interval condition of 4 is not exceeded, whereby the collation unit 153 determines that the interval condition of 4 is satisfied. Since the @ number 1 is assigned to the normal transition destination state 25, the collation unit 153 writes the current event position 7 at the @ number position of the event list and sets the current event position 7 at the final reception position. Then, the collation unit 153 adds the event lists as event lists r13 and r14 of state 25.

Subsequently, since a normal transition with an interval condition for event “E” is output from state 34, the collation unit 153 determines the transition type that corresponds to event “E”. Here, the collation unit 153 determines the normal transition with an interval condition output from state 34 as the transition type that corresponds to the event. Then, the collation unit 153 determines whether or not the final reception position of the event list r10′, which has not been processed, of state 34 and current event position 7 satisfy the interval condition. The final reception position of the selected event list r10′ is 5, the interval from current event position 7 is 2, and accordingly, the interval condition of 3 is not exceeded, whereby the collation unit 153 determines that the interval condition of 3 is satisfied. Since the @ number 1 is assigned to the normal transition destination state 37, the collation unit 153 writes the current event position 7 at the @ number position of the event list and sets the current event position 7 at the final reception position. Then, the collation unit 153 adds the event list as an event list r15 of state 37.

Subsequently, since a normal transition with an interval condition for event “E” is output from state 43, the collation unit 153 determines the transition type that corresponds to event “E”. Here, the collation unit 153 determines the normal transition with an interval condition output from state 43 as the transition type that corresponds to the event. Then, the collation unit 153 determines whether or not the final reception position of the event list r7′, which has not been processed, of state 43 and current event position 7 satisfy the interval condition. The final reception position of the selected event list r7′ is 4, the interval from current event position 7 is 3, and accordingly, the interval condition of 5 is not exceeded, whereby the collation unit 153 determines that the interval condition of 5 is satisfied. Since the @ number 1 is assigned to the normal transition destination state 46, the collation unit 153 writes the current event position 7 at the @ number position of the event list and sets the current event position 7 at the final reception position. Then, the collation unit 153 adds the event list as an event list r16 of state 46.

As illustrated in FIG. 25R, for event “E” of series 0, the collation unit 153 activates all the ε transitions and ε=transitions that are output from the state j while increasing the value of the state j by one each time. Since an ε transition is output from state 25, the collation unit 153 adds the event lists r13 and r14 of state 25 as the event lists r13′ and r14′ of the transition destination states 26, 27, and 28 and removes the event lists r13 and r14 of state 25.

Subsequently, since state 49 is a junction node, the collation unit 153 searches for event lists in which the event positions of the @ number positions of the designated @ numbers, which are designated by state 49, coincide with each other out of event lists of the ε=transition source states 28, 37, and 46 of state 49. Here, the event positions of 1 and 7 corresponding to the designated @ numbers 0 and 1 of the event list r13′ of state 28 and the event list r15 of state 37 are common. In addition, the event position corresponding to the designated @ numbers 0 and 1 of the event list r16 of state 46 is *(arbitrary event position), 7, which coincides with those of the event list r13′ of state 28 and the event list r15 of state 37. Thus, the collation unit 153 combines the event lists of a combination of these event lists r13′, r15, and r16 and adds the combined event list r20 in state 49.

As illustrated in FIG. 25S, the collation unit 153 extracts event positions corresponding to the designated @ numbers 0 and 1, which are designated at state 47, of the event lists r13′ and r14′ of the ε=transition source 26 of state 47. Here, in the case of a designated @ number 0, the collation unit 153 extracts 1 and 4 from the event lists r13′ and r14′. In such a case, the collation unit 153 determines whether or not the extracted event position is {“current event position”−“time-out length corresponding to @ number 0 of state 47”} or less. Here, the extracted event position is 1 (or 4), the current event position is 7, the time-out length corresponding to the @ number 0 of state 47 is 7, and “1 (or 4)>7−7”, and accordingly, the collation unit 153 does not remove the event lists. On the other hand, in the case of a designated @ number 1, the collation unit 153 extracts 7 from the event lists r13′ and r14′. In such a case, the collation unit 153 determines whether or not the extracted event position is {“current event position”−“time-out length corresponding to @ number 1 of state 47”} or less. Here, the extracted event position is 7, the current event position is 7, the time-out length corresponding to the @ number 1 of state 47 is 0, “7=7−0”, and accordingly, the collation unit 153 determines time-out and removes the event lists r13′ and r14′.

Subsequently, also for the event lists r13′ and r14′ of the ε=transition source 27 of state 48, similarly to the case of state 47, time-out corresponding to the @ number 1 occurs, and accordingly, the collation unit 153 removes the event lists r13′ and r14′.

Since there is an event list r20 in the final state of state 49, the collation unit 153 gives notification of the current event position 7 as a result of the collation and removes the event list r20 of state 49. In other words, the collation unit 153 gives notification of end time of the event pattern as a result of the completion of the collation. Then, the process up to state 49 is completed, and accordingly, the collation unit 153 ends the activation of all the ε transitions and ε=transitions.

Subsequently, as illustrated in FIGS. 25T and 25U, the collation unit 153 sets the value of the current event position i to 8, reads event position 8 and event “D” of series 1 from the event stream 143, and continues to perform collation. Subsequently, as illustrated in FIGS. 25V to 25X, the collation unit 153 sets the value of the current event position i to 9, reads event position 9 and event “E” of series 1 from the event stream 143, and continues to perform collation.

The collation unit 153 collates the event stream 143 using the NFA 142 by performing the above-described process illustrated in FIGS. 25A to 25X. Then, the collation unit 153 gives notification of the collation result to the user terminal 50. In addition, the collation unit 153 may display the collation result on the display unit 130. In FIGS. 25A to 25X described above, although the collation result is set as the end time of the event pattern 141 on the event stream 143, the collation result may include starting time.

### Advantages of Embodiments

Next, the advantages of the collation device 100 according to this embodiment will be described. For an event pattern 141, which accompanies the order of generation of events and an interval condition, as an event pattern 141 that includes events of multiple series, the collation device 100 generates a provisional NFA corresponding to the event pattern 141. Then, the collation device 100 replicates an NFA part corresponding to a same-series part in which events included in the generated provisional NFA are connected to each other in the same series for a plurality of series. Then, the collation device 100 substitutes each replicated NFA part with a transition received in an event of each series and combines the substituted NFA parts through ε transitions. Then, the collation device 100 receives events included in the event stream 143 in the NFA part corresponding to a series in which the event occurs among the replicated NFA parts. Then, the collation device 100 operates the NFA part that has received the event. In such a configuration, according to the collation device 100, since an event occurring in a specific series is received in the NFA part corresponding to the generated series and is operated, the process of determining the series identity between the event and an event that has occurred before the event can be performed at high speed.

In addition, in a case where a same-series part and an arbitrary-series part in which events are connected in arbitrary series are connected in the event pattern 141, the collation device 100 separates an NFA part corresponding to the same series part in a generated provisional NFA. Then, the collation device 100 replicates the separated NFA parts for a plurality of series. Then, the collation device 100 substitutes each replicated NFA part with a transition that is received in an event of each series and combines each substituted NFA part and a joining portion of the original NFA before the separation through an ε transition. Then, the collation device 100, in each replicated NFA part, receives events included in the event stream 143 in the NFA part corresponding to the series in which the event occurs out of the NFA parts, and the NFA part is operated, and, in an NFA part corresponding to the arbitrary series parts, receives the events in the NFA part and operates the NFA part. In such a configuration, according to the collation device 100, an event that occurs in a specific series is received in the NFA part corresponding to the generated series and operates, and accordingly, the process of determining the series identity between the event and an event that has occurred before the event can be performed at high speed.

Furthermore, in a case where a joining portion of an NFA part corresponding to the same-series part and an NFA part corresponding to an arbitrary-series part is present in the middle of the NFA part corresponding to the same-series part, the collation device 100 generates a connection node as a joining portion of each NFA part of which the same-series portion is replicated and the arbitrary series part. Then, the collation device 100 connects the generated connection node and each NFA part of which the same-series part is replicated through an ε transition, and joins the generated connection node and the arbitrary-series part through an ε transition. According to such a configuration, according to the collation device 100, even in a case where a joining portion of the NFA part corresponding to the same-series part and the NFA part corresponding to an arbitrary series part is present in the middle of the NFA part corresponding to the same-series part, the same-series part and the arbitrary-series part can be joined together through the connection node. Accordingly, the collation device 100 can easily realize a process of receiving and operating an event occurring in a specific series in the NFA part corresponding to the generated series. As a result, the collation device 100 can perform the process of determining series identity between the event and an event that has occurred before the event at high speed.

Program and the Like

In addition, the collation device 100 can be realized by building each function of the NFA generating unit 152, the collation unit 153, and the like described above in an information processing apparatus such as a known personal computer or a workstation.

Furthermore, each constituent element of each device illustrated in the figures does not necessarily need to be physically configured as is illustrated in the figures. In other words, a specific aspect of division or integration of each device is not limited to that illustrated in the figure, and the whole or a part thereof may be configured so as to be divided or integrated functionally or physically in an arbitrary unit in accordance with various loads or use circumstances, or the like. For example, the NFA generating unit 152 and the collation unit 153 may be integrated as one unit. On the other hand, the NFA generating unit 152 may be divided into a provisional NFA generating unit that generates a provisional NFA, a same-series NFA searching unit that searches for an NFA of the same series from the provisional NFA, and a same-series NFA converting unit that converts the NFA of the same-series. In addition, a storage unit such as the NFA 142 may be configured as an external device of the collation device 100 and be connectable through a network.

In addition, various processes described in the embodiments presented above may be realized by a computer such as a personal computer or a workstation executing a program that is prepared in advance. Thus, hereinafter, an example of a computer that executes a collation program realizing the same functions as those of the collation device 100 illustrated in FIG. 2 will be described. FIG. 26 is a diagram that illustrates an example of a computer that executes the collation program.

As illustrated in FIG. 26, a computer 200 includes a CPU 201 that performs various calculation processes, an input device 202 that receives an input of data from a user, and a display 203. In addition, the computer 200 includes a reading device 204 that reads a program or the like from a storage medium and an interface device 205 that receives and transmits data from/to another computer through a network. Furthermore, the computer 200 includes a RAM 206 that temporarily stores various types of information and a hard disk device 207. The devices 201 to 207 are connected to a bus 208.

The hard disk device 207 stores an NFA generating program 207a and a collation program 207b. The CPU 201 reads out the programs 207a and 207b and expands the programs in the RAM 206. The NFA generating program 207a serves as an NFA generating process 206a. The collation program 207b serves as a collation process 206b.

For example, the NFA generating process 206a corresponds to the NFA generating unit 152. The collation process 206b corresponds to the collation unit 153.

In addition, the programs 207a and 207b may not be initially stored in the hard disk device 207. For example, each program may be stored in a “portable physical medium”, which is inserted into the computer 200, such as a flexible disc (FD), a CD-ROM, a DVD disc, a magneto-optical disk, or an IC card. The computer 200 may be configured to read out the programs 207a to 207b from the medium and execute the program.

According to an aspect of a collation device disclosed in this application, in a case where a condition that uses two events included in the same series is set, there is an advantage of performing the process of determining the identity of the series between two events for event data included in a plurality of series at high speed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A collation device comprising:
a processor; and
a memory, wherein the processor executes:
generating an automaton by generating an automaton corresponding to an event pattern that is an event pattern including events of a plurality of series and is an event pattern accompanying an occurring order of the events and an interval condition of the events and replicating an automaton part corresponding to a same-series part in which events included in the generated automaton are connected to each other in the same series for a plurality of series, substituting each replicated automaton part with a transition that is received in an event of each series, and combining the substituted automaton parts through an ε transition; and
collating whether or not the event pattern is included in an event stream by sequentially comparing the event stream that includes the occurring order of a plurality of events of a plurality of series with the automaton, receiving an event included in the event stream in an automaton part corresponding to the series in which the event has occurred out of replicated automaton parts, and operating the automaton part.

2. The collation device described in claim 1,
wherein the generating includes, in a case where the same-series part and an arbitrary-series part in which the events are connected in arbitrary series are connected to each other in the event pattern, separating the automaton part corresponding to the same-series part of the generated automaton, replicating the separated automaton part for a plurality of series, substituting each replicated automaton part with a transition that is received in an event of each series, and combining the substituted automaton parts and a joining portion of the original automaton before the separation through ε transitions, and
wherein the collating includes, in each replicated automaton part receiving the event that is included in the event stream in an automaton part corresponding to the series in which the event has occurred out of the automaton parts and operating the automaton part, and in an automaton part corresponding to the arbitrary-series part receiving the event that is included in the event stream in the automaton part and operating the automaton part.

3. The collation device described in claim 2,
wherein the generating includes, in a case where a joining portion of the automaton part corresponding to the same-series part and an automaton part corresponding to the arbitrary-series part is present in the middle of the automaton part corresponding to the same-series part, generating a connection node as a joining portion of each automaton part of which the same-series part is replicated and the arbitrary-series part, joining the generated connection node and the each automaton part of which the same-series part is replicated through an ε transition, and connecting the generated connection node and the arbitrary-series part through an ε transition.

4. A computer-readable storage recording medium having stored therein a program for causing a computer to execute a collation process comprising:
generating an automaton by generating an automaton corresponding to an event pattern that is an event pattern including events of a plurality of series and is an event pattern accompanying an occurring order of the events and an interval condition of the events and replicating an automaton part corresponding to the same series part in which events included in the generated automaton are connected to each other in the same series for a plurality of series, substituting each replicated automaton part with a transition that is received in an event of each series, and combining the substituted automaton parts through an ε transition; and
collating whether or not the event pattern is included in an event stream by sequentially comparing the event stream that includes the occurring order of a plurality of events of a plurality of series with the automaton, receiving an event included in the event stream in an automaton part corresponding to the series in which the event has occurred out of replicated automaton parts, and operating the automaton part.

5. A collation method comprising:
generating an automaton by generating an automaton corresponding to an event pattern that is an event pattern including events of a plurality of series and is an event pattern accompanying an occurring order of the events and an interval condition of the events and replicating an automaton part corresponding to the same series part in which events included in the generated automaton are connected to each other in the same series for a plurality of series, substituting each replicated automaton part with a transition that is received in an event of each series, and combining the substituted automaton parts through an ε transition, using a processor; and
collating whether or not the event pattern is included in an event stream by sequentially comparing the event stream that includes the occurring order of a plurality of events of a plurality of series with the automaton, receiving an event included in the event stream in an automaton part corresponding to the series in which the event has occurred out of replicated automaton parts, and operating the automaton part, using the processor.
